(19) United States
(12) Patent Application Publication
(10) Pub. No.: US 2026/0343096 A1
(43) Pub. Date: Oct. 29, 2026

(54) CAMERA DEVICE AND OPTICAL DEVICE

(71) Applicant: LG INNOTEK CO., LTD., Seoul (KR)

(72) Inventors: Tae Wan KIM, Seoul (KR); Jung Cheol KIM, Seoul (KR); Hyeon Jun JANG, Seoul (KR)

(21) Appl. No.: 19/111,604

(22) PCT Filed: Sep. 6, 2023
(86) PCT No.: PCT/KR2023/013320

§ 371 Date: Mar. 13, 2025

(30) Foreign Application Priority Data
Sep. 14, 2022 (KR) 10-2022-0115711

(51) Int. Cl. H04N 23/68; H04N 23/54

(52) U.S. Cl. CPC H04N 23/687; H04N 23/54

(57) ABSTRACT

An embodiment comprises: a fixed part comprising a cover member including a top plate and a side plate connected to the top plate; a moving part comprising a holder disposed in the cover member, a first circuit board disposed on the holder, and an image sensor electrically connected to the first circuit board; and a support part which is coupled to the holder and supports the moving part with respect to the fixed part, wherein the holder includes a side portion, a corner portion, and a stopper protruding from the outer surface of the side portion of the holder toward the side plate of the cover member, and the stopper is disposed closer to the center of the side portion of the holder than to the corner portion of the holder.

### CROSS-REFERENCE TO RELATED APPLICATIONS

This application is the U.S. national stage application of International Patent Application No. PCT/KR 2023/013320, filed Sep. 6, 2023, which claims the benefit under 35 U.S.C. § 119 of Korean Application No. 10-2022-0115711, filed Sep. 14, 2022, the disclosures of each of which are incorporated herein by reference in their entirety.

### TECHNICAL FIELD

Embodiments relate to a camera device and an optical instrument including the same.

### BACKGROUND ART

Voice coil motor (VCM) technology, which is used in conventional general camera devices, is difficult to apply to a micro-scale camera device, which is intended to exhibit low power consumption, and study related thereto has been actively conducted.

There is increasing demand for, and production of, electronic products such as smartphones and cellular phones equipped with cameras. Cameras for cellular phones have been increasing in resolution and decreasing in size, and accordingly, actuators therefor are also becoming smaller, larger in diameter, and more multifunctional. In order to realize a high-resolution cellular phone camera, improvement in the performance of the cellular phone camera and additional functions, such as autofocus, shutter shaking prevention, and zooming in and out, are required.

### DISCLOSURE

### Technical Problem

Embodiments provide a camera device capable of inhibiting an OIS moving unit from being damaged or broken due to impact or collision and an optical instrument including the same.

### Technical Solution

A camera device according to an embodiment includes a fixed unit including a cover member including an upper plate and a side plate connected to the upper plate, a moving unit including a holder disposed inside the cover member, a first circuit board disposed on the holder, and an image sensor conductively connected to the first circuit board, and a support unit coupled to the holder and configured to support the moving unit with respect to the fixed unit, wherein the holder includes a side portion, a corner portion, and a stopper protruding from an outer side surface of the side portion of the holder toward the side plate of the cover member, and the stopper is disposed closer to the center of the side portion of the holder than to the corner portion of the holder. At least a portion of the stopper may pass through the support unit.

The shortest distance between the stopper and the side plate of the cover member may be less than the shortest distance between the outer side surface of the side portion of the holder and the side plate of the cover member.

The shortest distance between the stopper and the side plate of the cover member may be less than the shortest distance between an outer side surface of the corner portion of the holder and the side plate of the cover member.

The holder may include a protruding portion formed so as to allow a portion of the support unit to be coupled thereto, and the stopper may include a first stopper protruding from an outer side surface of the protruding portion of the holder. The support unit may include a connection portion connected to the first circuit board and coupled to the protruding portion of the holder, and the first stopper may pass through the connection portion.

The holder may include a protruding portion protruding in an optical-axis direction so as to allow a portion of the support unit to be coupled thereto, and the stopper may include a first stopper located on one side of the protruding portion of the holder and a second stopper located on the opposite side of the protruding portion of the holder.

The fixed unit may include a base disposed below the cover member and a second circuit board coupled to the base, and the stopper may include a second stopper protruding from the outer side surface of the side portion of the holder toward the base.

The base may include a protruding portion formed so as to allow a portion of the support unit to be coupled thereto, the holder may include a recess depressed in the outer side surface of the side portion of the holder so as to correspond to the protruding portion of the base, and the second stopper may protrude from a bottom surface of the recess in the holder toward the protruding portion of the base.

The distance between the second stopper and the protruding portion of the base may be less than the distance between the outer side surface of the side portion of the holder and the side plate of the cover member.

On the assumption that the center of the side portion of the holder is a point corresponding to 50% of the overall length of the side portion of the holder, the stopper may be disposed within a region between points corresponding to 35% and 65% of the length of the side portion of the holder.

A camera device according to another embodiment includes a fixed unit including a cover member, a moving unit including a holder disposed inside the cover member and an image sensor, and a support unit coupled to the holder and configured to support the moving unit with respect to the fixed unit, wherein the holder includes a first stopper protruding from an outer side surface of a first side portion of the holder toward a first side plate of the cover member in a second direction perpendicular to a first direction parallel to an optical axis, and the first stopper protrudes relative to the support unit coupled to the holder.

The holder may include a second stopper protruding from an outer side surface of a second side portion of the holder toward a second side plate of the cover member in a direction opposite the first stopper, and the second stopper may protrude relative to the support unit coupled to the holder. The support unit may include a first hole formed therein to allow a portion of the first stopper to pass therethrough and a second hole formed therein to allow the second stopper to pass therethrough.

The holder may include a third stopper protruding from an outer side surface of a third side portion of the holder in a third direction perpendicular to the first direction and the second direction and a fourth stopper protruding from an outer side surface of a fourth side portion of the holder in a direction opposite the third stopper.

The holder may include a first recess formed in the outer side surface of the third side portion of the holder and a second recess formed in the outer side surface of the fourth side portion of the holder, the third stopper may protrude from a bottom surface of the first recess, and the fourth stopper may protrude from a bottom surface of the second recess.

Each of the third stopper and the fourth stopper may be located farther inward than the support unit.

The protruding length of the third stopper may be less than the distance from the outer side surface of the third side portion of the holder to the bottom surface of the first recess, and the protruding length of the fourth stopper may be less than the distance from the outer side surface of the fourth side portion of the holder to the bottom surface of the second recess.

The base may include a first protruding portion formed so as to oppose the first recess in the holder and to allow a portion of the support unit to be coupled thereto and a second protruding portion formed so as to oppose the second recess in the holder and to allow another portion of the support unit to be coupled thereto, the third stopper may oppose the first protruding portion of the base, and the fourth stopper may oppose the second protruding portion of the base.

An actuator according to an embodiment includes a fixed unit including a cover member including an upper plate and a side plate connected to the upper plate, a moving unit including a holder disposed inside the cover member and a first circuit board disposed on the holder, and a support unit coupled to the holder and configured to support the moving unit with respect to the fixed unit, wherein the holder includes a side portion, a corner portion, and a stopper protruding from an outer side surface of the side portion of the holder toward the side plate of the cover member, and the stopper is disposed closer to the center of the side portion of the holder than to the corner portion of the holder.

### Advantageous Effects

According to embodiments, a gap between an OIS moving unit and a fixed unit necessary for OIS operation may be reduced.

According to embodiments, an impulse reduction effect may be exhibited by reducing the gap, and accordingly, the OIS moving unit may be inhibited from being damaged or broken due to impact or collision.

### DESCRIPTION OF DRAWINGS

FIG. 1 is a perspective view of a camera device according to an embodiment.

FIG. 2 is a perspective view of the camera device with a cover member removed therefrom.

FIG. 3 is an exploded perspective view of the camera device in FIG. 1.

FIG. 4A is a cross-sectional view taken along line AB in the camera device in FIG. 1.

FIG. 4B is a cross-sectional view taken along line CD in the camera device in FIG. 1.

FIG. 4C is a cross-sectional view taken along line EF in the camera device in FIG. 1.

FIG. 5 is an exploded perspective view of an AF driving unit in FIG. 3.

FIG. 6 is a perspective view of a bobbin, a sensing magnet, a balancing magnet, a first coil, a circuit board, a first position sensor, and a capacitor.

FIG. 7A is a perspective view of the bobbin, a housing, the circuit board, an upper elastic member, the sensing magnet, and the balancing magnet.

FIG. 7B is a perspective view of the configuration shown in FIG. 7A with a wire added thereto.

FIG. 8 is a bottom perspective view of the housing, the bobbin, a lower elastic member, a magnet, and the circuit board.

FIG. 9 is a perspective view of an image sensor unit.

FIG. 10A is a first exploded perspective view of the image sensor unit in FIG. 9.

FIG. 10B is a second exploded perspective view of the image sensor unit in FIG. 9.

FIG. 11 is a bottom perspective view of a holder, a terminal unit, a first board unit, a support board, a base, and a second board unit in FIG. 10A.

FIG. 12A is a perspective view of the holder.

FIG. 12B is a plan view of the holder, the first board unit, the image sensor, a second coil, and an OIS position sensor.

FIG. 13 is a rear perspective view of the holder and the first board unit.

FIG. 14 is a perspective view of the base, the terminal unit, and the wire.

FIG. 15 is a bottom view of the first board unit, the support board, and a heat dissipation member.

FIG. 16 is a perspective view of the first board unit, the support board, and the heat dissipation member.

FIG. 17A is a first perspective view of the support board coupled to the holder and to the base.

FIG. 17B is a second perspective view of the support board coupled to the holder and to the base.

FIG. 17C is a view of the configuration shown in FIG. 17A with the support board removed therefrom.

FIG. 17D is a view of the configuration shown in FIG. 17B with the support board removed therefrom.

FIG. 18A is a view for explaining movement of an OIS moving unit in an X-axis direction.

FIG. 18B is a view for explaining movement of the OIS moving unit in a y-axis direction.

FIG. 18C is a view for explaining rotation of the OIS moving unit in the clockwise direction in a four-channel drive mode.

FIG. 18D is a view for explaining rotation of the OIS moving unit in the counterclockwise direction in the four-channel drive mode.

FIG. 19A shows an embodiment of the magnet in FIG. 5.

FIG. 19B shows another embodiment of the magnet in FIG. 5.

FIG. 20A is a view showing an embodiment of placement of first to third regions of the second board unit, an extension region, an AF moving unit, an OIS moving unit, and a controller.

FIG. 20B is a schematic cross-sectional view of the lens module, the first board unit, the image sensor, the second board unit, and the heat dissipation member.

FIG. 21 is a block diagram showing the configuration of the controller and first to third sensors.

FIG. 22 is a plan view of the holder, the base, and the cover member.

FIG. 23A is an enlarged view of a first dotted line portion in FIG. 22.

FIG. 23B is an enlarged view of a second dotted line portion in FIG. 22.

FIG. 24 is a cross-sectional view of the image sensor unit and the cover member in a direction perpendicular to an optical axis.

FIG. 25 is a perspective view of a camera device according to another embodiment.

FIG. 26 is a perspective view of a holder of the camera device shown in FIG. 25.

FIG. 27 is a perspective view of a holder according to another embodiment.

FIG. 28A is a perspective view of an optical instrument according to an embodiment.

FIG. 28B is a perspective view of an optical instrument according to another embodiment.

FIG. 29 is a configuration diagram of the optical instruments shown in FIGS. 28A and 28B.

### BEST MODE

Hereinafter, embodiments of the present disclosure will be described in detail with reference to the accompanying drawings.

The technical spirit of the disclosure is not limited to the embodiments to be described, and may be implemented in various other forms, and one or more of the components may be selectively combined and substituted for use without exceeding the scope of the technical spirit of the disclosure.

In addition, terms (including technical and scientific terms) used in the embodiments of the disclosure, unless specifically defined and described explicitly, are to be interpreted as having meanings that may be generally understood by those having ordinary skill in the art to which the disclosure pertains, and meanings of terms that are commonly used, such as terms defined in a dictionary, should be interpreted in consideration of the context of the relevant technology.

Further, the terms used in the embodiments of the disclosure are for explaining the embodiments and are not intended to limit the disclosure. In this specification, the singular forms may also include plural forms unless otherwise specifically stated in a phrase, and in the case in which “at least one (or one or more) of A, B, or C” is stated, it may include one or more of all possible combinations of A, B, and C.

In addition, in describing the components of the embodiments of the disclosure, terms such as “first”, “second”, “A”, “B”, “(a)”, and “(b)” can be used. Such terms are only for distinguishing one component from another component, and do not determine the nature, sequence, or procedure of the corresponding constituent elements.

In addition, when it is described that a component is “connected”, “coupled” or “joined” to another component, the description may include not only being directly “connected”, “coupled” or “joined” to the other component but also being “connected”, “coupled” or “joined” by another component between the component and the other component. In addition, in the case of being described as being formed or disposed “above (on)” or “below (under)” another component, the description includes not only the case where the two components are in direct contact with each other, but also the case where one or more other components are formed or disposed between the two components. In addition, when expressed as “above (on)” or “below (under)”, it may refer to a downward direction as well as an upward direction with respect to one element.

Hereinafter, an AF driving unit may alternatively be referred to as a lens driving device, a lens driving unit, a voice coil motor (VCM), an actuator, or a lens moving device. Hereinafter, a “coil” may alternatively be referred to as a coil unit, and an “elastic member” may alternatively be referred to as an elastic unit or a spring.

In addition, in the following description, a “terminal” may alternatively be referred to as a pad, an electrode, a conductive layer, or a bonding unit.

In the following description, the terms “board unit”, “printed circuit board”, “circuit board”, and “board” may be used interchangeably.

For convenience of description, a camera device according to an embodiment will be described using the Cartesian coordinate system (x, y, z), but the embodiments are not limited thereto, and may be described using other coordinate systems. In the respective drawings, the x-axis and the y-axis may be directions perpendicular to the z-axis, which is an optical-axis direction, the z-axis direction, which is the direction of the optical axis OA, may be referred to as a “first direction”, the x-axis direction may be referred to as a “second direction”, and the y-axis direction may be referred to as a “third direction”. In addition, for example, the x-axis direction may be referred to as “one of the first horizontal direction and the second horizontal direction”, and the y-axis direction may be referred to as “the other of the first horizontal direction and the second horizontal direction”.

In addition, for example, the optical axis may be an optical axis of a lens mounted to a lens barrel. Alternatively, for example, the optical axis may be an axis that is perpendicular to an imaging area of an image sensor and passes through the center of the imaging area.

The first direction may be a direction perpendicular to the imaging area of the image sensor. In addition, for example, the optical-axis direction may be a direction parallel to the optical axis.

The camera device according to the embodiment may perform an “autofocus function”. Here, the autofocus function is a function of automatically focusing an image of a subject on the surface of the image sensor.

Hereinafter, the camera device may alternatively be referred to as a “camera module”, a “camera assembly”, a “camera unit”, a “camera”, an “image-capturing device”, or a “lens moving device”.

In addition, the camera device according to the embodiment may perform a “hand-tremor compensation function”. Here, the hand-tremor compensation function is a function of inhibiting the contour of a captured still image from being blurred due to vibration caused by shaking of a hand of a user when capturing the still image.

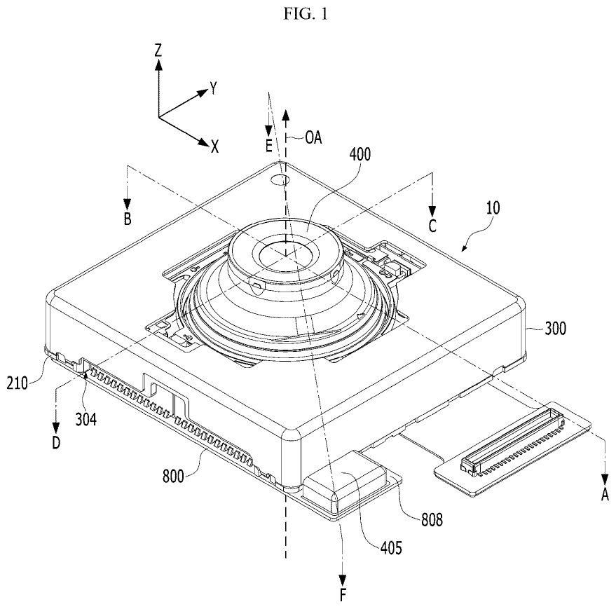

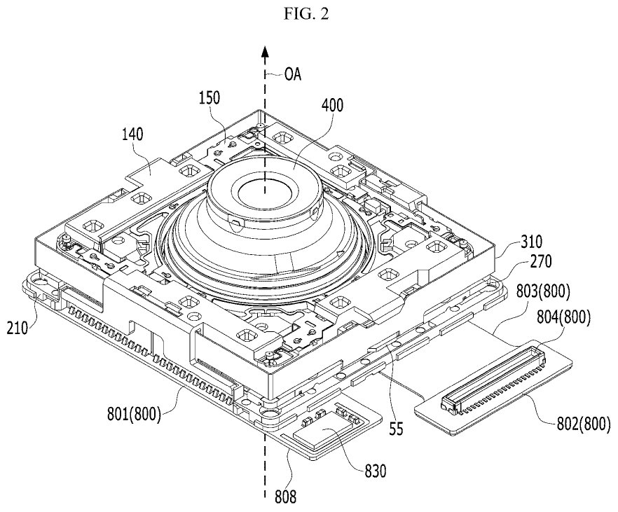

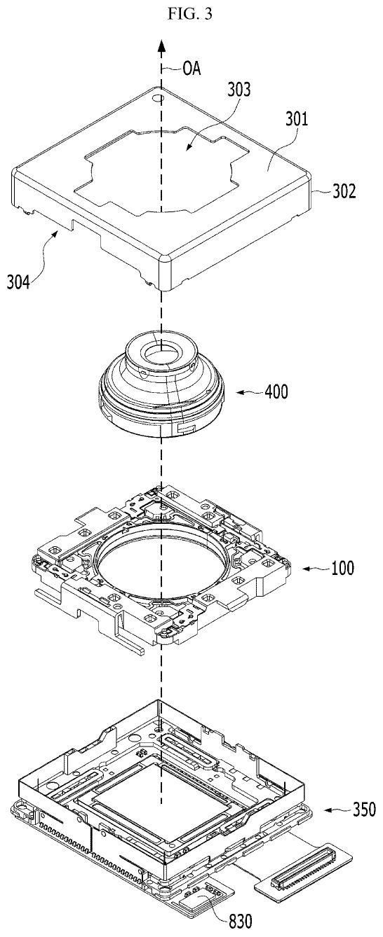

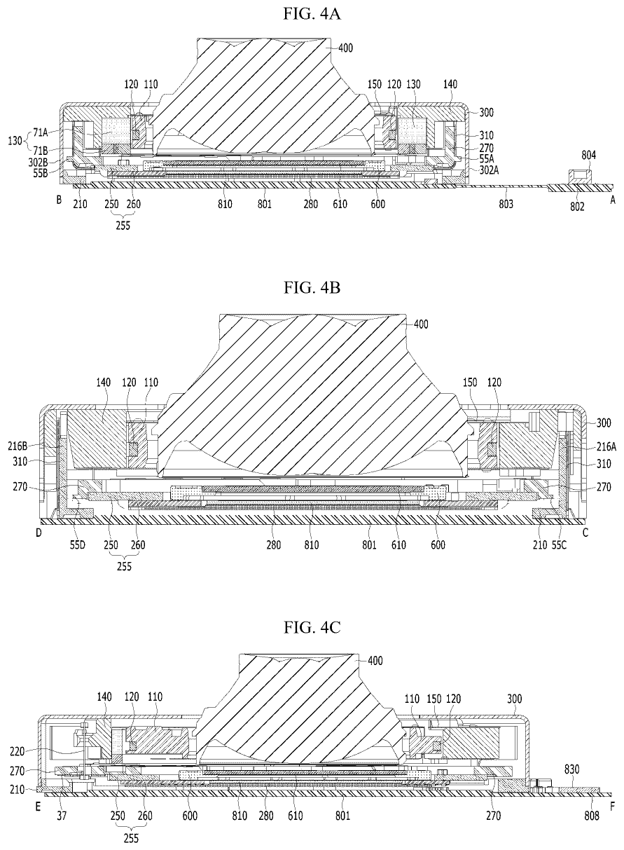

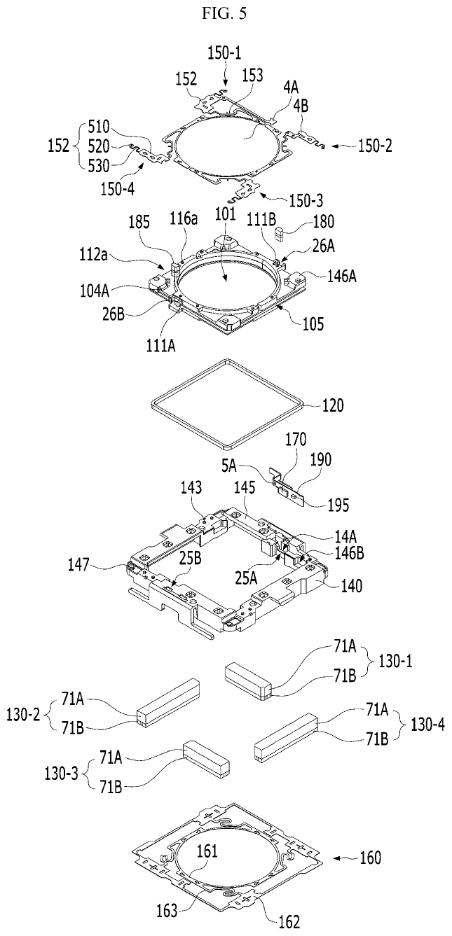

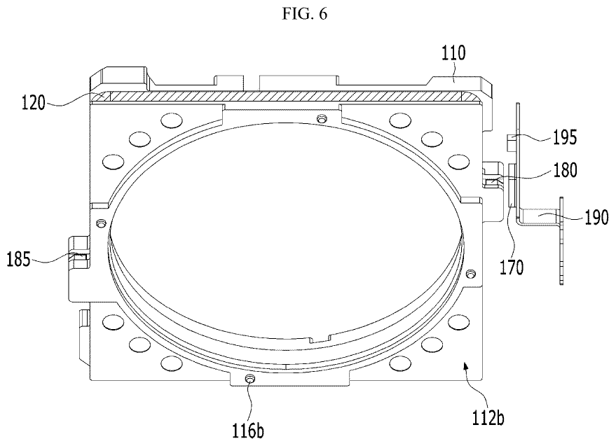

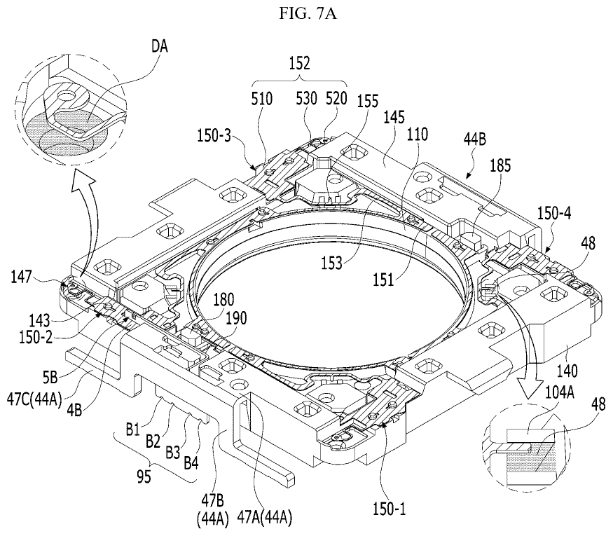

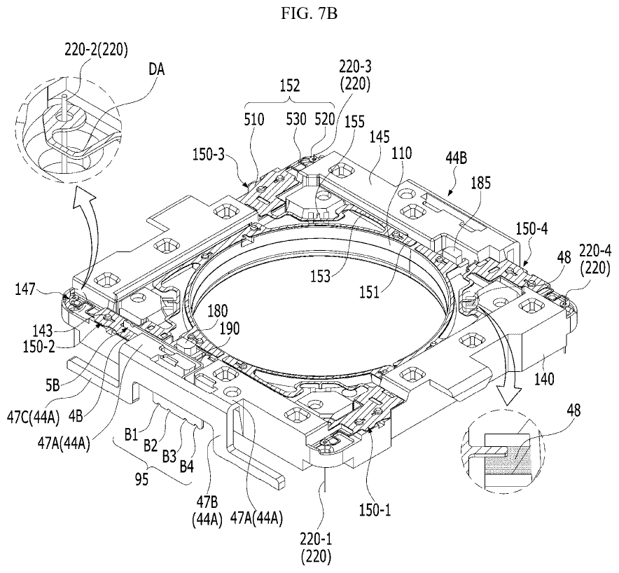

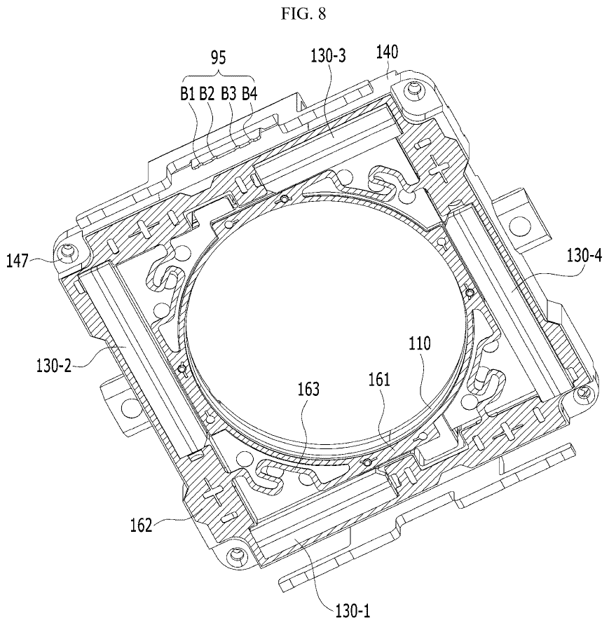

FIG. 1 is a perspective view of a camera device 10 according to an embodiment, FIG. 2 is a perspective view of the camera device 10, with a cover member 300 removed therefrom, FIG. 3 is an exploded perspective view of the camera device 10 in FIG. 1, FIG. 4A is a cross-sectional view taken along line AB in the camera device 10 in FIG. 1, FIG. 4B is a cross-sectional view taken along line CD in the camera device 10 in FIG. 1, FIG. 4C is a cross-sectional view taken along line EF in the camera device 10 in FIG. 1, FIG. 5 is an exploded perspective view of an AF driving unit 100 in FIG. 3, FIG. 6 is a perspective view of a bobbin 110, a sensing magnet 180, a balancing magnet 185, a first coil 120, a circuit board 190, a first position sensor 170, and a capacitor 195, FIGS. 7A and 7B are perspective views of the bobbin 110, a housing 140, the circuit board 190, an upper elastic member 150, the sensing magnet 180, and the balancing magnet 185, and FIG. 8 is a bottom perspective view of the housing 140, the bobbin 110, a lower elastic member 160, a magnet 130, and the circuit board 190.

Referring to FIGS. 1 to 8, the camera device 10 may include an AF driving unit 100 and an image sensor unit 350. The AF driving unit 100 may include an AF moving unit. The image sensor unit 350 may include an “OIS driving unit”.

The OIS driving unit may include an OIS moving unit. One of the AF moving unit and the OIS moving unit may be a first moving unit, and the other of the AF moving unit and the OIS moving unit may be a second moving unit.

The AF driving unit 100 may alternatively be referred to as a “lens moving unit” or a “lens driving device”. Alternatively, the AF driving unit 100 may alternatively be referred to as a “first moving unit (or second moving unit)” or a “first actuator (or second actuator)”.

The OIS driving unit may alternatively be referred to as a “sensor moving unit” or a “sensor moving device”. Alternatively, the OIS driving unit may be referred to as a “second moving unit (or first moving unit)” or a “second actuator (or first actuator)”.

The camera device 10 may further include at least one of a cover member 300 or a lens module 400. The cover member 300 and a base 210 to be described later may constitute a case.

The “actuator” according to the embodiment may include at least one of the AF driving unit or the OIS driving unit. For example, the actuator according to the embodiment may not include at least one of the lens module 400 or the image sensor 810 in the camera device 10. For example, the actuator according to the embodiment may include at least one of the components of the camera device 10, but may have a configuration in which the lens module 400 and the image sensor 810 are omitted.

The AF driving unit 100 may be coupled to a lens module 400, and may move the lens module in the direction of the optical axis OA or a direction parallel to the optical axis, thereby performing the autofocus function of the camera device 10.

The image sensor unit 350 may alternatively be referred to as an “image sensor moving unit”, an “image sensor shift unit”, a “sensor moving unit”, or a “sensor shift unit”. Alternatively, the image sensor unit 350 may be referred to as a “second moving unit (or first moving unit)” or a “second actuator (or first actuator)”.

The image sensor unit 350 may include an image sensor 810. For example, the image sensor unit 350 may include an OIS moving unit including the image sensor 810. For example, the image sensor unit 350 may move the OIS moving unit (e.g., image sensor 810) in a direction perpendicular to the optical axis. In addition, the image sensor unit 350 may tilt or rotate (or roll) the OIS moving unit (e.g., image sensor 810) with respect to the optical axis or about the optical axis. The hand-tremor compensation function of the camera device 10 may be performed by the image sensor unit 350.

In an example, the image sensor 810 may include an imaging area for sensing of light that has passed through the lens module 400. Here, the imaging area may alternatively be referred to as an effective area, a light-receiving area, an active area, or a pixel area. For example, the imaging area of the image sensor 810 may be a portion into which light that has passed through a filter 610 is introduced so as to form an image contained in the light, and may include at least one unit pixel. In an example, the imaging area may include a plurality of unit pixels.

Referring to FIGS. 5 and 6, the AF driving unit 100 may move a lens module 400 in the optical-axis direction. In an example, the AF driving unit 100 may move a bobbin 110 in the optical-axis direction. In an example, the AF driving unit 100 may include the bobbin 110, a first coil 120, a magnet 130, and a housing 140. The AF driving unit 100 may further include an upper elastic member 150 and a lower elastic member 160.

In addition, the AF driving unit 100 may further include a first position sensor 170, a circuit board 190, and a sensing magnet 180 in order to implement AF feedback. In addition, the AF driving unit 100 may further include at least one of a balancing magnet 185 or a capacitor 195

The bobbin 110 may be disposed in the housing 140, and may be moved in the direction of the optical axis OA or the first direction (e.g., the Z-axis direction) by electromagnetic interaction between the first coil 120 and the magnet 130.

The bobbin 110 may have a bore formed therein in order to be coupled to the lens module 400 or to mount the lens module 400 therein. In an example, the bore in the bobbin 110 may be a through-hole formed through the bobbin 110 in the optical-axis direction and may have a circular shape, an elliptical shape, or a polygonal shape. However, the disclosure is not limited thereto.

The lens module 400 may include at least one lens and/or a lens barrel. In an example, the lens module 400 may include one or more lenses and a lens barrel accommodating the one or more lenses. However, the disclosure is not limited thereto, and any of various holding structures may be used in place of the lens barrel, so long as the same is capable of supporting one or more lenses.

In an example, the lens module 400 may be screwed to the bobbin 110. Alternatively, in another example, the lens module 400 may be coupled to the bobbin 110 by means of an adhesive (not shown). Meanwhile, light that has passed through the lens module 400 may pass through the filter 610, and may be introduced into the image sensor 810.

The bobbin 110 may include at least one protruding portion 111A or 111B provided on an outer surface thereof. In an example, the at least one protruding portion 111A or 111B may protrude in a direction parallel to a straight line perpendicular to the optical axis OA. However, the disclosure is not limited thereto. In an example, the bobbin 110 may include two protruding portions 111A and 111B located opposite each other.

The protruding portions 111A and 111B of the bobbin 110 may correspond to recessed portions 25A and 25B in the housing 140 to be inserted into or disposed in the recessed portions 25A and 25B in the housing 140, and may suppress or inhibit the bobbin 110 from rotating beyond a predetermined range about the optical axis.

The bobbin 110 may include a protruding portion 146A protruding in a direction perpendicular to the optical axis. In an example, the protruding portion 146A of the bobbin 110 may be disposed on a corner portion of the bobbin. The housing 140 may include a recess 146B formed therein so as to correspond to, face, or overlap the protruding portion 146A of the bobbin 110. The protruding portion 146A of the bobbin 110 may serve as a stopper that allows the bobbin 110 to move within a prescribed range in the optical-axis direction (e.g., the direction from the upper elastic member 150 toward the lower elastic member 160).

The bobbin 110 may include a first escape recess 112a formed in an upper surface thereof in order to avoid spatial interference with a first frame connection portion 153 of the upper elastic member 150. In addition, the bobbin 110 may include a second escape recess 112b formed in a lower surface thereof in order to avoid spatial interference with a second frame connection portion 163 of the lower elastic member 160.

The bobbin 110 may include a first coupling portion 116a in order to be coupled or fixed to the upper elastic member 150. For example, the first coupling portion 116a of the bobbin 110 may take the form of a protrusion. However, the disclosure is not limited thereto. In another embodiment, the first coupling portion may take the form of a flat surface or a recess. In addition, the bobbin 110 may include a second coupling portion 116b in order to be coupled or fixed to the lower elastic member 160. For example, the second coupling portion 116b may take the form of a protrusion. However, the disclosure is not limited thereto. In another embodiment, the second coupling portion may take the form of a flat surface or a recess.

Referring to FIG. 5, the bobbin 110 may include a recess 105 formed in the outer surface thereof to allow the first coil 120 to be seated therein, inserted thereinto, or disposed therein. For example, the recess 105 in the bobbin 110 may have a shape coinciding with the shape of the first coil 120 or may have a closed curve shape (e.g., ring shape).

In addition, the bobbin 110 may include a first seating recess 26a formed therein to allow the sensing magnet 180 to be seated therein, inserted thereinto, fixed thereto, or disposed therein. In addition, the bobbin 110 may include a second seating recess 26b formed in the outer surface thereof to allow the balancing magnet 185 to be seated therein, inserted thereinto, fixed thereto, or disposed therein.

In an example, the first and second seating recesses 26A and 26B in the bobbin 110 may be formed in the outer surfaces of the bobbin 110 that face each other. In an example, the first seating recess 26A may be formed in the first protruding portion 111A of the bobbin 110, and the second seating recess 26B may be formed in the second protruding portion 111B of the bobbin 110.

Referring to FIGS. 5, 7A, and 7B, a damper 48 may be disposed between the bobbin 110 and the upper elastic member 150. In an example, the damper 48 may be disposed between the bobbin 110 and the first frame connection portion 153 of the upper elastic member 150 so as to be in contact therewith, coupled thereto, or attached thereto.

In an example, the upper elastic member 150 may include an extension portion (or protruding portion) 155 extending from the first frame connection portion 153. The extension portion 155 may be spaced apart from each of an outer frame 152 and an inner frame 151. In addition, the extension portion 155 may be spaced apart from one end of the first frame connection portion 153 that is connected to the inner frame 151 and the other end of the first frame connection portion 153 that is connected to the outer frame 152. The extension portion 155 may extend above the upper surface of the bobbin 110. In an example, a part (or end) of the extension portion 155 may be disposed on a guide portion 104A of the bobbin 110 and may overlap the guide portion 104A in the optical-axis direction.

The damper 48 may be disposed between the guide portion 104A of the bobbin 110 and the extension portion 155 of the upper elastic member 150 so as to be in contact therewith, coupled thereto, or attached thereto. Because the damper 48 is in contact with or attached to the extension portion 155 and the bobbin 110, the damper 48 may serve to alleviate or absorb vibration of the bobbin 110. For example, the damper 48 may be formed as a damping member (e.g., silicone).

In an example, the guide portion 104A of the bobbin 110 may include a protrusion protruding upward from the escape portion 112a of the bobbin 110. In addition, in an example, the guide portion 104A of the bobbin 110 may include a recess formed therein to allow the damper 48 to be received or disposed therein.

The first coil 120 is disposed on or coupled to the bobbin 110. In an example, the first coil 120 may be disposed on or coupled to the outer surface of the bobbin 110. In an example, the first coil 120 may surround the outer surface of the bobbin 110 in the direction of rotation about the optical axis OA. However, the disclosure is not limited thereto.

The first coil 120 may be directly wound around the outer surface of the bobbin 110. However, the disclosure is not limited thereto. In another embodiment, the first coil 120 may be wound around the bobbin 110 using a coil ring or may be implemented as a coil block having an angled ring shape.

Power or a driving signal may be supplied to the first coil 120. The power or the driving signal supplied to the first coil 120 may be a direct current signal, an alternating current signal, or a signal containing direct current and alternating current components, and may be of a voltage type or a current type.

When a driving signal (e.g., driving current) is supplied to the first coil 120, electromagnetic force may be generated by electromagnetic interaction with the magnet 130, and the bobbin 110 may be moved in the direction of the optical axis OA by the generated electromagnetic force.

At the initial position of the AF driving unit, the bobbin 110 may be moved upward or downward, which is referred to as bidirectional driving of the AF driving unit. Alternatively, at the initial position of the AF driving unit, the bobbin 110 may be moved upward, which is referred to as unidirectional driving of the AF driving unit.

At the initial position of the AF driving unit, the first coil 120 may be disposed so as to correspond to or overlap the magnet 130, which is disposed in the housing 140, in a direction parallel to a straight line that is perpendicular to the optical axis OA and extends through the optical axis.

In an example, the AF driving unit may include the bobbin 110 and components coupled to the bobbin 110 (e.g., the first coil 120, the sensing magnet 180, and the balancing magnet 185). In addition, the AF driving unit may further include the lens module 400.

In addition, the initial position of the AF driving unit may be the original position of the AF driving unit in a state in which no power is supplied to the first coil 120 or a position at which the AF driving unit is located as a result of the upper and lower elastic members 150 and 160 being elastically deformed due only to the weight of the AF driving unit. In addition, the initial position of the bobbin 110 may be a position at which the AF driving unit is located when gravity acts in a direction from the bobbin 110 toward the base 210 or when gravity acts in a direction from the base 210 toward the bobbin 110.

The sensing magnet 180 may provide a magnetic field, which is to be detected by the first position sensor 170, and the balancing magnet 185 may serve to cancel out the influence of the magnetic field of the sensing magnet 180 and to establish weight equilibrium with the sensing magnet 180.

The sensing magnet 180 may alternatively be referred to as a “sensor magnet” or a “second magnet”. The sensing magnet 180 may be disposed on the bobbin 110 or may be coupled to the bobbin 110. The sensing magnet 180 may be disposed so as to face the first position sensor 170. The balancing magnet 185 may be disposed on the bobbin 110 or may be coupled to the bobbin 110. In an example, the balancing magnet 185 may be disposed opposite the sensing magnet 180.

In an example, each of the sensing magnet 180 and the balancing magnet 185 may be a monopolar-magnetized magnet, which has one N pole and one S pole. However, the disclosure is not limited thereto. In another embodiment, each of the sensing magnet 180 and the balancing magnet 185 may be a bipolar-magnetized magnet or a 4-pole magnet, which includes two N poles and two S poles.

The sensing magnet 180 may be moved in the optical-axis direction together with the bobbin 110, and the first position sensor 170 may detect the intensity of the magnetic field or the magnetic force of the sensing magnet 180, which is moved in the optical-axis direction, and may output an output signal corresponding to a result of the detection.

In an example, the intensity of the magnetic field or the magnetic force detected by the first position sensor 170 may vary depending on displacement of the bobbin 110 in the optical-axis direction, the first position sensor 170 may output an output signal proportional to the detected intensity of the magnetic field, and the displacement of the bobbin 110 in the optical-axis direction may be detected using the output signal from the first position sensor 170.

The housing 140 is disposed inside the cover member 300. In an example, the housing 140 may be disposed on the image sensor unit 350.

The housing 140 may accommodate therein the bobbin 110 and may support the magnet 130, the first position sensor 170, and the circuit board 190.

Referring to FIGS. 5, 7A, 7B, and 8, the housing 140 may be formed in the overall shape of a hollow column. In an example, the housing 140 may include a polygonal (e.g., quadrangular or octagonal) or circular bore formed therein, and the bore in the housing 140 may take the form of a through-hole formed through the housing 140 in the optical-axis direction.

The housing 140 may include side portions, which correspond to or face side plates 302 of the cover member 300, and corners, which correspond to or face the corners of the cover member 300.

The housing 140 may be provided on the upper portion, upper surface, or upper end thereof with a stopper 145 in order to avoid direct collision with the inner surface of an upper plate 301 of the cover member 300.

Referring to FIG. 5, the housing 140 may include a mounting groove (or groove) 14A formed therein to accommodate the circuit board 190. The mounting groove 14A may have a shape coinciding with the shape of the circuit board 190.

Referring to FIGS. 7A and 7B, the housing 140 may include protruding portions 44A and 44B that surround at least one of the circuit board 190 or a support board 310. In an example, the protruding portions 44A and 44B may be disposed or formed on the outer surface of the housing 140. In an example, the protruding portions 44A and 44B may be disposed or formed on the outer surfaces of the side portions of the housing 140. The protruding portions 44A and 44B may alternatively be referred to as “protective portions”, “support portions”, “extension portions”, or guide portions.

The protruding portions 44A and 44B of the housing 140 may surround at least a portion of the circuit board 190 and at least a portion of the support board 310. In an example, the housing 140 may include a first protruding portion 44A disposed on a first side portion of the housing and a second protruding portion 44B disposed on a second side portion of the housing 140. The first protruding portion 44A and the second protruding portion 44B may be located opposite each other with respect to the optical axis OA or the bobbin 110. In another embodiment, the second protruding portion 44B may be omitted.

In an example, the circuit board 190 may be disposed inside the first protruding portion 44A. In an example, the mounting groove 14A may be formed in the first protruding portion 44A.

In an example, each of the first protruding portion 44A and the second protruding portion 44B may include a first portion 47A connected to the upper surface of the housing 140 and a second portion 47B connected to the first portion 47A and spaced apart from the side portion of the housing 140. In an example, the first portion 47A of the first protruding portion 44A may be connected to the upper surface of the first side portion of the housing 140, and the first portion 47A of the second protruding portion 44B may be connected to the upper surface of the second side portion of the housing 140. In an example, the first portion 47A may protrude from the upper surface of the housing 140 in the optical-axis direction or toward the inner surface of the upper plate 301 of the cover member 300.

In an example, at least a portion of the circuit board 190 may be located between the first portion 47A and the second portion 47B of the first protruding portion 44A. In addition, in an example, at least a portion of the support board 310 may be located between the first portion 47A and the second portion 47B of the first protruding portion 44A.

The housing 140 may include an opening formed therein to expose terminals B1 to B4 of a terminal unit 95 of the circuit board 190 therethrough, and the opening may be formed in the side portion of the housing 140.

Each of the first protruding portion 44A and the second protruding portion 44B of the housing 140 may include a third portion 47C extending from the second portion 47B. In an example, the third portion 47C may extend or protrude from the lower side or lower end of the second portion 47B in a direction parallel to the outer surface of the first side portion (or second side portion) of the housing 140 (e.g., in the second horizontal direction).

In an example, the third portion 47C may include a 3-1^{st} portion extending from one end of the second portion 47B and a 3-2^{nd} portion extending from another end of the second portion, and the 3-1^{st} portion and the 3-2^{nd} portion may extend or protrude in opposite directions.

An adhesive or a sealing member may be disposed between the protruding portions 44A and 44B of the housing 140 and the cover member 300. In an example, the adhesive (or sealing member) may be disposed between the protruding portions 44A and 44B of the housing 140 and the side plates 302 of the cover member 300 and may couple the protruding portions and the side plates to each other. The protruding portions 44A and 44B may increase a coupling area in which the same are coupled to the side plates of the cover member 300 and may stably couple the housing 140 and the cover member 300 to each other without interference with the support board 310.

The housing 140 may be provided on the upper portion, upper end, or upper surface thereof with at least one first coupling portion 143, which is coupled to a first outer frame 152 of the upper elastic member 150. The housing 140 may be provided on the lower portion, lower end, or lower surface thereof with a second coupling portion, which is coupled and fixed to a second outer frame 162 of the lower elastic member 160. For example, each of the first and second coupling portions of the housing 140 may be formed in the shape of a flat surface, a protrusion, or a recess.

A hole 147, which is a passage through which a wire 220 passes, may be formed in a corner of the housing 140. The hole 147 may be a through-hole formed through the housing 140 in the optical-axis direction. In another embodiment, the hole may be structured so as to be depressed in the outer surface of a corner portion of the housing 140, and at least a portion of the hole may be open to the outer surface of the corner portion. The hole 147 in the housing 140 may be provided in the same number as the number of support members.

The magnet 130 may be disposed on, coupled to, or fixed to the housing 140, which is a fixed unit. In an example, the magnet 130 may be disposed on, coupled to, or fixed to a side portion of the housing 140. The magnet 130 may include an AF driving magnet 71A for AF driving. In addition, the magnet 130 may include an OIS driving magnet 71B for OIS driving. Hereinafter, the AF driving magnet 71A may be referred to as one of the first magnet and the second magnet, and the OIS driving magnet 71B may be referred to as the other of the first magnet and the second magnet.

In another embodiment, the magnet 130 may be disposed on, coupled to, or fixed to the corner portion of the housing.

In an example, the magnet 130 may include a plurality of magnet units. In an example, the magnet 130 may include first to fourth magnet units 130-1 to 130-4 disposed on the housing 140. In another embodiment, the magnet 130 may include two or more magnet units.

The magnet 130 may be disposed on at least one of the side portion or the corner of the housing 140. In an example, at least a portion of the magnet 130 may be disposed on the side portion or the corner of the housing 140. Alternatively, in another example, at least a portion of the magnet 130 may be disposed on the side portion of the housing 140, and the remaining portion thereof may be disposed on the corner of the housing 140.

In an example, each of the magnet units 130-1 to 130-4 may include a first portion disposed on a corresponding corner among the four corners of the housing 140. In addition, each of the magnet units 130-1 to 130-4 may include a second portion disposed on the side portion of the housing 140 that is adjacent to the corresponding corner of the housing 140.

In an example, the first magnet unit 130-1 and the third magnet unit 130-3 may be located on opposite sides of the housing 140 in the first horizontal direction (e.g., the Y-axis direction). In an example, the second magnet unit 130-2 and the fourth magnet unit 130-4 may be located on opposite sides of the housing 140 in the second horizontal direction (e.g., the X-axis direction).

In an example, the first magnet unit 130-1 and the third magnet unit 130-3 may be disposed parallel to each other in the second horizontal direction (e.g., the X-axis direction), and the second magnet unit 130-2 and the fourth magnet unit 130-4 may be disposed parallel to each other in the first horizontal direction (e.g., the Y-axis direction).

At the initial position of the AF driving unit, the magnet 130 may be disposed on the housing 140 such that at least a portion thereof overlaps the first coil 120 in a direction parallel to a straight line that is perpendicular to the optical axis OA and extends through the optical axis OA.

The magnet 130 may include a monopolar-magnetized magnet or a 2-pole magnet including one N-pole area and one S-pole area. In another embodiment, the magnet 130 may include a bipolar-magnetized magnet or a 4-pole magnet including two N-pole areas and two S-pole areas. In still another embodiment, the magnet 130 may include a monopolar-magnetized magnet and a bipolar-magnetized magnet.

In an example, the magnet 130 may include a magnet for AF (or AF driving magnet) for implementation of AF operation and a magnet for OIS (or OIS driving magnet) for implementation of OIS operation. In another embodiment, the magnet 130 may be a common magnet for implementation of AF operation and OIS operation.

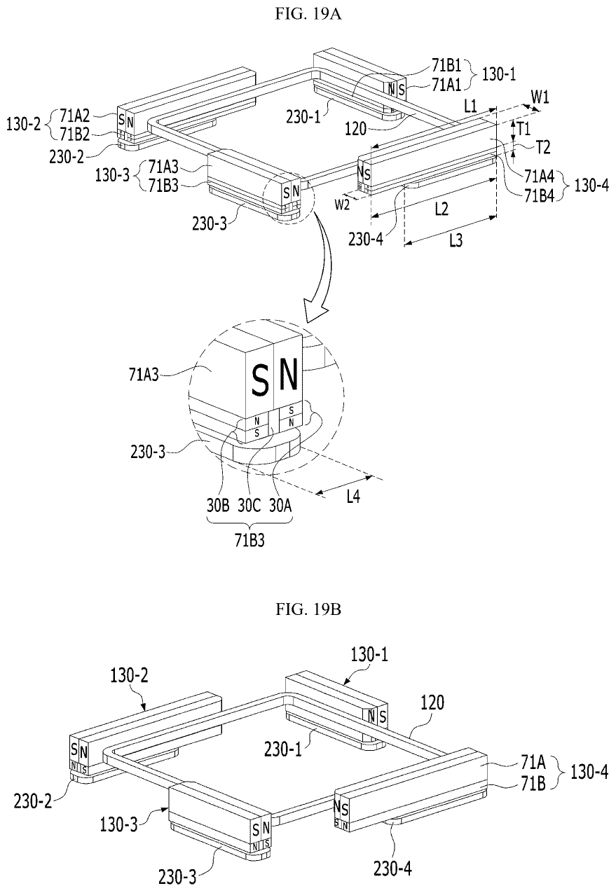

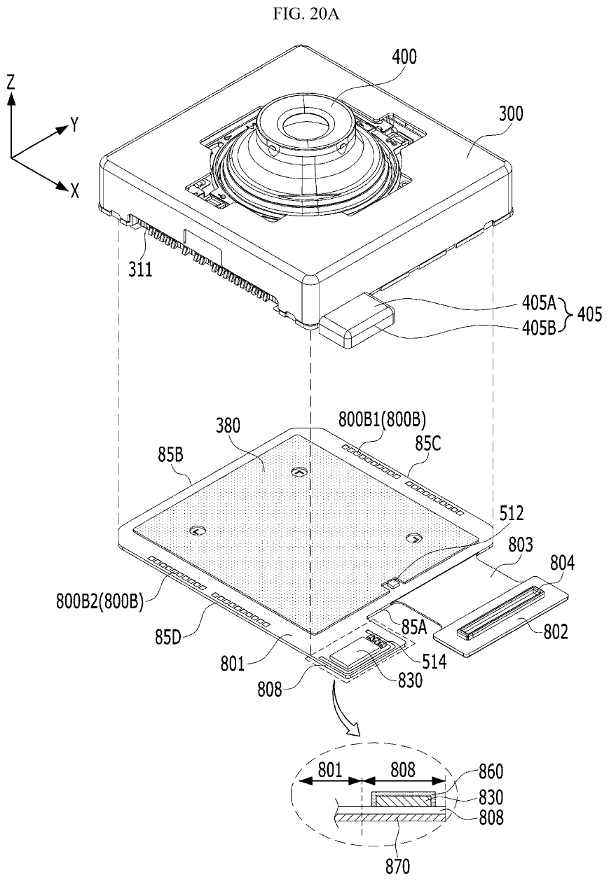

FIG. 19A shows an embodiment of the magnet 130 in FIG. 5.

Referring to FIG. 19A, the magnet 130 may include a first magnet 71A, which is a magnet for AF, and a second magnet 71B, which is a magnet for OIS disposed beneath the first magnet 71A.

The first magnet 71A may be a 2-pole magnet including one N-pole area and one S-pole area. In an example, the N-pole area and the S-pole area of the first magnet 71A may be disposed so as to face or oppose each other in a direction perpendicular to the optical axis. In another embodiment, the first magnet 71A may be a 4-pole magnet including two N-pole areas and two S-pole areas.

The first magnet 71A may include a plurality of magnet units 71A1 to 71A4. As described above, each of the plurality of magnet units 71A1 to 71A4 may be a 2-pole magnet or a 4-pole magnet. In an example, the magnet units 71A1 to 71A4 may have the same size and shape as each other. In an example, two magnet units 71A1 and 71A3 opposing each other in a first diagonal direction may have the same size and shape as each other, and the remaining two magnet units 71A2 and 71A4 opposing each other in a second diagonal direction may have the same size and shape as each other.

In another embodiment, the size and shape of the two magnet units 71A1 and 71A3 may be different from those of the remaining two magnet units 71A2 and 71A4. In an example, the length of the long side of each of the two magnet units 71A1 and 71A3 may be greater than the length of the long side of each of the remaining two magnet units 71A2 and 71A4. In an example, the length of the short side of each of the two magnet units 71A1 and 71A3 may be equal to the length of the short side of each of the remaining two magnet units 71A2 and 71A4.

The second magnet 71B may be a 4-pole magnet including two N-pole areas and two S-pole areas. In an example, the second magnet 71B may include a first magnet part 30A, a second magnet part 30B, and a partition wall 30C disposed between the first magnet part 30A and the second magnet part 30B. In this case, the partition wall 30C may be a non-magnetic material or air, and may be referred to as a “neutral zone” or a “neutral area”. In another embodiment, the second magnet 71B may be a 2-pole magnet including one N-pole area and one S-pole area.

In an example, the first magnet part 30A and the second magnet part 30B may be spaced apart from each other in a direction perpendicular to the first direction (or the optical-axis direction). In an example, the first magnet part 30A may include a first N-pole area and a first S-pole area opposing or facing each other in the optical-axis direction. The second magnet part 30B may include a second N-pole area and a second S-pole area opposing or facing each other in the optical-axis direction. In addition, the first N-pole area (or the first S-pole area) of the first magnet part 30A and the second S-pole area (or the second N-pole area) of the second magnet part 30B may oppose or face each other in a direction perpendicular to the optical axis.

The second magnet 71B may include a plurality of magnet units 71B1 to 71B4. As described above, each of the plurality of magnet units 71B1 to 71B4 may be a 4-pole magnet. In another embodiment, each of the magnet units 71B1 to 71B4 may be a 2-pole magnet. Each of the magnet units 71B1 to 71B4 may oppose or overlap a corresponding one of the second coil units 230-1 to 230-4 in the optical-axis direction.

In an example, the magnet units 71B1 to 71B4 may have the same size and shape as each other. In an example, two magnet units 71B1 and 71B3 opposing each other in the first diagonal direction may have the same size and shape as each other, and the remaining two magnet units 71B2 and 71B4 opposing each other in the second diagonal direction may have the same size and shape as each other.

In another embodiment, the size and shape of the two magnet units 71B1 and 71B3 may be different from those of the remaining two magnet units 71B2 and 71B4. In an example, the length of the long side of each of the two magnet units 71B1 and 71B3 may be greater than the length of the long side of each of the remaining two magnet units 71B2 and 71B4. In an example, the length of the short side of each of the two magnet units 71B1 and 71B3 may be equal to the length of the short side of each of the remaining two magnet units 71B2 and 71B4.

The second magnet 71B may be disposed beneath the first magnet 71A. The second magnet 71B may be disposed on the lower surface of the first magnet 71A. In an example, the upper surface of the second magnet 71B may be in contact with the lower surface of the first magnet 71A or may be fixed or coupled to the lower surface of the first magnet 71A by means of an adhesive. In an example, at least a portion of the first magnet 71A may overlap at least a portion of the second magnet 71B in the first direction (or the optical-axis direction).

In another embodiment, the second magnet may be spaced apart from the first magnet. In this case, a portion of the housing 140 may be disposed between the first magnet and the second magnet. Alternatively, in another embodiment, a partition wall or a yoke may be disposed between the first magnet and the second magnet spaced apart from each other. In this case, the description of the partition wall 30C may be equally or similarly applied to the partition wall.

In an example, the length T2 of the second magnet 71B in the optical-axis direction may be less than the length T1 of the first magnet 71A in the optical-axis direction (T2<T1). In another embodiment, T2 may be greater than or equal to T1.

In addition, the length L2 of the long side of the second magnet 71B may be less than or equal to the length L1 of the long side of the first magnet 71A (L2≤L1). In another embodiment, L2 may be greater than L1.

In addition, the width W2 (or the length of the short side) of the second magnet 71B may be less than or equal to the width W1 (or the length of the short side) of the first magnet 71A (W2≤W1). In another embodiment, W2 may be greater than W1.

At the initial position of the AF moving unit, the first coil 120 may oppose or overlap the first magnet 71A in a direction perpendicular to the first direction (or the optical-axis direction). In FIG. 19A, the N-pole area of the first magnet 71A may be disposed so as to face the first coil 120, or the N-pole area thereof may be located closer to the first coil 120 than the S-pole area thereof. However, in another embodiment, the position of the N-pole area and the position of the S-pole area may be interchanged.

In an example, at the initial position of the OIS moving unit, at least a portion of the first magnet 130 may overlap at least a portion of the second coil 230 in the first direction (or the optical-axis direction). In an example, at the initial position of the OIS moving unit, at least a portion of the second magnet 71B may overlap at least a portion of the second coil 230 in the first direction (or the optical-axis direction).

The length L2 of the long side of the second magnet 71B may be greater than the length L3 of the long side of the second coil 230 (L2>L3). In another embodiment, the length of the long side of the second magnet 71B may be less than or equal to the length of the long side of the second coil 230.

The width W2 (or the length of the short side) of the second magnet 71B may be greater than the length L4 of the short side of the second coil 230 (W2>L4). In another embodiment, the length of the long side of the second magnet 71B may be less than or equal to the length of the long side of the second coil 230.

In an example, the length of the long side of each of two magnet units 71B1 and 71B3 of the second magnet 71B may be less than the length of the long side of a respective one of the coil units 230-1 and 230-3 of the second coil 230. In another embodiment, the length of the long side of each of the two magnet units 71B1 and 71B3 may be equal to or greater than the length of the long side of a respective one of the coil units 230-1 and 230-3.

In addition, the length of the long side of each of the remaining two magnet units 71B2 and 71B4 of the second magnet 71B may be greater than the length of the long side of a respective one of the coil units 230-2 and 230-4 of the second coil 230. In another embodiment, the length of the long side of each of the magnet units 71B2 and 71B4 may be equal to or less than the length of the long side of a respective one of the coil units 230-2 and 230-4 of the second coil 230.

In an example, the length of the short side of each of the first to fourth magnet units 71B1 to 71B4 of the second magnet 71B may be less than the length of the short side of a respective one of the first to fourth coil units 230-1 to 230-4 of the second coil 230. In another embodiment, the length of the short side of each of the first to fourth magnet units 71B1 to 71B4 may be greater than the length of the short side of a respective one of the first to fourth coil units 230-1 to 230-4.

FIG. 19B shows another embodiment of the magnet 130 in FIG. 5.

Referring to FIG. 19B, the second magnet 71B in FIG. 19B may be a 2-pole magnet including one N-pole area and one S-pole area. The description of the lengths T2, L2, and W2 of the second magnet 71B in FIG. 19A may be equally or similarly applied to the second magnet 71B in FIG. 19B.

The circuit board 190 may be disposed in the housing 140, and the first position sensor 170 may be disposed or mounted on the circuit board 190 and may be conductively connected to the circuit board 190. In an example, the circuit board 190 may be disposed in the mounting groove 14A in the housing 140, and the terminals B1 to B4 of the circuit board 190 may be exposed outside the housing 140.

The circuit board 190 may be provided with a terminal unit (or terminal part) 95 including a plurality of terminals B1 to B4 for conductive connection to an external terminal or an external device. The plurality of terminals B1 to B4 of the circuit board 190 may be conductively connected to the first position sensor 170.

The first position sensor 170 may be disposed on the housing 140 and/or the circuit board 190. In an example, the first position sensor 170 may be disposed on a first surface of the circuit board 190, and the plurality of terminals B1 to B4 may be disposed on a second surface of the circuit board 190. Here, the second surface of the circuit board 190 may be a surface opposite the first surface of the circuit board 190. In an example, the first surface of the circuit board 190 may be the surface of the circuit board 190 that faces the bobbin 110 or the sensing magnet 180. For example, the circuit board 190 may be a printed circuit board or an FPCB.

The first position sensor 170 may be conductively connected to the circuit board 190. In an example, the first position sensor 170 may be conductively connected to the first to fourth terminals B1 to B4 of the circuit board 190. In an example, the circuit board 190 may include a circuit pattern or wiring (not shown) for conductive connection between the first to fourth terminals B1 to B4 and the first position sensor 170.

In an example, at the initial position of the AF driving unit, at least a portion of the first position sensor 170 may oppose or overlap the sensing magnet 180 in a direction parallel to a straight line that is perpendicular to the optical axis OA and extends through the optical axis OA. In another embodiment, at the initial position of the AF driving unit, the first position sensor may not oppose or overlap the sensing magnet.

The first position sensor 170 serves to detect movement, displacement, or position of the bobbin 110 in the optical-axis direction. That is, when the bobbin 110 is moved, the first position sensor 170 may detect the magnetic field or the intensity of the magnetic field of the sensing magnet 180 mounted to the bobbin 110 and may output an output signal corresponding to a result of the detection, and the movement, displacement, or position of the bobbin 110 in the optical-axis direction may be detected using the output from the first position sensor 170.

The first position sensor 170 may be a driver IC including a Hall sensor and a driver. The first position sensor 170 may include first to fourth terminals for transmitting and receiving data to and from the outside through data communication using a protocol, such as I2C communication, and fifth and sixth terminals for directly supplying a driving signal to the first coil 120.

In an example, each of the first to fourth terminals of the first position sensor 170 may be conductively connected to a corresponding one of the first to fourth terminals B1 to B4 of the circuit board 190 by means of solder or a conductive adhesive.

In addition, in an example, the fifth and sixth terminals of the first position sensor 170 may be conductively connected to the first coil 120. In an example, the first position sensor 170 may be conductively connected to the first coil 120 via at least one of the upper elastic member 150 or the lower elastic member 160 and may supply a driving signal to the first coil 120.

In an example, a portion of the first upper elastic unit 150-1 may be connected to one end of the first coil 120, and the other portion of the first upper elastic unit 150-1 may be conductively connected to the circuit board 190. A portion of the second upper elastic unit 150-2 may be connected to the other end of the first coil 120, and the other portion of the second upper elastic unit 150-2 may be conductively connected to the circuit board 190. The circuit board 190 may include a first pad 5A conductively connected to the other portion of the first upper elastic unit 150-1 and a second pad 5B conductively connected to the other portion of the second upper elastic unit 150-2. Each of the fifth and sixth terminals of the first position sensor 170 may be conductively connected to a corresponding one of the first and second pads 5A and 5B of the circuit board 190.

In another embodiment, the first coil 120 may be conductively connected to the circuit board 190 and the fifth and sixth terminals of the first position sensor 170 via two lower elastic members.

In an example, in an embodiment in which the first position sensor 170 is a driver IC, the first and second terminals B1 and B2 of the circuit board 190 may be power terminals for supply of power, the third terminal B3 may be a terminal for transmission and reception of a clock signal, and the fourth terminal B4 may be a terminal for transmission and reception of a data signal.

In another embodiment, the first position sensor 170 may be a Hall sensor. In this case, the first position sensor 170 may include two input terminals for reception of a driving signal or power supplied thereto and two output terminals for output of a sensing voltage (or output voltage). In an example, a driving signal may be supplied to the first position sensor 170 through the first and second terminals B1 and B2 of the circuit board 190, and the output from the first position sensor 170 may be output to the outside through the third and fourth terminals B3 and B4. In addition, the first coil 120 may be conductively connected to the circuit board 190. The circuit board 190 may further include two separate terminals in addition to the first to fourth terminals B1 to B4, and a driving signal may be supplied to the first coil 120 from the outside through the two separate terminals.

In an example, among the power terminals of the first position sensor 170, a ground terminal may be conductively connected to the cover member 300.

The capacitor 195 may be disposed or mounted on the first surface of the circuit board 190. The capacitor 195 may be of a chip type. In this case, the chip may include a first terminal, which corresponds to one end of the capacitor 195, and a second terminal, which corresponds to the other end of the capacitor 195. The capacitor 195 may alternatively be referred to as a “capacitive element” or a condenser.

The capacitor 195 may be conductively connected in parallel to the first and second terminals B1 and B2 of the circuit board 190, through which power (or driving signal) is supplied to the first position sensor 170 from the outside. Alternatively, the capacitor 195 may be conductively connected in parallel to the terminals of the first position sensor 170, which are conductively connected to the first and second terminals B1 and B2 of the circuit board 190.

Because the capacitor 195 is conductively connected in parallel to the first and second terminals B1 and B2 of the circuit board 190, the capacitor 195 may serve as a smoothing circuit for removing ripple components included in power signals GND and VDD, which are supplied to the first position sensor 170 from the outside, and thus may supply stable and consistent power signals to the first position sensor 170.

In another embodiment, the sensing magnet 180 may be disposed on the housing 140, and the first position sensor 170 may be disposed on the bobbin 110. In another embodiment, the balancing magnet 185 may be omitted.

The upper elastic member 150 and the lower elastic member 160 may be coupled to the bobbin 110 and the housing 140. In an example, the upper elastic member 150 may be coupled to the upper portion, upper end, or upper surface of the bobbin 110 and to the upper portion, upper end, or upper surface of the housing 140, and the lower elastic member 160 may be coupled to the lower portion, lower end, or lower surface of the bobbin 110 and to the lower portion, lower end, or lower surface of the housing 140. The upper elastic member 150 and the lower elastic member 160 may elastically support the bobbin 110 with respect to the housing 140.

The upper elastic member 150 may include a plurality of upper elastic units (e.g., 150-1 to 150-4), which are conductively separated or isolated from each other. The lower elastic member 160 is implemented as a single elastic unit. However, in another embodiment, the lower elastic member may include a plurality of lower elastic units, which are conductively separated or isolated from each other. In another embodiment, at least one of the upper elastic member or the lower elastic member may be implemented as a single unit or a single construction.

The upper elastic member 150 may further include a first inner frame 151 coupled or fixed to the upper portion, upper surface, or upper end of the bobbin 110, a second inner frame 152 coupled or fixed to the upper portion, upper surface, or upper end of the housing 140, and a first frame connection portion 153 interconnecting the first inner frame 151 and the first outer frame 152. In addition, the upper elastic member 150 may include the above-described extension portion 155.

The lower elastic member 160 may include a second inner frame 161 coupled or fixed to the lower portion, lower surface, or lower end of the bobbin 110, a second outer frame 162 coupled or fixed to the lower portion, lower surface, or lower end of the housing 140, and a second frame connection portion 163 interconnecting the second inner frame 161 and the second outer frame 162. The inner frame may alternatively be referred to as an inner portion, the outer frame may alternatively be referred to as an outer portion, and the frame connection portion may alternatively be referred to as a connection portion.

Each of the first and second frame connection portions 153 and 163 may be formed so as to be bent or curved (or crooked) at least once to form a pattern having a predetermined shape.

Each of the upper elastic member 150 and the lower elastic member 160 may be made of a conductive material, for example, metal. In addition, each of the upper elastic member 150 and the lower elastic member 160 may be formed as an elastic member, for example, a leaf spring.

Referring to FIGS. 5, 7A, and 7B, in an example, the second outer frame 152 of the first upper elastic unit 150-1 may include a first bonding portion 4A coupled or conductively connected to the first pad 5A of the circuit board 190, and the second outer frame 152 of the second upper elastic unit 150-2 may include a second bonding portion 4B conductively connected to the second pad 5B of the circuit board 190.

In another embodiment, at least one of the upper elastic member 150 or the lower elastic member 160 may include two elastic members. In an example, each of the two elastic members of any one of the upper elastic member 150 and the lower elastic member 160 may be coupled or conductively connected to a corresponding one of the first and second pads of the circuit board 190, and the first coil 120 may be conductively connected to the two elastic members.

The first outer frame 152 of the upper elastic member 150 may include a first coupling portion 510 coupled to the housing 140, a second coupling portion 520 coupled to the wire 220, and a connection portion 530 interconnecting the first coupling portion 510 and the second coupling portion 520. The first coupling portion 510 may include a through-hole or a hole formed therein in order to be coupled to the first coupling portion 143 of the housing 140. The second coupling portion 520 may include a through-hole or a hole formed therein in order to be coupled to the wire 220. In an example, the second coupling portion 520 may be coupled to the wire 220 by means of a conductive adhesive or solder. In an example, the connection portion 530 may include a bent portion bent at least once or a curved portion curved at least once. However, the disclosure is not limited thereto. In another embodiment, the connection portion 530 may have a straight line shape.

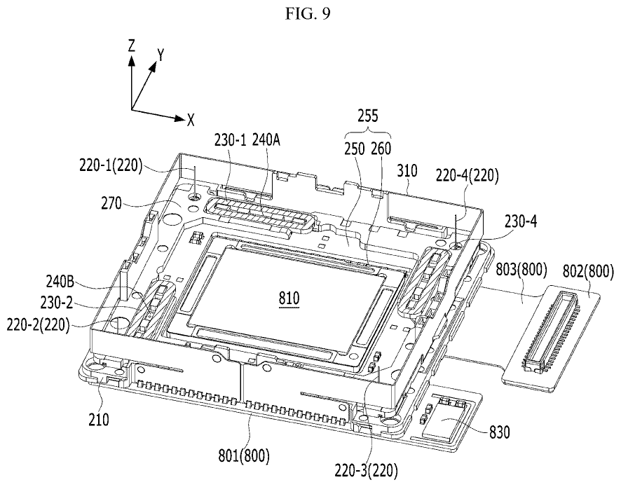

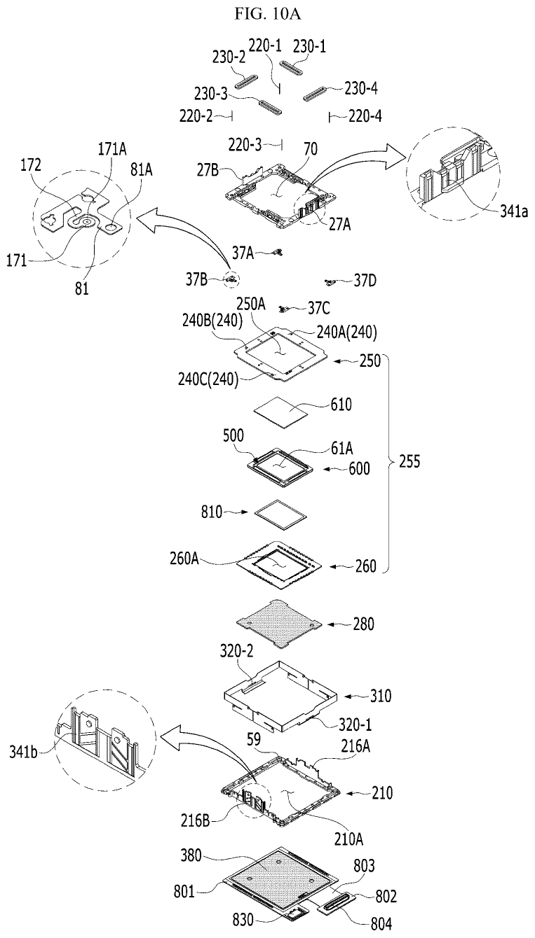

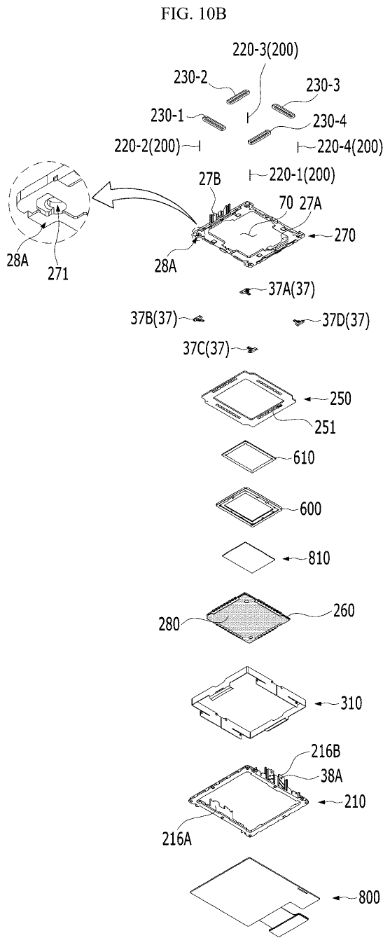

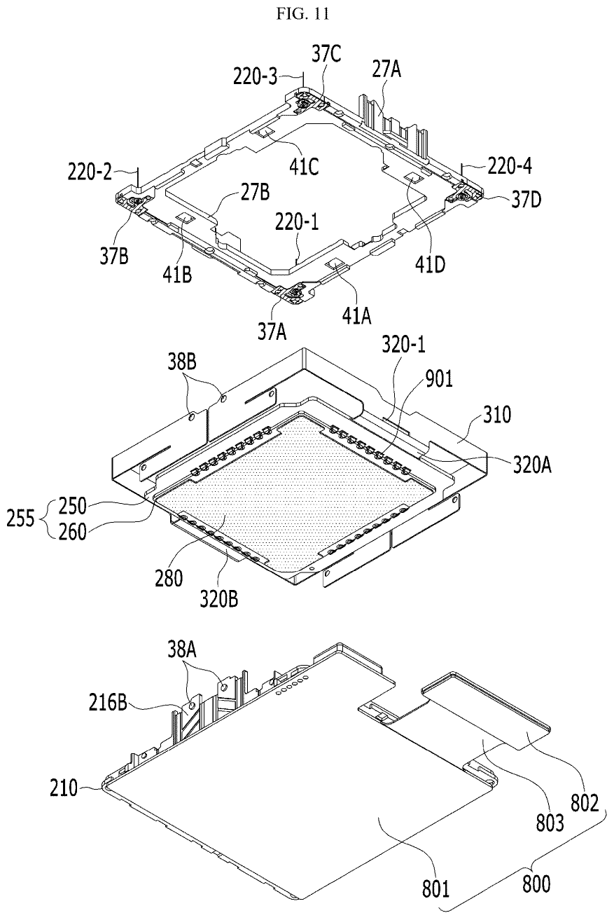

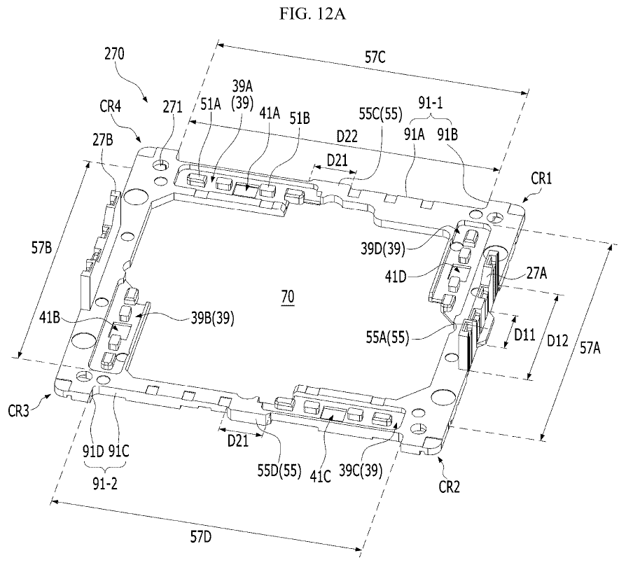

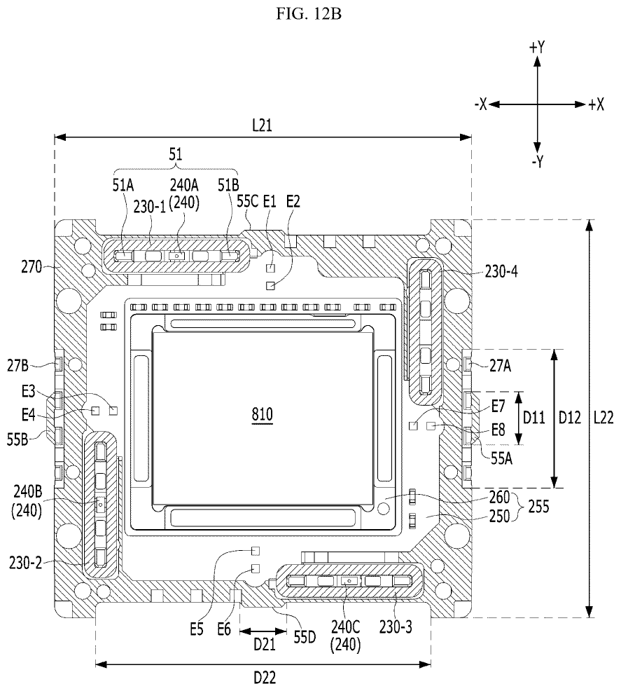

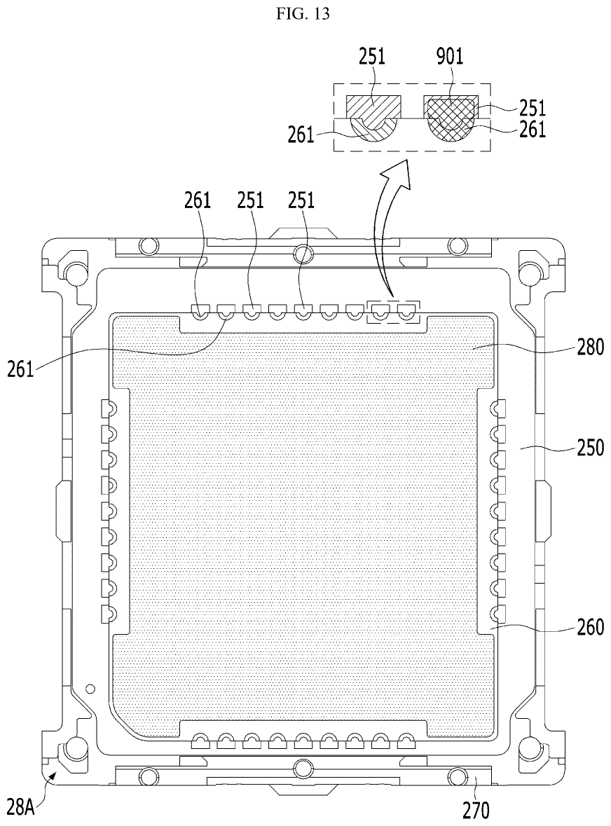

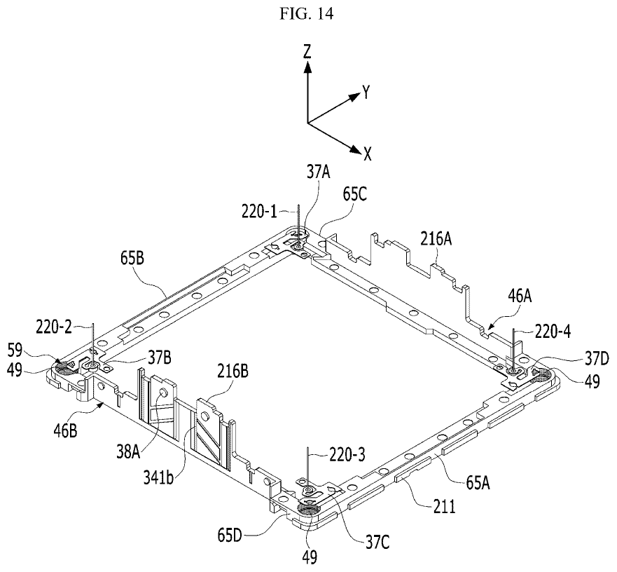

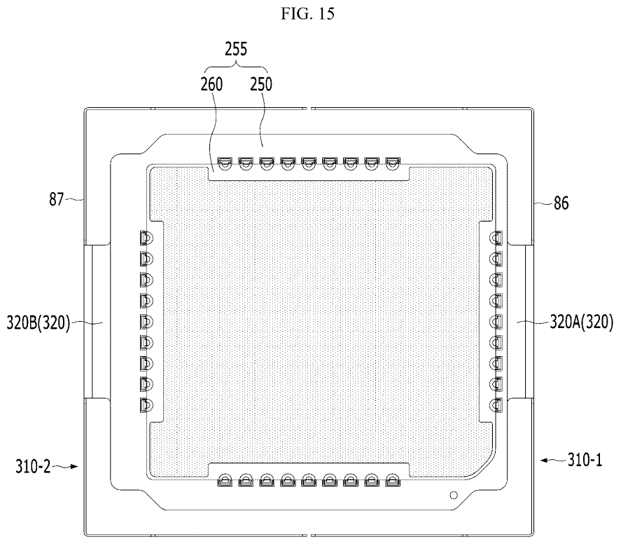

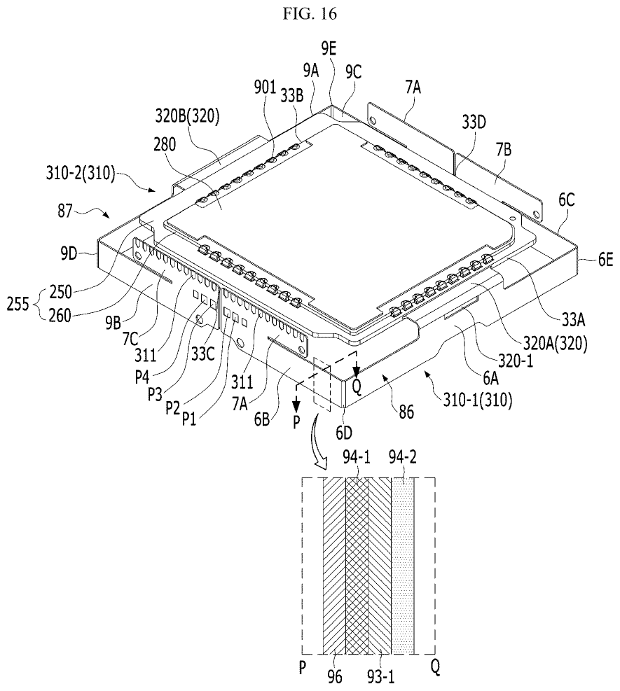

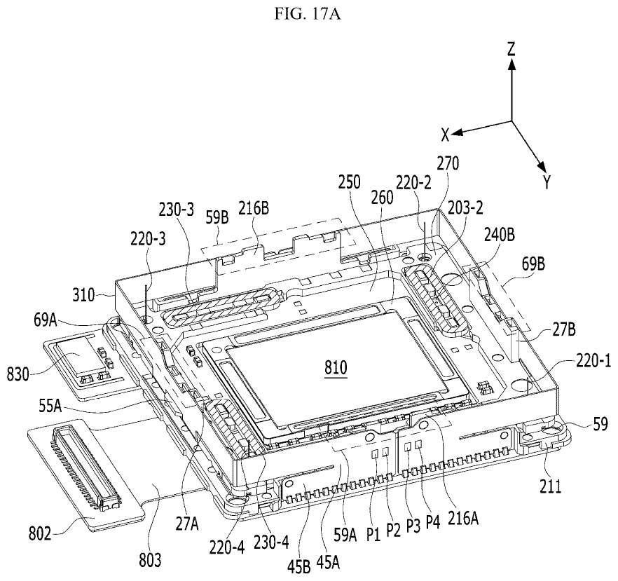

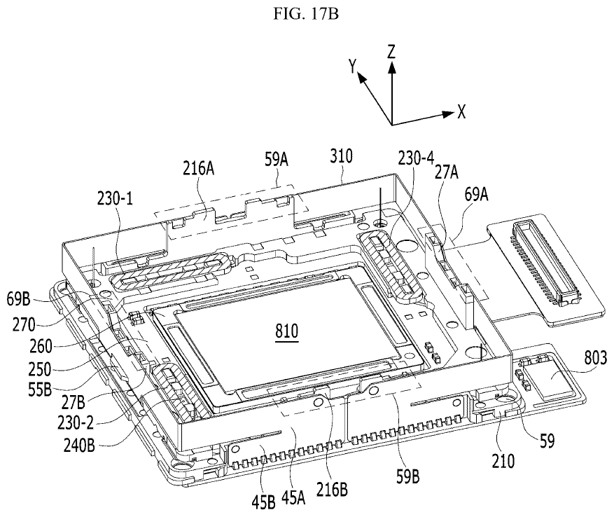

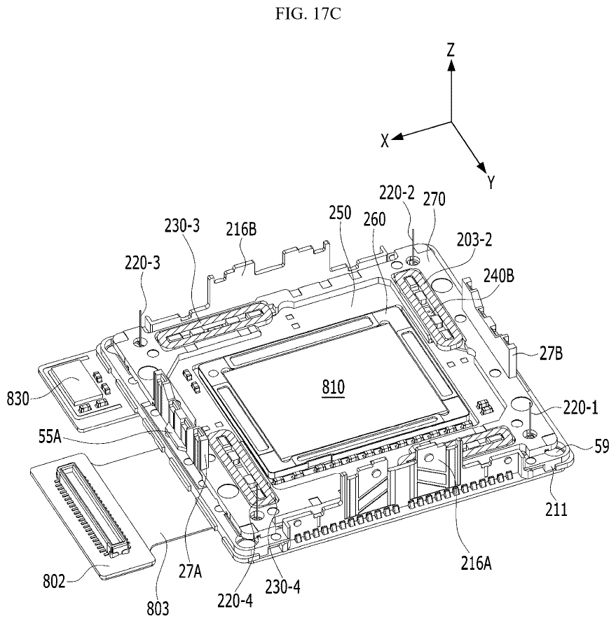

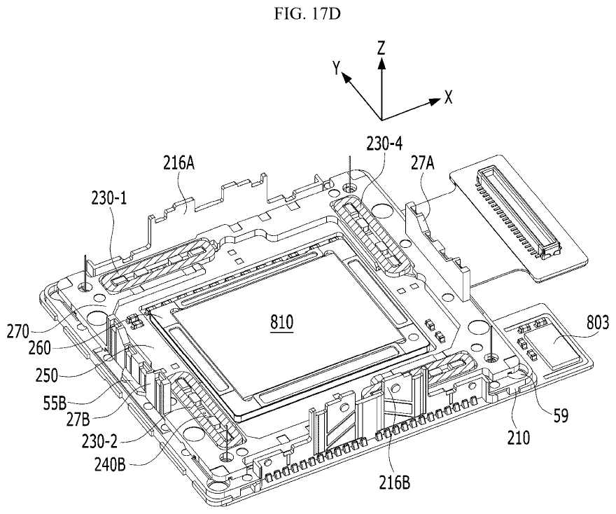

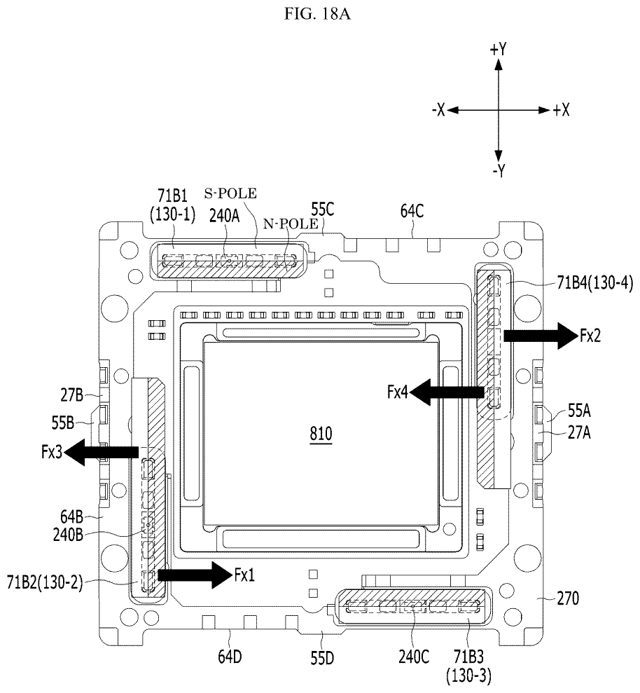

FIG. 9 is a perspective view of the image sensor unit 350, FIG. 10A is a first exploded perspective view of the image sensor unit 350 in FIG. 9, FIG. 10B is a second exploded perspective view of the image sensor unit 350 in FIG. 9, FIG. 11 is a bottom perspective view of a holder 270, a terminal unit 37, a first board unit 255, a support board 310, a heat dissipation member 280, the base 210, and a second board unit 800 in FIG. 10A, FIG. 12A is a perspective view of the holder, FIG. 12B is a plan view of the holder 270, the first board unit 255, the image sensor 810, the second coil 230, and an OIS position sensor 240, FIG. 13 is a rear perspective view of the holder 270 and the first board unit 255, FIG. 14 is a perspective view of the base 210, the terminal unit 37, and the wire 220, FIG. 15 is a bottom view of the first board unit 255, the support board 310, and the heat dissipation member 280, FIG. 16 is a perspective view of the first board unit 255, the support board 310, and the heat dissipation member 280, FIG. 17A is a first perspective view of the support board 310 coupled to the holder 270 and to the base 210, FIG. 17B is a second perspective view of the support board 310 coupled to the holder 270 and to the base 210, FIG. 17C is a view of the configuration shown in FIG. 17A with the support board 310 removed therefrom, and FIG. 17D is a view of the configuration shown in FIG. 17B with the support board 310 removed therefrom.

Referring to FIGS. 9 to 17D, the image sensor unit 350 may include a fixed unit and an OIS moving unit spaced apart from the fixed unit. The image sensor unit 350 may include a support unit interconnecting the fixed unit and the OIS moving unit.

In an example, the support unit may include a support board 310. Alternatively, in an example, the support unit may be the support board 310. In another embodiment, the support unit may be an elastic member, for example, a leaf spring or a suspension wire, rather than being the support board 310.

The fixed unit may be a fixed unit of the camera device 10 that does not move during OIS operation. In an example, the fixed unit may include a second board unit 800. In an example, the fixed unit may include a component coupled to the second board unit 800. The “board unit” 255 or 800 may alternatively be referred to as a “board” or a “circuit board”.

In an example, the fixed unit may include a base 210 coupled to the second board unit 800. In an example, the fixed unit may include the housing 140 of the AF driving unit and components disposed on the housing 140, for example, the magnet 130, the first position sensor 170, and the circuit board 180. In addition, the fixed unit may include a cover member 300 coupled to the base 210. The OIS moving unit may be disposed inside the cover member 300. In an example, the cover member 300 may accommodate the moving unit and the support board 310.

The OIS moving unit may include the image sensor 810. The OIS moving unit may further include a first board unit 255 spaced apart from and conductively connected to the second board unit 800. In addition, in an example, the OIS moving unit may include components disposed on the first board unit 255, for example, at least one of a heat dissipation member 280, a holder 270, a second coil 230, or a second position sensor 240. The holder 270 may alternatively be referred to as a “spacing member”. In another embodiment, the holder 270 may be omitted, and the second coil 230 may be disposed on the first board unit 255, for example, the first circuit board 250.

In an example, the camera device 10 may include a fixed unit, a moving unit including a heat dissipation member 280 disposed on the fixed unit and an image sensor 810 disposed on the heat dissipation member 280, and a support unit (e.g., 310) that supports the moving unit so that the moving unit is movable in a direction perpendicular to the optical-axis direction. The support unit (e.g., 310) may be connected between the moving unit and the fixed unit.

The moving unit may include a first board unit 255 on which the image sensor 810 is disposed, the fixed unit may include a second board unit 800 disposed so as to be spaced apart from the first board unit 255, and the support unit may interconnect the first board unit 255 and the second board unit 800.

The support unit may include a conductive layer 93-1, a first insulating layer 94-1 disposed beneath the conductive layer 93-1, and a second insulating layer 94-2 disposed on the conductive layer 93-1. In the support unit, a portion of the first insulating layer 94-1 may not be disposed so as to expose a portion of the conductive layer 93-1.

The first board unit 255 may include a first circuit board 250 connected to the support unit, a second circuit board 260 conductively connected to the image sensor 810, and solder 901 conductively interconnecting the first circuit board 250 and the second circuit board 260.

The camera device 10 may include an elastic member 220 (hereinafter referred to as a “wire”) to elastically support the OIS moving unit with respect to the fixed unit. The elastic member 220 may take the form of a wire or a spring.

In an example, one end of the wire 220 may be coupled to the upper elastic member 150 (or the housing 140), and the other end of the wire 220 may be coupled to the holder 270. In an example, one end of the wire 220 may be coupled to the first outer frame 152 of the upper elastic member 150 (e.g., the second coupling portion 520) by means of solder or a conductive adhesive. In an example, the other end of the wire 220 may be coupled to the terminal unit 37 by means of solder or a conductive adhesive, and the terminal unit 37 may be disposed on the holder 270 or may be coupled to the holder 270.

Referring to FIGS. 7A and 7B, a damper DA may be disposed between one end of the wire 220 passing through the hole 147 in the housing 140 and the hole 147 in the housing 140. In an example, at least a portion of the damper DA may be disposed in the hole 147 in the housing 140 and may be coupled or attached to at least a portion of the wire 220 and the housing 140.

In an example, the wire 220 may be disposed in the optical-axis direction. In an example, the wire 220 may be disposed on a corner of the housing 140 and/or a corner of the holder 270. In an example, the wire 220 may include four wires 220-1 to 220-4. Each of the four wires 220-1 to 220-4 may be disposed on a corresponding one of four corners of the housing 140 and/or four corners of the holder 270.

Referring to FIGS. 10A and 10B, the holder 270 may include a hole 271 formed therein to allow at least a portion of the wire 220 to pass therethrough. In an example, the hole 271, through which the other end of the wire 220 passes, may be formed in the corner of the holder 270. In an example, the hole 271 may be formed in each of the four corners of the holder 270. In an example, the hole 271 may be a through-hole formed through the holder 270 in the optical-axis direction. However, in another embodiment, the hole 271 may take the form of an escape recess.

In an example, the terminal unit 27 may be disposed on or coupled to the upper surface or lower surface of the holder 270. In an example, the terminal unit 27 may be disposed on or coupled to the lower surface of the corner of the holder 270. The holder 270 may include a recess 28A formed therein to allow the terminal unit 37 to be disposed therein. In an example, the recess 28A may be formed in the lower surface of the corner of the holder 270.

In an example, the terminal unit 27 may include at least one hole 81A formed therein in order to be coupled to the holder 270. The terminal unit 37 and the holder 270 may be coupled to each other by means of an adhesive or thermal fusion. For example, the hole 81A may be a hole formed to allow an adhesive to be injected thereinto.

In addition, the terminal unit 37 may include a hole 171A formed therein to allow the other end of the wire 220 to be inserted thereinto or coupled thereto. For example, the holes 81A and 171A may be through-holes.

In an example, the terminal unit 37 may include a body 81 coupled to the holder 270. The body 81 may include a coupling portion 171 coupled to the wire 220. The coupling portion 171 may include a hole 171A formed therein in order to be coupled to the wire 220. The coupling portion 171 may be coupled to the wire 220 by means of solder or a conductive adhesive. In an example, the other end of the wire 220 that has passed through the hole 171A in the coupling portion 171 may be coupled to the lower portion or lower surface of the coupling portion 171 by means of solder or a conductive adhesive.

The terminal unit 37 may include a connection portion 172 interconnecting the body 81 and the coupling portion 171. The width of the connection portion 172 may be less than the width of the body 81. In addition, in an example, the width of the connection portion 152 may be less than the width (or diameter) of the coupling portion 171.

In an example, the terminal unit 37 may include an extension portion (not shown) extending from the body 81. The extension portion of the terminal unit 37 may be bent and extend from the body 81 in the downward direction. In an example, the extension portion of the terminal unit 37 may extend toward a hole 59 in the base 210. The extension portion of the terminal unit may alternatively be referred to as a “bent portion”.

In an example, the terminal unit 37 may include four terminals 37A to 37D corresponding to the four wires 220-1 to 220-4. Each of the terminals 37A to 37D may be disposed on a corresponding one of the corners of the holder 270 and may be coupled to a corresponding one of the wires 220-1 to 220-4. The description given with reference to FIG. 10A may be equally or similarly applied to the structure of each of the terminals 37A to 37D. The terminal unit 37 may be made of a conductive material, for example, metal. In another embodiment, the terminal unit 37 may be omitted, and the wire 220 may be directly coupled to the holder 270.

Referring to FIG. 14, a damper 49 or an adhesive may be disposed between the terminal unit 37 and the base 210. The damper 49 may be in contact with, coupled to, or attached to the terminal unit 37 and the base 210. In an example, the base 210 may include a hole 59 (or recess) formed at a position corresponding to or opposing the terminal unit 37. In an example, the hole 59 (or the recess) may be formed in the corner of the base 210.

In an example, the damper 49 may be disposed in the hole 59 in the base 210. Alternatively, at least part of the extension portion (not shown) of the terminal unit 37 may be disposed in the hole 59 in the base 210, and the damper 49 may be in contact with, coupled to, or attached to the extension portion of the terminal unit 59. The damper may serve to absorb or alleviate vibration of the OIS moving unit, thereby inhibiting or suppressing oscillation of the OIS moving unit during OIS driving. In another embodiment, the extension portion may be omitted from the terminal unit 37, and the camera device 10 may not include the damper 49 in FIG. 14.

The support board 310 may support the OIS moving unit with respect to the fixed unit such that the OIS moving unit is capable of moving in a direction perpendicular to the optical axis or such that the OIS moving unit is capable of tilting or rotating within a predetermined range about the optical axis.

In an example, one end of the support board 310 may be connected or coupled to the first board unit 255, and the other end of the support board 310 may be connected or coupled to the second board unit 800.

The holder 270 may be disposed below the AF driving unit. In an example, the holder 270 may be embodied as a non-conductive member. In an example, the holder 270 may be made of an injection-molding material, which may be easily shaped through an injection-molding process. In addition, the holder 270 may be formed of an insulating material. In addition, for example, the holder 270 may be formed of resin or plastic.

Referring to FIGS. 10A, 10B, and 12A, the holder 270 may include an upper surface, a lower surface formed opposite the upper surface, and a side surface (e.g., outer side surface) interconnecting the upper surface and the lower surface. In an example, the lower surface of the holder 270 may oppose or face the second board unit 800.

The holder 270 may support the first board unit 255 and may be coupled to the first board unit 255. In an example, the first board unit 255 may be disposed beneath the holder 270. In an example, the lower portion, lower surface, or lower end of the holder 270 may be coupled to the upper portion, upper surface, or upper end of the first board unit 255. In an example, the holder 270 may be coupled to the first board unit 255 by means of an adhesive. In another embodiment, for example, the first board unit 255 may be disposed on the holder 270.

The holder 270 may accommodate or support the second coil 230. The holder 270 may support the second coil 230 such that the second coil 230 is spaced apart from the first board unit 255. In an example, at least a portion of the holder 270 may be disposed between the second coil 230 and the first board unit 255.

In an example, the holder 270 may include an accommodation portion 39 in which the second coil 230 is disposed or accommodated. For example, the accommodation portion 39 may be formed in a recess shape. In an example, the accommodation portion 39 may be a recess depressed in the upper surface of the holder 270. In an example, the holder 270 may include recesses 39A to 39D formed therein so as to correspond to the coil units 230-1 to 230-4 of the second coil 230. Each of the coil units 230-1 to 230-4 may be disposed in a corresponding one of the recesses 39A to 39D in the holder 270.

The holder 270 may include a bore 70 formed therein so as to correspond to one region of the first board unit 255. In an example, the bore 70 in the holder 270 may be a through-hole formed through the holder 270 in the optical-axis direction. In an example, the bore 70 in the holder 270 may correspond to, oppose, or overlap the image sensor 810 in the optical-axis direction.

When viewed from above, the shape of the bore 70 in the holder 270 may be a polygonal shape such as a quadrangular shape, a circular shape, or an elliptical shape. However, the disclosure is not limited thereto. The bore 70 may be formed in any of various shapes.

In an example, the bore 70 in the holder 270 may have a shape or a size suitable for exposing the image sensor 810, a portion of the upper surface of the first circuit board 250, a portion of the upper surface of the second circuit board 260, and other elements. In an example, the area of the bore 70 in the holder 270 may be larger than the area of the image sensor 810 and may be larger than the area of the bore 250A in the first circuit board 250.

Referring to FIGS. 11 and 12A, the holder 270 may include holes 41A, 41B, and 41C formed therein so as to correspond to the second position sensor 240. In an example, the holder 270 may include holes 41A, 41B, and 41C formed therein at positions corresponding, respectively, to first to third sensors 240A, 240B, and 240C of the second position sensor 240.

In an example, the holes 41A, 41B, and 41C may be disposed adjacent to the corners of the holder 270. The holder 270 may include a dummy hole 41D formed therein at a position adjacent to the corner of the holder 270 that does not correspond to the second position sensor 240. The dummy hole 41D may be formed in order to establish weight equilibrium of the OIS moving unit during OIS driving. The dummy hole 41D may be a through-hole. In another embodiment, the dummy hole 41D may not be formed. The holes 41A, 41B, and 41C may be through-holes formed through the holder 270 in the optical-axis direction. In another embodiment, the holes 41A, 41B, and 41C may be omitted from the holder 270.

The holder 270 may be provided on the upper surface thereof with at least one coupling protrusion 51 in order to be coupled to the second coil 230. In an example, the coupling protrusion 51 may be inserted into, disposed in, or coupled to a cavity in the coil unit of the second coil 230.

The coupling protrusion 51 may protrude from the upper surface of the holder 270 in the upward direction or toward the AF driving unit. In an example, the coupling protrusion 51 may protrude from the bottom surface of the accommodation portion 39. In an example, the coupling protrusion 51 may be formed adjacent to each of the holes 41A to 41D in the holder 270.

In an example, two coupling protrusions 51A and 51B may be disposed or arranged so as to correspond to each of the holes 41A, 41B, 41C, and 41D in the holder 270. In an example, each of the holes 41A, 41B, 41C, and 41D in the holder 270 may be located between the two coupling protrusions 51A and 51B.

The holder 270 may include one or more protruding portions 27A and 27B. The protruding portions 27A and 27B may protrude from the upper surface of the holder 270. In an example, the protruding portions 27A and 27B may protrude from the outer side surface of the holder 270 in the optical-axis direction or the upward direction.

In an example, the holder 270 may include two protruding portions 27A and 27B, which oppose or overlap each other in the second horizontal direction (e.g., the X-axis direction).

Referring to FIG. 12A, in an example, the holder 270 may include a plurality of side portions (or side plates) 57A to 57D. In addition, the holder 270 may include a plurality of corner portions CR1 to CR4 or corners.

In an example, each of the corner portions of the holder 270 may include a corresponding one of the corners of the holder 270. In this case, the corner of the holder 270 may be a corner at which two adjacent outer side surfaces of the holder 270 meet each other. In an example, each of the corner portions of the holder 270 may be a region located outside the hole 271 in the holder 270. In an example, each of the corner portions of the holder 270 may be a region closer to a corresponding one of the corners of the holder 270 than to a first position of the holder 270. In an example, the first position may be a center point between the middle point (or the center) of each of the side portions 57A to 57D of the holder 270 and a corresponding one of the corners of the holder 270.

In an example, the first protruding portion 27A may be formed on the first side portion 57A of the holder 270, and the second protruding portion 27B may be formed on the second side portion 57B of the holder 270. In an example, the protruding portions 27A and 27B may be disposed or located at the centers of the side portions (or the side plates) of the holder 270.

The holder 270 may include a groove 341a formed therein. The groove 341a may be an adhesive-receiving groove. The groove 341a may be formed in the outer side surface of each of the protruding portions 27A and 27B of the holder 270. The groove 341a may be formed in the upper surface of each of the protruding portions 27A and 27B of the holder 270. The groove 341a may be formed from the upper surface of each of the protruding portions 27A and 27B of the holder 270 to the lower surface thereof. An adhesive, by which the support board 310 is adhered to the holder 270, may be disposed in the groove 341a. The groove 341a may include a plurality of grooves. In an example, the groove 341a may extend in the optical-axis direction. In another embodiment, the groove in the holder 270 may extend in a direction perpendicular to the optical axis.

The first board unit 255 may include a first circuit board 250 and a second circuit board 260 conductively connected to each other. The second circuit board 260 may alternatively be referred to as a “sensor board”. In another embodiment, the heat dissipation member 280 may be included in the first board unit 255.

The first board unit 255 may be disposed on the lower surface of the holder 270. In an example, the first board unit 255 may be coupled to the lower surface of the holder 270. In an example, the first circuit board 250 may be disposed on and/or coupled to the lower surface of the holder 270. In an example, a first surface of the first circuit board 250 may be coupled or attached to the lower surface of the holder 270 by means of an adhesive member.

In this case, the first surface of the first circuit board 250 may be a surface that faces or opposes the AF driving unit and on which the second position sensor 240 is disposed. In addition, a second surface of the first circuit board 250 may be a surface formed opposite the first surface of the first circuit board 250.

The first circuit board 250 may alternatively be referred to as a sensor board, a main board, a main circuit board, a sensor circuit board, or a moving circuit board. In all of the embodiments, the first circuit board 250 may alternatively be referred to as a “second board” or a “second circuit board”, and the second circuit board 260 may alternatively be referred to as a “first board” or a “first circuit board”.

The second position sensor 240 (240A, 240B, and 240C) may be disposed on the first circuit board 250 in order to detect movement of the OIS moving unit in a direction perpendicular to the optical-axis direction and/or rotation, tilting, or rolling of the OIS moving unit about the optical axis. In addition, a controller 830 and/or a circuit element (e.g., capacitor) may be disposed on the first circuit board 250.

The first circuit board 250 may include first terminals E1 to E8 in order to be conductively connected to the second coil 230. Here, the first terminals E1 to E8 may alternatively be referred to as “first pads” or “first bonding parts”. The first terminals E1 to E8 of the first circuit board 250 may be disposed or arranged on the first surface 60A of the first circuit board 250. For example, the first circuit board 250 may be a printed circuit board or a flexible printed circuit board (FPCB).

The first circuit board 250 may include a bore 250A formed therein so as to correspond to or oppose the lens module 400 and the bore in the bobbin 110. In an example, the bore 250A in the first circuit board 250 may be a through-hole or a cavity formed through the first circuit board 250 in the optical-axis direction and may be formed at the center of the first circuit board 250.

When viewed from above, the shape of the first circuit board 250, for example, the outer circumferential shape thereof, may be a shape coinciding with or corresponding to the shape of the holder 270, for example, a quadrangular shape. In addition, when viewed from above, the shape of the bore 250A in the first circuit board 250 may be a polygonal shape such as a quadrangular shape, a circular shape, or an elliptical shape. In an example, the bore 250A in the first circuit board 250 may open or expose the image sensor 810 and/or a bore 260A in the second circuit board 260.

In addition, the first circuit board 250 may include at least one terminal 251 in order to be conductively connected to the second circuit board 260. Here, the terminal 251 of the first circuit board 250 may alternatively be referred to as a “pad” or a “bonding part”. The terminal 251 of the first circuit board 250 may be disposed or arranged on the lower surface of the first circuit board 250.

In an example, the terminal 251 may be provided in plural, and the plurality of terminals 251 may be disposed or arranged in a region between the bore 250A in the first circuit board 250 and any one side of the first circuit board 250 in a direction parallel to the side of the first circuit board 250. In an example, the plurality of terminals 251 may be arranged around the bore 250A.

The second circuit board 260 may be disposed beneath the first circuit board 250. The second circuit board 260 may be conductively connected to the image sensor 810.

When viewed from above, the shape of the second circuit board 260 may be a polygonal shape (e.g., a quadrangular shape, a square shape, or a rectangular shape). However, the disclosure is not limited thereto. In another embodiment, the shape of the second circuit board 260 may be a circular shape or an elliptical shape.

In an example, the area of the outer circumferential surface of the second circuit board 260 having a quadrangular shape may be larger than the area of the bore 250A in the first circuit board 250. In an example, the lower side of the bore 250A in the first circuit board 250 may be shielded or blocked by the second circuit board 260.

In an example, when viewed from above or below, the outer side surface (or the side) of the second circuit board 260 may be located between the outer side surface (or the side) of the first circuit board 250 and the bore 250A in the first circuit board 250.

In an example, the second circuit board 260 may include a bore 260A formed therein so as to correspond to the bore 250A in the first circuit board 250 and/or the image sensor 810. The bore 260A in the second circuit board 260 may be a hole or a cavity formed through the second circuit board 260 in the optical-axis direction and may be formed at the center of the second circuit board 260.

In an example, the bore 260A in the second circuit board 260 may open or expose the image sensor 810. In an example, the image sensor 810 may be disposed in the bore 260A in the second circuit board 260 and may be conductively connected to the second circuit board 260. In an example, the image sensor 810 may be conductively connected to the second circuit board 260 via a wire.

In another embodiment, the bore 260A may not be formed in the second circuit board 260, and the image sensor 810 may be disposed on the upper surface of the second circuit board 260.

In another embodiment, the heat dissipation member 280 may be omitted. In the embodiment in which the heat dissipation member 280 is omitted, the bore 260A may not be formed in the second circuit board 260, and the image sensor 810 may be disposed on the upper surface of the second circuit board 260.

In an example, in the embodiment in which the heat dissipation member 280 is omitted, the image sensor 810 may be disposed on the upper surface of a single board into which the first circuit board and the second circuit board are integrated.

The second circuit board 260 may include at least one terminal 261 conductively connected to the at least one terminal 251 of the first circuit board 250. In an example, the terminal 261 of the second circuit board 260 may be provided in plural.

In an example, the at least one terminal 261 of the second circuit board 260 may be formed on the side surface or the outer side surface of the second circuit board 260 that interconnects the upper surface of the second circuit board 260 and the lower surface thereof. The upper surface of the second circuit board 260 may be a surface facing the first circuit board 250, and the lower surface of the second circuit board 260 may be a surface formed opposite the upper surface of the second circuit board. In an example, the terminal 261 may take the form of a recess depressed in the side surface of the second circuit board 260. Alternatively, for example, the terminal 261 may take the form of a semicircular or semi-elliptical via formed in the side surface of the second circuit board 260. In another embodiment, the at least one terminal of the second circuit board 260 that is conductively connected to the second terminal 251 of the first circuit board 250 may be formed on the upper surface of the second circuit board 260.

In an example, the terminal 261 of the second circuit board 260 may be coupled to the terminal 251 of the first circuit board 250 by means of solder 901 (refer to FIG. 11) or a conductive adhesive member. Although only one solder 901 coupling any one terminal of the second circuit board 260 to any one terminal 251 of the first circuit board is illustrated in an enlarged portion indicated by a dotted line in FIG. 13, solder for coupling another terminal of the second circuit board 260 to a terminal of the first circuit board 250 corresponding thereto may be provided.

For example, the first and second circuit boards 250 and 260 may be printed circuit boards or FPCBs. Further, at least one of the first and second circuit boards 250 and 260 may be an organic substrate or a ceramic substrate.

The heat dissipation member 280 may be disposed on or coupled to the first board unit 255. In an example, the heat dissipation member 280 may be disposed on or coupled to the second circuit board 260. In an example, the heat dissipation member 280 may be disposed beneath the second circuit board 260. In an example, the heat dissipation member 280 may be coupled or fixed to the lower surface of the second circuit board 260. In an example, at least a portion of the upper surface of the heat dissipation member 280 may be coupled or fixed to the lower surface of the second circuit board 260 by means of an adhesive.

The “heat dissipation member” may alternatively be referred to as a “heat dissipation sheet”, a “heat dissipation tape”, a “heat dissipation layer”, a “heat dissipation film”, a “heat dissipation board”, a “heat dissipation plate”, or a “heat dissipation body”.

In another embodiment, the heat dissipation member 280 may be included in the first board unit 255, and the image sensor 810 may be disposed on the first board unit 255.

The bore 260A in the second circuit board 260 may open or expose at least a portion of the heat dissipation member 280. The image sensor 810 may be disposed on, attached to, or coupled to at least a portion of the heat dissipation member 280 that is exposed by the bore 260A. In an example, the image sensor 810 may be fixed, attached, or coupled to the heat dissipation member 280 by means of an adhesive. In an example, the image sensor 810 may be disposed on the first board unit 255.

In an example, at least a region of the upper surface of the heat dissipation member 280 may be exposed by the bore 260A, and the image sensor 810 may be disposed on, attached to, or coupled to at least a region of the upper surface of the heat dissipation member 280 that is exposed by the bore 260A.

In another embodiment, the second circuit board 260 may include a recess formed in the lower surface thereof to allow the heat dissipation member 280 to be received or disposed therein.

In another embodiment, the bore 260A may not be formed in the second circuit board 260, and the heat dissipation member 280 may be fixed, attached, or coupled to the lower surface of the second circuit board 260. In still another embodiment, the heat dissipation member 280 may be omitted.

In an example, the heat dissipation member 280 may be formed as a plate-type member having a predetermined thickness and hardness. In addition, the heat dissipation member 280 may improve dissipation of heat generated by the heat source of the first board unit 255 to the outside. In this case, the heat source of the first board unit 255 may be an electronic element (or circuit element) disposed on the first board unit 255, for example, the image sensor 810, the controller 830, the second position sensor 240, and/or the capacitor.

In an example, the heat dissipation member 280 may include a metallic material having high thermal conductivity and high heat dissipation efficiency, for example, at least one of SUS, aluminum, nickel, phosphorus, bronze, or copper.

In addition, the heat dissipation member 280 may serve as a reinforcing member stably supporting the image sensor 810 and suppressing the image sensor 810 from being damaged due to external impact or contact.

In another embodiment, the heat dissipation member 280 may be formed of a heat dissipation material having high thermal conductivity, for example, heat dissipation epoxy, heat dissipation plastic (e.g., polyimide), or heat dissipation synthetic resin.

For example, in the embodiment of the present disclosure, the “heat dissipation member” may alternatively be referred to as a “heat dissipation body”, a “heatsink”, a “heat dissipation plate”, a “heat dissipation sheet”, a plate, a metal plate, a reinforcing member, or a stiffener.

The heat dissipation member 280 may include a predetermined pattern including at least one groove or at least one uneven portion in order to improve heat dissipation effect. In an example, a groove or an uneven portion having a predetermined pattern may be formed in the lower surface of the heat dissipation member 280.

In an example, the predetermined pattern may include a plurality of grooves formed so as to be spaced apart from each other by predetermined intervals. In an example, the predetermined pattern may have a stripe shape. In another embodiment, the predetermined pattern may have a net shape or a mesh shape. In still another embodiment, the predetermined pattern may have a shape including dots spaced apart from each other. For example, the shape of the dot may be a circular shape, an elliptical shape, or a polygonal shape (e.g., quadrangular shape).

In another embodiment, the predetermined pattern may be formed in at least one of the upper surface, lower surface, or outer side surface of the heat dissipation member 280. In still another embodiment, the heat dissipation member may include a hole or a through-hole in place of the groove or the uneven portion. Because the heat dissipation member 280 moves together with the OIS moving unit, the heat dissipation member 280 may be spaced apart from the fixed unit, for example, the second board unit 800. The heat dissipation member 280 may include at least one escape recess 281 (refer to FIG. 10A) formed therein in order to avoid spatial interference with the solder 901.

The first circuit board 250 and the second circuit board 260 are illustrated in FIG. 13 as being conductively coupled to each other by means of the solder 901. However, in another embodiment, the first circuit board and the second circuit board may be implemented as a single integrated circuit board.

The second coil 230 may be disposed on or coupled to the OIS moving unit. In an example, the second coil 230 may be disposed on the holder 270. The second coil 230 may be disposed on the upper surface of the holder 270. The second coil 230 may be disposed beneath the magnet 130.

The second coil 230 may be coupled to the holder 270. In an example, the second coil 230 may be coupled or attached to the upper surface of the holder 270. In an example, the second coil 230 may be coupled to the coupling protrusion 51 of the holder 270. The OIS moving unit may be moved by interaction between the second coil 230 and the magnet 130.

In an example, the second coil 230 may correspond to, oppose, or overlap the magnet 130 disposed on the fixed unit in the direction of the optical axis OA. In another embodiment, the fixed unit may include a separate OIS-dedicated magnet in addition to the magnet of the AF driving unit, and the second coil may correspond to, oppose, or overlap the OIS-dedicated magnet. In this case, the number of OIS-dedicated magnets may be the same as the number of coil units included in the second coil 230.

In still another embodiment, the OIS-dedicated magnet may be disposed on a fixed portion of the second coil 230, and an OIS-dedicated magnet 71B of the magnet 130 may be disposed on the OIS moving unit. In this case, the second coil 230 may be conductively connected to the support board 310 and/or the second board unit 800 via a conductive member.

In an example, the second coil 230 may include a plurality of coil units 230-1 to 230-4. In an example, the second coil 230 may include four coil units 230-1 to 230-4 disposed on the four corners of the holder 270. In an example, at least a portion of each of the coil units 230-1 to 230-4 may be disposed on a corresponding one of the corners of the holder 270. A portion of each of the coil units 230-1 to 230-4 may be disposed on a side portion of the holder 270 that is adjacent to a corresponding one of the corners of the holder 270.

Each of the coil units 230-1 to 230-4 may take the form of a coil block having a closed curve shape or a ring shape. In an example, each coil unit may have a cavity or a hole formed therein. In an example, each of the coil units may be formed as a fine pattern (FP) coil, a wound coil, or a coil block. In an example, the protrusion 51 of the holder 270 may be inserted into or coupled to the cavity or the hole in each of the coil units 230-1 to 230-4.

In another embodiment, the second coil 230 may be disposed on the first circuit board 250 or may be coupled to the first circuit board 250.

The second coil 230 may be conductively connected to the first circuit board 250. In an example, the first coil unit 230-1 may be conductively connected to two terminals E1 and E2 of the first circuit board 250, the second coil unit 230-2 may be conductively connected to two other terminals E3 and E4 of the first circuit board 250, the third coil unit 230-3 may be conductively connected to two other terminals E5 and E6 of the first circuit board 250, and the fourth coil unit 230-4 may be conductively connected to two other terminals E7 and E8 of the first circuit board 250.

Power or a driving signal may be supplied to the first to fourth coil units 230-1 to 230-4 through the first circuit board 250. The power or the driving signal supplied to the second coil 230 may be a direct current signal, an alternating current signal, or a signal containing direct current and alternating current components, and may be of a current type or a voltage type.

The OIS moving unit may be moved in the first horizontal direction or the second horizontal direction or may be rolled about the optical axis by interaction between the first to fourth magnet units 130-1 to 130-4 and the first to fourth coil units 230-1 to 230-4.

In an example, current may be independently applied to at least three coil units among the four coil units 230-1 to 230-4. In another embodiment, current may be independently applied to at least two coil units among the four coil units 230-1 to 230-4.

In an example, a separate independent driving signal, e.g., driving current, may be supplied to each of the four coil units 230-1 to 230-4.

The controller 830 or 780 may supply at least one driving signal to at least one of the first to fourth coil units 230-1 to 230-4 and may control the at least one driving signal such that the OIS moving unit is moved in the X-axis direction and/or the Y-axis direction or is rotated within a predetermined angular range about the optical axis. The “controller” to be described hereinbelow may be at least one of the controller 830 of the camera device 10 or the controller 780 of an optical instrument 200A.

When the second coil 230 is driven in a three-channel drive mode, three independent driving signals may be supplied to the second coil 230. In an example, among the four coil units, two coil units (e.g., 230-2 and 230-4, or 230-1 and 230-3), which face each other in a diagonal direction, may be connected in series to each other. One driving signal may be supplied to two coil units connected in series to each other, and an independent driving signal may be supplied to each of the remaining two coil units among the four coil units.

Alternatively, when the second coil 230 is driven in a four-channel drive mode, an independent driving signal may be supplied to each of the four coil units 230-1 to 230-4, which are separated from each other.

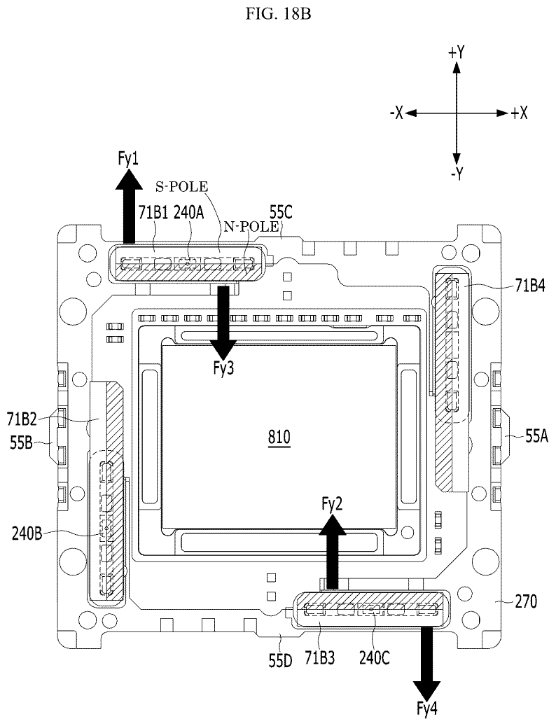

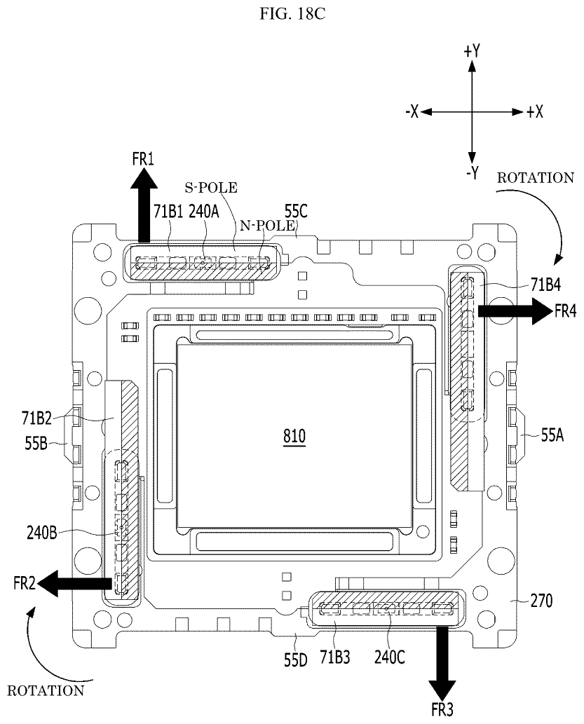

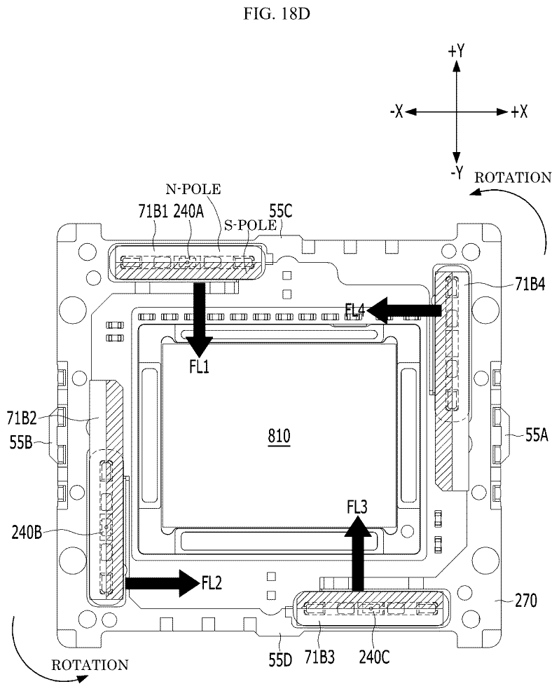

FIG. 18A is a view for explaining movement of the OIS moving unit in the X-axis direction, and FIG. 18B is a view for explaining movement of the OIS moving unit in the y-axis direction.

The N pole and the S pole of each of the first and third magnet units 71B1 and 71B3, which face each other in a first diagonal direction, may be disposed so as to face each other in the first horizontal direction (e.g., the Y-axis direction). In addition, the N pole and the S pole of each of the second and fourth magnet units 71B2 and 71B4, which face each other in a second diagonal direction, which is perpendicular to the first diagonal direction, may be disposed so as to face each other in the second horizontal direction (e.g., the X-axis direction).

That is, the direction in which the N pole and the S pole of the first magnet unit 71B1 face each other may be the same as or parallel to the direction in which the N pole and the S pole of the third magnet unit 71B3 face each other. In addition, the direction in which the N pole and the S pole of the second magnet unit 71B2 face each other may be the same as or parallel to the direction in which the N pole and the S pole of the fourth magnet unit 71B4 face each other.

In another embodiment in which the second magnet 71B is a 2-pole magnet, based on the boundary line (or the interface) between the N pole and the S pole of each of the first to fourth magnet units 71B1 to 71B4, the N pole thereof may be located at an inward position, and the S pole thereof may be located at an outward position. In another embodiment, based on the boundary line between the N pole and the S pole of each of the first to fourth magnet units 71B1 to 71B4, the S pole thereof may be located at an inward position, and the N pole thereof may be located at an outward position. The boundary line (or the interface) may be a portion that separates the N pole and the S pole from each other and has substantially no magnetism and thus almost no polarity.

Referring to FIG. 18A, the OIS moving unit may be moved or shifted in the X-axis direction by first electromagnetic force Fx1 (or Fx3) generated by interaction between the second coil unit 230-2 and the second magnet unit 71B2 and second electromagnetic force Fx2 (or Fx4) generated by interaction between the fourth coil unit 230-4 and the fourth magnet unit 71B4. In an example, the direction of the first electromagnetic force Fx1 (or Fx3) and the direction of the second electromagnetic force Fx2 (or Fx4) may be the same as each other.

Referring to FIG. 18B, the OIS moving unit may be moved or shifted in the y-axis direction by third electromagnetic force Fy1 (or Fy3) generated by interaction between the first coil unit 230-1 and the first magnet unit 71B1 and fourth electromagnetic force Fy2 (or Fy4) generated by interaction between the third coil unit 230-3 and the third magnet unit 71B3. In an example, the direction of the third electromagnetic force Fy1 (or Fy3) and the direction of the fourth electromagnetic force Fy2 (or Fy4) may be the same as each other.

FIG. 18C is a view for explaining rotation of the OIS moving unit in the clockwise direction in the four-channel drive mode, and FIG. 18D is a view for explaining rotation of the OIS moving unit in the counterclockwise direction in the four-channel drive mode.

Referring to FIG. 18C, the OIS moving unit may be rotated, tilted, or rolled in the clockwise direction about the optical axis or with respect to the optical axis by first electromagnetic force FR1 generated by interaction between the first coil unit 230-1 and the first magnet unit 71B1, second electromagnetic force FR2 generated by interaction between the second coil unit 230-2 and the second magnet unit 71B2, third electromagnetic force FR3 generated by interaction between the third coil unit 230-3 and the third magnet unit 71B3, and fourth electromagnetic force FR4 generated by interaction between the fourth coil unit 230-4 and the fourth magnet unit 71B4.

In addition, referring to FIG. 18D, the OIS moving unit may be rotated, tilted, or rolled in the counterclockwise direction about the optical axis or with respect to the optical axis by first electromagnetic force FL1 generated by interaction between the first coil unit 230-1 and the first magnet unit 71B1, second electromagnetic force FL2 generated by interaction between the second coil unit 230-2 and the second magnet unit 71B2, third electromagnetic force FL3 generated by interaction between the third coil unit 230-3 and the third magnet unit 71B3, and fourth electromagnetic force FL4 generated by interaction between the fourth coil unit 230-4 and the fourth magnet unit 71B4.

In an example, the direction of the first electromagnetic force FR1 (or FL1) and the direction of the third electromagnetic force FR3 (or FL3) may be opposite each other. In addition, in an example, the direction of the second electromagnetic force FR2 (or FL2) and the direction of the fourth electromagnetic force FR4 (or FL4) may be opposite each other. In addition, in an example, the direction of the first electromagnetic force FR1 (or FL1) and the direction of the second electromagnetic force FR2 (or FL2) may be perpendicular to each other.

In the case of the three-channel drive mode, a driving signal may not be supplied to two coil units (e.g., 130-1 and 130-3, or 130-2 and 130-4) connected in series to each other, and thus, no electromagnetic force may be generated by the two coil units connected in series to each other. In an example, in the case of the three-channel drive mode, FR2 and FR4 may be omitted, and FR1 and FR3 may be present in FIG. 18C. Alternatively, in the case of the three-channel drive mode, FR2 and FR4 may be present, and FR1 and FR3 may be omitted in FIG. 18C. In addition, in the case of the three-channel drive mode, FL2 and FL4 may be omitted, and FL1 and FL3 may be present in FIG. 18D. Alternatively, in the case of the three-channel drive mode, FL2 and FL4 may be present, and FL1 and FL3 may be omitted in FIG. 18D.

Compared to the three-channel drive mode, according to the four-channel drive mode shown in FIGS. 18C and 18D, the electromagnetic force for rotation of the OIS moving unit may be increased, and accordingly, the amount of driving current required to drive the first to fourth coil units 230-1 to 230-4 may be reduced, and thus, power consumption may be reduced.

In the embodiment shown in FIG. 2, OIS driving for hand-tremor compensation is performed using the second magnet 71B and the second coil 230. However, in another embodiment, OIS driving for hand-tremor compensation may be performed using a shape-memory-alloy member. In an example, the shape-memory-alloy member may be coupled to the fixed unit and the OIS moving unit and may be conductively connected to the first board unit 255. The controller 830 or 780 may supply a driving signal to the shape-memory-alloy member and may move the OIS moving unit in a direction perpendicular to the optical axis or may rotate, tilt, or roll the OIS moving unit about the optical axis using the shape-memory-alloy member.

In still another embodiment, OIS driving may be performed using the second magnet 71B and the second coil 230, and the camera device 10 may include a ball member (not shown), which is disposed between the base 210 and the holder 270 in order to support the OIS moving unit. In this case, the ball member may support the OIS moving unit using frictional force and/or rolling force between the base 210 and the holder 270 so that the OIS moving unit is moved in a direction perpendicular to the optical axis or is rotated, tilted, or rolled about the optical axis. In an example, the ball member may be disposed in the hole 59 in the base 210 and may be in contact with each of the base 210 and the holder 270. In another embodiment, the ball member may be provided, and the terminal unit 37 and the wire 220 may be omitted.

The second position sensor 240 may be disposed on, coupled to, or mounted on the first surface (e.g., the upper surface) of the first circuit board 250. The second position sensor 240 may detect movement or displacement of the OIS moving unit in a direction perpendicular to the optical-axis direction, for example, shift or movement of the OIS moving unit in a direction perpendicular to the optical-axis direction. In addition, the second position sensor 240 may detect rotation, rolling, or tilting of the OIS moving unit within a predetermined range about the optical axis or with respect to the optical axis. The first position sensor 170 may alternatively be referred to as an “AF position sensor”, and the second position sensor 240 may alternatively be referred to as an “OIS position sensor”.

The second position sensor 240 may oppose or overlap the magnet 130 in the optical-axis direction. In an example, the second position sensor 240 may oppose or overlap the second magnet 71B in the optical-axis direction. In an example, the second position sensor 240 may include three or more sensors corresponding to or overlapping three or more magnet units among the four magnet units 71B1 to 71B4 of the second magnet 71B in the optical-axis direction in order to detect movement of the OIS moving unit.

In an example, the second position sensor 240 may be disposed below the second coil 230.

In an example, the second position sensor 240 may not overlap the second coil 230 in a direction perpendicular to the optical axis. In an example, the sensing element of the second position sensor 240 may not overlap the second coil 230 in a direction perpendicular to the optical axis. The sensing element may be a portion that detects a magnetic field.

In an example, the center of the second position sensor 240 may not overlap the second coil 230 in a direction perpendicular to the optical axis. In an example, the center of the second position sensor 240 may be a spatial center in the x-axis and y-axis directions in an xy-coordinate plane perpendicular to the optical axis. Alternatively, the center of the second position sensor 240 may be a spatial center in the x-axis, y-axis, and z-axis directions.

In another embodiment, at least a portion of the second position sensor 240 may overlap the second coil 230 in a direction perpendicular to the optical axis.

In an example, the second position sensor 240 may overlap the holes 41A to 41C in the holder 270 in the optical-axis direction. In addition, in an example, the second position sensor 240 may overlap the cavity in the second coil 230 in the optical-axis direction. In addition, in an example, at least some of the holes 41A to 41C in the holder 270 may overlap the cavity in the second coil 230 in the optical-axis direction.

In an example, at least a portion of the second position sensor 240, for example, the center of the second position sensor 240, may not overlap the second coil 230 in the optical-axis direction.

In an example, the second position sensor 240 may include a first sensor 240A, a second sensor 240B, and a third sensor 240C, which are spaced apart from one another.

For example, each of the first to third sensors 240A, 240B, and 240C may be a Hall sensor. In another embodiment, each of the first to third sensors 240A, 240B, and 240C may be a driver IC including a Hall sensor and a driver. The description of the first position sensor 170 may be equally or similarly applied to the first to third sensors 240A, 240B, and 240C. Each of the first to third sensors 240A, 240B, and 240C may be, for example, a displacement detection sensor, the output voltage of which varies depending on the positional relationship with a magnet unit corresponding thereto.

Each of the first sensor 240A, the second sensor 240B, and the third sensor 240C may be conductively connected to the first circuit board 250.

The second position sensor 240 may be disposed below the cavity in the second coil 230. In another embodiment, when viewed in the optical-axis direction or viewed from above, the second position sensor 240 may be disposed outside the second coil 230.

The second position sensor 240 may not overlap the second coil 230 in a direction perpendicular to the optical-axis direction. In an example, the second position sensor 240 may overlap the holder 270 in a direction perpendicular to the optical-axis direction.

In an example, the first sensor 240A may be disposed below the cavity in the first coil unit 230-1. The first sensor 240A may be disposed in a hole 41A corresponding thereto among the holes 41A to 41C in the holder 270. The second sensor 240B may be disposed below the cavity in the second coil unit 230-2. The second sensor 240B may be disposed in a hole 41B corresponding thereto among the holes 41A to 41C in the holder 270. The third sensor 240C may be disposed below the cavity in the third coil unit 230-3. The third sensor 240C may be disposed in a hole 41C corresponding thereto among the holes 41A to 41C in the holder 270.

In an example, each of the first to third sensors 240A, 240B, and 240C may not overlap a corresponding one of the coil units 230-1 to 230-3 in a direction perpendicular to the optical axis. The first to third sensors 240A, 240B, and 240C may overlap the holder 270 in a direction perpendicular to the optical axis.

Since the first to third sensors 240A, 240B, and 240C are disposed so as not to overlap the OIS coil 230 in a direction perpendicular to the optical axis, the influence of the magnetic field of the OIS coil 230 on the output of the OIS position sensor 240 may be reduced, and accordingly, it is possible to accurately perform OIS feedback driving and to ensure the reliability of OIS operation.

The second position sensor 240 may oppose, correspond to, or overlap the magnet 130 in the optical-axis direction. In an example, at the initial position of the OIS moving unit, at least a portion of the first sensor 240A may overlap the first magnet unit 71B1 of the second magnet 71B in the optical-axis direction. The first sensor 240A may output a first output signal (e.g., first output voltage) corresponding to a result of detection of the magnetic field of the first magnet unit 71B1.

In an example, at the initial position of the OIS moving unit, at least a portion of the second sensor 240B may overlap the second magnet unit 71B2 of the second magnet 71B in the optical-axis direction. The second sensor 240B may output a second output signal (e.g., second output voltage) corresponding to a result of detection of the magnetic field of the second magnet unit 71B2.

In addition, in an example, at the initial position of the OIS moving unit, at least a portion of the third sensor 240C may overlap the third magnet unit 71B3 of the second magnet 71B in the optical-axis direction. The third sensor 240C may output a third output signal (e.g., third output voltage) corresponding to a result of detection of the magnetic field of the third magnet unit 71B3.

The initial position of the OIS moving unit may be the original position of the OIS moving unit in a state in which no power or driving signal is applied to the second coil 230 from the controller 830 or 780 or a position at which the OIS moving unit is located as a result of the support board being elastically deformed due only to the weight of the OIS moving unit. In addition, the initial position of the OIS moving unit may be a position at which the OIS moving unit is located when gravity acts in a direction from the first board unit 255 toward the second board unit 800 or when gravity acts in the opposite direction.

In order to improve the linearity of the relationship between the displacement of the OIS moving unit and the output from the second position sensor 250, each of the sensor units 240A, 240B, and 240C may overlap a corresponding one of the magnet units 71B1, 71B2, and 71B3 within the stroke range of the OIS moving unit in the optical-axis direction.

In an example, the controller 830 or 780 may control rolling of the OIS moving unit using at least one of first output voltage from the first sensor 240A, second output voltage from the second sensor 240B, or third output voltage from the third sensor 240C. In an example, the controller 830 or 780 may control rolling of the OIS moving unit using the first output voltage and the third output voltage.

In an example, the controller 830 or 780 may control or adjust movement or displacement of the OIS moving unit in the first horizontal direction (e.g., the y-axis direction) or the second horizontal direction (e.g., the x-axis direction) using at least one of the first to third output voltages. In an example, the controller 830 or 780 may control or adjust movement or displacement of the OIS moving unit in the first horizontal direction (e.g., the y-axis direction) using the first output voltage from the first sensor 240A and may control or adjust movement or displacement of the OIS moving unit in the second horizontal direction using the second output voltage from the second sensor 240B.

In an example, each of the first to third sensors 240A, 240B, and 240C may be a Hall sensor. In another embodiment, each of the first to third sensors may be a driver IC including a Hall sensor. In still another embodiment, each of the first and second sensors 240A and 240B may be a Hall sensor, and the third sensor 240C may be a tunnel magnetoresistance (TMR) sensor. In this case, the tunnel magnetoresistance (TMR) sensor may be a TMR magnetic angle sensor.

In still another embodiment, each of the first to third sensors 240A, 240B, and 240C may be a tunnel magnetoresistance (TMR) sensor. In this case, the TMR sensor may be a TMR linear magnetic field sensor having a linear output corresponding to the displacement (or the stroke) of the OIS moving unit.

The base 210 may be disposed below the first board unit 255. The base 210 may be spaced apart from the first board unit 255. The base 210 may have a polygonal shape, for example, a quadrangular shape, which coincides with or corresponds to the shape of the cover member 300 or the first board unit 255.

In an example, the base 210 may include a bore 210A formed therein so as to correspond to or oppose the first board unit 255. The bore 210A in the base 210 may be a through-hole formed through the base 210 in the optical-axis direction. In another embodiment, the base may not include a bore therein.

In an example, the base 210 may be coupled to the side plate 302 of the cover member 300. The base 210 may be provided on the side portion or the outer side surface thereof with a stair 211 (refer to FIG. 14), to which an adhesive is applied in order to be adhered to the side plate 302 of the cover member 300. In this case, the stair 211 may guide the side plate 302 of the cover member 300, which is coupled to the upper side thereof. The stair 211 of the base 210 and the lower end of the side plate 302 of the cover member 300 may be adhered and fixed to each other by means of an adhesive or the like.

The base 210 may include at least one protruding portion 216A or 216B protruding from the upper surface thereof. In an example, the protruding portion 216A or 216B may protrude upward from the outer side surface of the base 210. In an example, the base 210 may include two protruding portions 216A and 216B, which oppose or overlap each other in the first horizontal direction (e.g., the Y-axis direction).

In an example, the base 210 may include four side portions (or side plates), and the protruding portions 216A and 216B may be formed on two side portions among the four side portions. In an example, each of the protruding portions 216A and 216B may be disposed or located at the center of a corresponding one of the side portions (or the side plates) of the base 210.

The base 210 may include a groove 341b formed therein. The groove 341b may be an adhesive-receiving groove. The groove 341b may be formed in the outer side surface of each of the protruding portions 216A and 216B of the base 210. The groove 341b may be formed in the upper surface of each of the protruding portions 216A and 216B of the base 210. The groove 341b may be formed from the upper surface of each of the protruding portions 216A and 216B of the base 210 to the lower surface thereof. An adhesive, by which the support board 310 is adhered to the base 210, may be disposed in the groove 341b. The groove 341b may include a plurality of grooves. In an example, the groove 341b may extend in the optical-axis direction. In another embodiment, the groove formed in each of the protruding portions 216A and 216B of the base 210 may extend in a direction perpendicular to the optical axis.

The second board unit 800 may be disposed beneath the base 210. In an example, the second board unit 800 may be disposed so as to be spaced apart from the OIS moving unit, for example, the first board unit 255 and the heat dissipation member 280, in the optical-axis direction.

In an example, the second board unit 800 may be disposed on the lower surface of the base 210. The second board unit 800 may be coupled to the base 210. In an example, the second board unit 800 may be coupled to the lower surface of the base 210.

The second board unit 800 may serve to supply a signal from the outside to the image sensor unit 350 or to output a signal transmitted from the image sensor unit 350 to the outside.

The second board unit 800 may include a first region (or first board) 801, which corresponds to, opposes, or overlaps the AF driving unit 100 or the image sensor 810 in the optical-axis direction, a second region (or second board) 802, on which the connector 804 is disposed, and a third region (or third board) 803, which interconnects the first region 801 and the second region 802. The connector 804 may be provided with ports in order to be conductively connected to the second region 802 of the second board unit 800 and to be conductively connected to an external device (e.g., the optical instrument 200A). The bore 210A in the base 210 may be closed or blocked by the first region 801 of the second board unit 800.

The first region 801 of the second board unit 800 may correspond to, oppose, or overlap at least one of the cover member 300 or the base 210 in the optical-axis direction. In an example, the first region 801 may overlap the upper plate 301 and the side plate 302 of the cover member 300 in the optical-axis direction.

Each of the first region 801 and the second region 802 of the second board unit 800 may include a rigid substrate. The third region 803 may include a flexible substrate. In addition, each of the first region 801 and the second region 802 may further include a flexible substrate.

In another embodiment, at least one of the first to third regions 801 to 803 of the second board unit 800 may include at least one of a rigid substrate or a flexible substrate.

The second board unit 800 may be disposed behind the first board unit 255. In an example, the first board unit 255 may be disposed between the AF driving unit 100 and the second board unit 800. In another embodiment, the second board unit may be disposed between the AF driving unit and the first board unit.

When viewed from above, the first region 801 of the second board unit 800 may have a polygonal shape (e.g., quadrangular shape, square shape, or rectangular shape). However, the disclosure is not limited thereto. In another embodiment, the first region of the second board unit may have a circular shape.

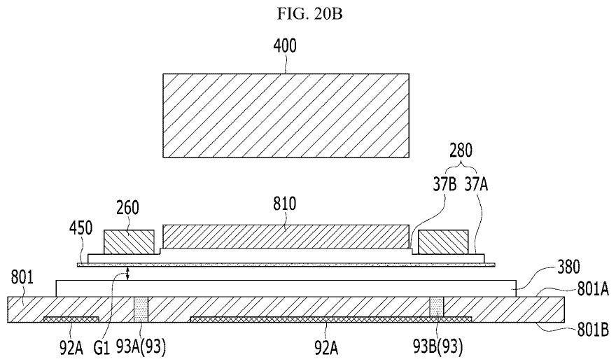

FIG. 20A is a view showing an embodiment of placement of the first to third regions 801 to 803 of the second board unit 800, the extension region 808, the AF moving unit, the OIS moving unit, and the controller 830.

Referring to FIG. 20A, the first region 801 may include four side portions (or side surfaces) 85A to 85D. In an example, the first region 801 may include first and second side portions 85A and 85B, which oppose each other or are located opposite each other in the second horizontal direction (e.g., the X-axis direction), and third and fourth side portions 85C and 85D, which oppose each other or are located opposite each other in the first horizontal direction (e.g., the Y-axis direction).

The second region 802 may be disposed adjacent to the first side portion 85A of the first region 801, and the third region 803 may be connected to the first side portion 85A of the first region 801. In an example, the third region 803 may extend from the first region 801 and may be connected to the side of the second region 802 that opposes the first side portion 85A.

The second board unit 800 may include a plurality of terminals 800B corresponding to terminals 311 of the support board 310. The plurality of terminals 800B may be formed in the first region 801 of the second board unit 800. In an example, the second board unit 800 may include first terminals 800B1, which are disposed or arranged so as to be spaced apart from each other in the second horizontal direction (e.g., the X-axis direction) along the side of the third side portion 85C of the first region 801, and second terminals 800B2, which are disposed or arranged so as to be spaced apart from each other in the second horizontal direction along the side of the fourth side portion 85D of the first region 801.

In an example, the plurality of terminals 800B may be formed on the first surface (e.g., the upper surface) of the second board unit 800 (e.g., the first region 801), which faces the first board unit 255.

In an example, the controller 830 may be disposed in the extension region extending from any one of the third and fourth side portions 85C and 85D of the first region 801 of the second board unit 800. In another embodiment, the controller may be disposed in the extension region extending from the side portion of the first region 801 of the second board unit 800, on which the plurality of terminals is formed.

A coupling hole (not shown) may be formed in the first region 801, and a coupling protrusion (not shown) may be formed on the base 210 in order to be coupled to the coupling hole in the first region 801.

The camera device 10 may further include a heat dissipation member 380, which is disposed on, coupled to, or fixed to the second board unit 800. In an example, the heat dissipation member 380 may be disposed on, coupled to, or fixed to the upper surface of the first region 801 of the second board unit 800. In another embodiment, the heat dissipation member 380 may be omitted.

The camera device 10 may further include a third heat dissipation member (not shown), which is disposed on, coupled to, or fixed to the second surface (e.g., the lower surface) of the second board unit 800.

In an example, the heat dissipation member 380 may be a plate-type member having a predetermined thickness and hardness. In addition, the heat dissipation member 380 may oppose or overlap the heat dissipation member 280 in the optical-axis direction.

Referring to FIG. 20A, the controller 830 may be disposed on or coupled to the upper surface of the extension region 808. In another embodiment, the controller may be disposed on or coupled to the lower surface of the extension region 808.

Referring to FIG. 20A, the controller 830 may be disposed in the extension region 808 of the second board unit 800, which is located outside the cover member 300. In another embodiment, the controller may be disposed in the first region of the second board unit 800, which is located outside the base 210.

In still another embodiment, the controller may be disposed or mounted on the second circuit board 260, which is a sensor board. In another embodiment, the controller may be disposed or mounted on the upper surface of the second circuit board 260. Since the heat dissipation member 280 is disposed on or coupled to the lower surface of the second circuit board 260, when the controller is disposed on the second circuit board 260, heat generated from the controller may be easily dissipated by the heat dissipation member 280, and accordingly, heat dissipation efficiency and heat dissipation performance may be improved.

FIG. 20B is a schematic cross-sectional view of the lens module 400, the first board unit 255, the image sensor 810, and the second board unit 800.

Referring to FIG. 20B, the image sensor 810 may be disposed in the bore (or the hole) 260A in the second circuit board 260 and may be coupled to the heat dissipation member 280.

In an example, the heat dissipation member 280 may include a body 37A, which is disposed beneath the second circuit board 260, and a protruding portion (or protruding region) 37B, which protrudes from the body 37A and is disposed in the bore 260A in the second circuit board 260.

The camera device 10 may include a heat dissipation body 450 interconnecting the heat dissipation member 280 and the support unit (e.g., the support board 310).

The heat dissipation body 450 may include a body (or a first region) coupled to the lower surface of the heat dissipation member 280 and a connection portion (or a second region) interconnecting the body and the support unit (e.g., the support board 310). The heat dissipation body 450 may include a graphite sheet.

The image sensor 810 may be disposed on, coupled to, or fixed to the protruding portion 37B. In an example, the image sensor 810 may be disposed on, coupled to, or attached to the upper surface of the protruding portion 37B. In an example, the upper surface of the protruding portion 37B may be located at a lower position than the upper surface of the second circuit board 260. In another embodiment, the upper surface of the protruding portion 37B may be located at the same height as the upper surface of the second circuit board 260.

The heat dissipation member 380 may be disposed on the first surface 801A (or the upper surface) of the first region 801 of the second board unit 800, which opposes the heat dissipation member 280 in the optical-axis direction.

A spacing distance (or gap) G1 between the first board unit 255 and the second board unit 800 in the optical-axis direction may be 0.05 mm to 0.7 mm. In an example, the spacing distance G1 may be a distance between the lower surface of the heat dissipation member 280 and the upper surface of the heat dissipation member 380.

In another embodiment, G1 may be 0.15 mm to 0.5 mm. In still another embodiment, G1 may be 0.15 mm to 0.3 mm. In still another embodiment, G1 may be 0.2 mm to 0.3 mm.

The second board unit 800 may include a first conductive layer 93, which is exposed to the first surface 801A and is in contact with the heat dissipation member 380, for example, the lower surface of the heat dissipation member 380. In an example, the first conductive layer 93 may be thermally bonded to the lower surface of the heat dissipation member 380 or may be coupled to the lower surface of the heat dissipation member 380 by means of a conductive adhesive, for example, solder. In addition, in an example, the first conductive layer 93 may be conductively connected to the heat dissipation member 380.

The second board unit 800 may include a second conductive layer 92A, which is connected to the first conductive layer 93 and is exposed from the second surface 801B (or the lower surface) of the second board unit 800, which is a surface opposite the first surface 801A of the second board unit 800. In an example, the second conductive layer 92A may be conductively connected to the ground of the second board unit 800.

The first conductive layer 93 may take the form of a via, which is formed through at least a portion of the second board unit 800. In an example, the first conductive layer 93 may include a first via 93A formed through the second board unit 800 so as to be open or exposed to the second surface 801B of the second board unit 800. In addition, one end of the first conductive layer 93 may be in contact with the lower surface of the heat dissipation member 380, and the other end thereof may include a second via 93B formed therein so as to be in contact with, coupled to, or connected to the second conductive layer 92A.

Referring to FIG. 20B, the second conductive layer 92A may be disposed in, coupled to, or attached to a recess formed in the second surface 801B of the second board unit 800. In another embodiment, the second conductive layer may be disposed on, coupled to, or attached to the second surface 801B of the second board unit 800, which is a flat surface in which no recess is formed.

Each of the first conductive layer 93 and the second conductive layer 92A may serve as a heat dissipation pattern or a heat dissipation pad for dissipating heat from the second board unit 800. That is, because the first conductive layer 93 and the second conductive layer 92A are provided only for the purpose of heat dissipation, the first conductive layer 93 and the second conductive layer 92A may not be conductively connected to wires of the second board unit 800 other than the ground of the second board unit 800. In this case, the other wires may be wires conductively connected to the controller 830 or 780, an electronic element (or circuit element) such as the image sensor 810, or the support board 310.

The second conductive layer 92A may be conductively connected to the cover member 300 (e.g., the side plate 302) via solder, a conductive adhesive, or a sheet of conductive tape. Alternatively, in another embodiment, the second conductive layer 92A, which is connected to the ground of the second board unit 800, may be conductively connected to the cover member 300 via a bracket. The bracket may be a structure in which the camera device is accommodated or received in order to protect the camera device. In an example, the bracket may be formed of a conductive material. Since the ground of the second board unit 800, the heat dissipation member 380, and the cover member 300 are conductively connected to one another, it is possible to protect the camera device 10 from static electricity and to improve heat dissipation efficiency.

In another embodiment, at least one of the first conductive layer or the second conductive layer of the second board unit 800 may be equally or similarly applied to the second circuit board 260. In an example, the second circuit board 260 according to another embodiment may include at least one third conductive layer, which is in contact with the heat dissipation member 280, and at least a portion of the third conductive layer may be exposed from the second circuit board 260.

Since the heat dissipation member 380 is disposed on the first surface of the second board unit 800, the spacing distance from the heat dissipation member 280 may be reduced, and accordingly, heat dissipation efficiency may be improved.

Heat dissipated from the heat dissipation member 280 may be transferred to the heat dissipation member 380 through convection or radiation, and the transferred heat may be dissipated outside through the heat dissipation member 380. Accordingly, heat dissipation effect may be improved. Since the upper surface of the heat dissipation member 380 and the lower surface of the heat dissipation member 280 are disposed so as to face or overlap each other in the optical-axis direction, heat may be smoothly transferred from the heat dissipation member 280 to the heat dissipation member 380.

In an example, the heat dissipation member 280 and the heat dissipation member 380 may be formed of the same material. In another embodiment, the heat dissipation member 280 and the heat dissipation member 380 may be formed of different materials. In an example, the thermal conductivity of the heat dissipation member 280 may be equally or similarly applied to the heat dissipation member 380.

In addition, the heat dissipation member 380 may serve as a reinforcing member for stably supporting the second board unit 800 and suppressing the second board unit 800 from being damaged due to external impact or contact.

In another embodiment, the heat dissipation member 380 may be formed of a heat dissipation material having high thermal conductivity, for example, heat dissipation epoxy, heat dissipation plastic, or heat dissipation synthetic resin.

The heat dissipation member 380 may include at least one groove or at least one uneven portion in order to improve heat dissipation effect. In an example, a groove or an uneven portion having a predetermined pattern may be formed in at least one of the upper surface or the lower surface of the heat dissipation member 380.

In another embodiment, the heat dissipation member 380 may include a hole or a through-hole in place of the groove. In an example, the heat dissipation member 380 according to another embodiment may include a plurality of through-holes. The description of the predetermined pattern of the heat dissipation member 280 may be equally or similarly applied to the heat dissipation member 380.

A camera device according to another embodiment may include a heat dissipation member disposed beneath the second board unit 800. In this case, the description of the material of the heat dissipation member 280 or 380 may be equally or similarly applied to the material of this heat dissipation member.

The support board 310 may support the moving unit so that the OIS moving unit is moved relative to the fixed unit in a direction perpendicular to the optical-axis direction, and may conductively connect the first board unit 255 to the second board unit 800.

The support board 310 may alternatively be referred to as a “support member”, a “connection board”, or a “connection part”. Alternatively, the support board 310 may be referred to as an “interposer”. Alternatively, the “interposer” may include the first circuit board 250 and the support board 310 formed integrally with each other.

In another embodiment, instead of the support board 310, there may be provided a support unit, one end of which is connected to the moving unit, for example, the first board unit 255, and the other end of which is connected to the fixed unit, for example, the second board unit 800. In an example, the support unit may include at least one of a leaf spring or a suspension wire. In an example, the support unit may conductively interconnect the first board unit 255 and the second board unit 800.

The support board 310 may include a flexible substrate or may be a flexible substrate. In an example, the support board 310 may include a flexible printed circuit board (FPCB). At least a portion of the support board 310 may be flexible. The first circuit board 250 and the support board 310 may be connected to each other.

Referring to FIG. 16, in an example, the support board 310 may include a connection portion 320, which is connected to the first circuit board 250. In an example, the first circuit board 250 and the support board 310 may be integrally formed with each other. In another embodiment, the first circuit board 250 and the support board 310 may be provided separately from each other, rather than being integrated, may be connected to each other via the connection portion 320, and may be conductively connected to each other. Alternatively, in another embodiment, the connection portion 320 may be integrally formed with at least one of the support board 310 or the first circuit board 250.

In addition, the support board 310 may be conductively connected to the first circuit board 250. The support board 310 may be conductively connected to the second board unit 800. In an example, one end of the support board 310 may be connected or coupled to the first board unit 255 (e.g., the second circuit board 260). In addition, the other end of the support board 310 may be connected or coupled to the second board unit 800.

The support board 310 may support the OIS moving unit with respect to the fixed unit. In addition, the support board 310 may guide movement of the OIS moving unit. The support board 310 may guide the OIS moving unit to move in a direction perpendicular to the optical-axis direction. The support board 310 may guide the OIS moving unit to rotate, tilt, or roll about the optical axis. The support board 310 may restrict movement of the OIS moving unit in the optical-axis direction.

A portion of the support board 310 may be coupled, attached, or fixed to the base 210, which is the fixed unit, and the other portion of the support board 310 may be coupled, attached, or fixed to the holder 270, which is the OIS moving unit.

In an example, portions of bodies 86 and 87 of the support board 310 may be coupled to the base 210 (e.g., the protruding portions 216A and 216B), which is the fixed unit, and other portions of the bodies 86 and 87 may be coupled to the holder 270 (e.g., the protruding portions 27A and 27B), which is the OIS moving unit.

The connection portion 320 of the support board 310 may be coupled to the first board unit 255 (e.g., the first board unit 250) and may be conductively connected thereto. The extension portions 7A to 7D of the support board 310 may be coupled to the second board unit 800 (e.g., the terminals 800B) and may be conductively connected thereto.

In an example, the support board 310 may include a circuit member and an elastic unit coupled to the circuit member. The elastic unit serves to elastically support the OIS moving unit, and may be implemented as an elastic body, for example, a spring. The elastic unit may include metal or may be made of an elastic material. The circuit member serves to conductively connect the first circuit board 250 to the second board unit 800, and may be a flexible substrate or may include at least one of a flexible substrate or a rigid substrate. The circuit member may be, for example, an FPCB.

In an example, the support board 310 may be connected to the first board unit 255 (e.g., the first circuit board 250) and may include at least one connection portion 320A or 320B, which is conductively connected to the first board unit 255 (e.g., the first circuit board 250).

In addition, the support board 310 may include at least one extension portion 7A to 7D, which is coupled to the second board unit 800 and is conductively connected to the second board unit 800, and the at least one extension portion 7A to 7D may include a plurality of terminals 311.

In an example, the support board 310 may be disposed so as to surround the OIS moving unit, for example, the first board unit 255. In an example, the support board 310 may be disposed so as to surround the four side portions 33A to 33D (refer to FIG. 16) or the outer side surfaces of the first circuit board 250.

In an example, the support board 310 may not overlap the OIS moving unit, for example, the first board unit 255, in the optical-axis direction, and at least a portion of the support board 310 may overlap the OIS moving unit, for example, the first board unit 255, in a direction perpendicular to the optical-axis direction.

In an example, the support board 310 may include a plurality of support boards that are separated from or spaced apart from each other. In another embodiment, the support board 310 may be formed in an integral type.

The support board 310 may include bodies 86 and 87. In an example, the bodies 86 and 87 may be disposed so as to surround the OIS moving unit, for example, the first board unit 255. In an example, the bodies 86 and 87 may not overlap the OIS moving unit, for example, the first board unit 255, in the optical-axis direction, and at least portions of the bodies 86 and 87 may overlap the OIS moving unit, for example, the first board unit 255, in a direction perpendicular to the optical-axis direction.

For example, the bodies 86 and 87 may have a plate shape that is flat in the optical-axis direction or a direction parallel to the optical-axis direction. For example, when viewed from above, the external shape of the bodies 86 and 87 may be a polygonal shape such as a quadrangular shape or a circular shape.

In an example, each of the bodies 86 and 87 may include a plurality of portions that are separated from or spaced apart from each other. In another embodiment, each body may be formed in an integral type.

In addition, the support board 310 may include an extension portion that extends from each of the bodies 86 and 87 to be coupled to the second board unit 800. In an example, the extension portion of the support board 310 may extend toward the second board unit 800, and one end portion of the extension portion of the support board 310 may be coupled to the second board unit 800. A plurality of terminals, which are conductively connected to the second board unit 800 by means of solder or a conductive adhesive, may be provided at one end portion of the extension portion of the support board 310. For example, the extension portion of the support board 310 may alternatively be referred to as a “terminal portion”, a “protruding portion”, or a “leg member”.

The extension portions 7A to 7D may extend from the bodies 86 and 87 toward the second board unit 800. In an example, the extension portions 7A to 7D may extend from the bodies 86 and 87 in the first direction. In addition, the extension portions 7A to 7D may extend in the second horizontal direction (the X-axis direction).

When viewed from the front, two extension portions 7D and 7B may be bilaterally symmetrical with each other. In an example, the two extension portions 7D and 7B may be bilaterally symmetrical with each other with respect to a straight line that is parallel to the optical axis and extends through the center point between the two extension portions 7D and 7B.

When viewed from the front, the other two extension portions 7A and 7C may be bilaterally symmetrical with each other. In an example, the other two extension portions 7A and 7C may be bilaterally symmetrical with each other with respect to a straight line that is parallel to the optical axis and extends through the center point between the other two extension portions 7A and 7C.

The extension portion 7D may include a first extension portion 45A (or a first portion) extending from the bodies 86 and 87 toward the second board unit 800 and a second extension portion 45B (or a second portion) extending in a direction different from the extension direction of the first extension portion. In an example, the first extension portion 45A may extend in the optical-axis direction, and the second extension portion 45B may extend in a direction perpendicular to the optical axis.

In an example, the first extension portion may extend in the first direction (e.g., the Z-axis direction). In an example, the second extension portion 45B may extend in the second horizontal direction (e.g., the X-axis direction). In an example, the second extension portion 45B may extend in the leftward or rightward direction with respect to one end of each of the bodies 86 and 87 or a center line. Here, the center line may be an imaginary line that passes through the center point between two adjacent extension portions (e.g., 7D and 7B, or 7A and 7C).

In an example, the second extension portion 45B may extend left or right from the first extension portion 45A. When viewed from the front, the overall shape of the extension portion 7D may be an L-shape (“└”) or a shape (“┘”) bilaterally symmetrical with the L-shape (“└”).

The length of the extension portion 7D in the transverse direction may be greater than the length of the extension portion 7D in the longitudinal direction. The reason for this is to easily dispose or arrange the terminals in the second horizontal direction.

Each of the extension portions 7A to 7D may include a plurality of terminals 311 (refer to FIG. 16). In an example, the plurality of terminals 311 may be disposed at the lower portions or lower ends of the extension portions 7A to 7D. In an example, the plurality of terminals 311 may be disposed in contact with the lower ends or lower surfaces of the extension portions 7A to 7D. In an example, the plurality of terminals 311 may be disposed or arranged so as to be spaced apart from each other in the second horizontal direction (e.g., the X-axis direction).

In an example, the extension portions 7A to 7D of the support board 310 may be fixed or coupled to the fixed unit (e.g., the base 210). In an example, when the OIS moving unit is moved or shifted, the bodies 86 and 87 of the support board 310 may be moved, and the extension portions 7A to 7D of the support board 310 may be fixed and thus may not be moved.

In an example, the support board 310 may include a first support board 310-1 and a second support board 310-2, which are spaced apart from each other. The first and second support boards 310-1 and 310-2 may be formed to be bilaterally symmetrical with each other. In another embodiment, the first support board 310-1 and the second support board 310-2 may be integrated into a single board. In still another embodiment, the support board 310 may include three or more support boards.

In an example, the first and second support boards 310-1 and 310-2 may be disposed so as to surround the four side portions 33A to 33D of the first circuit board 250.

In an example, the first support board 310-1 may include a first body 86 and at least one extension portion 7A or 7B extending from the first body 86. The at least one extension portion 7A or 7B of the first support board 310-1 may include a plurality of terminals 311.

The second support board 310-2 may include a second body 87 and at least one extension portion 7C or 7D extending from the second body 87. The at least one extension portion 7C or 7D of the second support board 310-2 may include a plurality of terminals 311.

The first circuit board 250 may include a first side portion 33A and a second side portion 33B, which are located opposite each other, and may include a third side portion 33C and a fourth side portion 33D, which are located between the first side portion 33A and the second side portion 33B and are located opposite each other.

In an example, the first connection portion 320A may connect the first body 86 to the first side portion 33A of the first circuit board 250. The second connection portion 320B may connect the second body 87 to the second side portion 33B of the first circuit board 250.

The first body 86 may include a first portion 6A, which corresponds to or opposes the first side portion 33 A of the first circuit board 250, a second portion 6B, which corresponds to a portion (or one side) of the third side portion 33C of the first circuit board 250, and a third portion 6C, which corresponds to a portion (or one side) of the fourth side portion 33D of the first circuit board 250. In addition, the first body 86 may include a first bent portion 6D, which connects one end of the first portion 6A to the second portion 6B and is bent from the end of the first portion 6A, and a second bent portion 6E, which connects the other end of the first portion 6A to the third portion 6C and is bent from the other end of the first portion 6A. For example, the first body 86 may have a “U” shape.

In an example, the first support board 310-1 may include an extension portion 7A and an extension portion 7B. In an example, the extension portion 7A may be connected to one side of the first body 86, and the extension portion 7B may be connected to the other side of the first body 86.

In an example, the extension portion 7A may extend or protrude from the second portion 6B of the first body 86 toward the second board unit 800, and the extension portion 7B may extend or protrude from the third portion 6C of the first body 86 toward the second board unit 800. The extension portion 7B may be located opposite the extension portion 7A with the first board unit 255 (e.g., the first circuit board 250) interposed therebetween.

In an example, the first connection portion 320A may connect the first portion 6A of the first body 86 to the first side portion 33A of the first circuit board 250. The first connection portion 320A may include a bent portion. In an example, the first connection portion 320A may connect the central region of the first portion 6A of the first body 86 to the central region of the first side portion 33A of the first circuit board 250.

The second body 87 may include a first portion 9A, which corresponds to or opposes the second side portion 33B of the first circuit board 250, a second portion 9B, which corresponds to or opposes another portion (or the opposite side) of the third side portion 33C of the first circuit board 250, and a third portion 9C, which corresponds to or opposes another portion (or the opposite side) of the fourth side portion 33D of the first circuit board 250. In addition, the second body 87 may include a first bent portion 9D, which connects one end of the first portion 9A to the second portion 9B and is bent from the end of the first portion 9A, and a second bent portion 9E, which connects the other end of the first portion 9A to the third portion 9C and is bent from the other end of the first portion 9A. For example, the second body 87 may have a “U” shape. In addition, for example, the second body 87 may have a shape symmetrical with the shape of the first body 86 with respect to the optical axis. For example, the second body 87 may be symmetrical with the first body 86 with respect to the optical axis.

In an example, the second support board 310-2 may include an extension portion 7C and an extension portion 7D. In an example, the extension portion 7C may be connected to one side of the second body 87, and the extension portion 7D may be connected to the other side of the second body 87.

The extension portion 7C may extend or protrude from the second portion 9B of the second body 87 toward the second board unit 800, and the extension portion 7D may extend or protrude from the third portion 9C of the second body 87 toward the second board unit 800. The extension portion 7D may be located opposite the extension portion 7C with the first board unit 255 (e.g., the first circuit board 250) interposed therebetween.

In an example, when viewed from the front, the extension portion 7A and the extension portion 7C may be bilaterally symmetrical with each other. In another embodiment, the extension portion 7A and the extension portion 7C may not be bilaterally symmetrical with each other.

In addition, in an example, when viewed from the front, the extension portion 7B and the extension portion 7D may be bilaterally symmetrical with each other. In another embodiment, the extension portion 7B and the extension portion 7D may not be bilaterally symmetrical with each other.

In an example, the second connection portion 320B may connect the first portion 9A of the second body 87 to the second side portion 33B of the first circuit board 250. The second connection portion 320B may include a bent portion. In an example, the second connection portion 320B may connect the central region of the first portion 9A of the second body 87 to the central region of the second side portion 33B of the first circuit board 250.

Referring to FIG. 16, the terminal units (e.g., 7A and 7C) of the support board 310 may be provided with terminals P1 to P4 in order to be conductively connected to the terminals B1 to B4 of the terminal unit 95 of the circuit board 190 of the AF driving unit 100. The terminals B1 to B4 of the terminal unit 95 of the circuit board 190 and the terminals P1 to P4 of the extension portions 7A and 7C of the support board 310 may be conductively connected to each other by means of solder or a conductive adhesive. That is, the circuit board 190 of the AF driving unit 100 may be conductively connected to the second board unit 800 via the support board 310.

Referring to FIG. 16, the support board 310 may include a conductive layer 93-1. In addition, the support board 310 may include a first insulating layer 94-1 disposed on one surface (or a first surface) or one side of the conductive layer 93-1. In addition, the support board 310 may include a second insulating layer 94-2 disposed on the other surface (or a second surface) or the other side of the conductive layer 93-1. In another embodiment, the support board 310 may include at least one of the first insulating layer 94-1 or the second insulating layer 94-2. The support board 310 may include a protective layer 96 disposed on the first insulating layer 94-1. For example, the protective layer 96 may be an EMI member (e.g., a sheet of EMI tape). Alternatively, the protective layer 96 may be a heat dissipation member, for example, graphite. Alternatively, for example, the protective layer 96 may be an elastic material. Alternatively, for example, the protective layer 96 may be a conductive member. Alternatively, for example, the protective layer 96 may be an insulating member.

FIG. 17A is a first perspective view of the support board 310 coupled to the holder 270 and to the base 210, and FIG. 17B is a second perspective view of the support board 310 coupled to the holder 270 and to the base 210.

Referring to FIGS. 17A and 17B, the holder 270 may include first to fourth side portions 64A to 64D (refer to FIG. 18A) corresponding to or opposing the first to fourth side portions 33A to 33D of the first circuit board 250.

The first and second side portions 64A and 64B of the holder 270 may oppose each other or may be disposed opposite each other in the second horizontal direction (e.g., the X-axis direction). In addition, the third and fourth side portions 64C and 64D of the holder 270 may oppose each other or may be disposed opposite each other in the first horizontal direction (e.g., the Y-axis direction).

At least a portion of the support board 310 may be attached or coupled to the holder 270. In an example, at least one connection portion 320A or 320B of the support board 310 may be coupled to at least one of the first to fourth side portions 64A to 64D of the holder 270 by means of an adhesive. In an example, the first connection portion 320A may be coupled, attached, or fixed to the first side portion 64A of the holder 270 by means of an adhesive, and the second connection portion 320B may be coupled, attached, or fixed to the second side portion 64B of the holder 270.

The holder 270 may be provided on the first side portion 64A thereof with a first protruding portion 27A, and may be provided on the second side portion 64B thereof with a second protruding portion 27B.

The support board 310 may be coupled, attached, or fixed to the protruding portions 27A and 27B of the holder 270. The support board 310 may be coupled, attached, or fixed to the outer side surfaces (or the inner side surfaces) of the protruding portions 27A and 27B of the holder 270.

In an example, a portion of the support board 310 may be coupled, attached, or fixed to the first protruding portion 27A and the second protruding portion 27B of the holder 270. The bodies 86 and 87 of the support board 310 may be coupled, attached, or fixed to the first and second protruding portions 27A and 27B of the holder 270.

In an example, the first support board 310-1 may be coupled, attached, or fixed to the first protruding portion 27A, and the second support board 310-2 may be coupled, attached, or fixed to the second protruding portion 27B. In an example, the first portion 6A of the first body 86 may be coupled, attached, or fixed to the outer side surface (or the inner side surface) of the first protruding portion 27A, and the first portion 9A of the second body 87 may be coupled, attached, or fixed to the outer side surface (or the inner side surface) of the second protruding portion 27B.

The base 210 may include first to fourth side portions 65A to 65D (refer to FIG. 14) corresponding to or opposing the first to fourth side portions 33A to 33D of the first circuit board 250. In addition, the first to fourth side portions 65A to 65D of the base 210 may correspond to or oppose the first to fourth side portions 64A to 64D of the holder 270.

The first and second side portions 65A and 65B of the base 210 may oppose each other or may be disposed opposite each other in the first horizontal direction (e.g., the Y-axis direction). In addition, the third and fourth side portions 65C and 65D of the base 210 may oppose each other or may be disposed opposite each other in the second horizontal direction (e.g., the X-axis direction).

At least a portion of the support board 310 may be coupled, attached, or fixed to the base 210. In an example, the bodies 86 and 87 of the support board 310 may be coupled to the base 210 by means of an adhesive. In an example, the extension portions 7A to 7D of the support board 310 may be coupled, attached, or fixed to the protruding portions 216A and 216B of the base 210. In addition, in an example, portions of the bodies 86 and 87 of the support board 310, which are connected to the extension portions 7A to 7D, may be coupled to the base 210.

The base 210 may include accommodation portions 46A and 46B in order to be coupled or attached to at least a portion of the support board 310. The accommodation portions 46A and 46B may be formed in a recess shape. The accommodation portions 46A and 46B may be recesses depressed in the outer side surfaces of the side portions of the base 210.

In an example, the base 210 may include a first recess 46A formed in the third side portion 65C thereof to allow the extension portions 7A and 7C to be disposed therein and coupled thereto. In an example, the base 210 may include a second recess 46B formed in the fourth side portion 65D thereof to allow the extension portions 7B and 7D to be disposed therein and coupled thereto. The recesses 46A and 46B may be depressed in the outer side surfaces of the side portions 65C and 65D of the base 210.

In an example, the depth of the recesses 46A and 46B in the base 210 may be greater than or equal to the thickness of the extension portions 7A to 7D of the support board 310. The reason for this is to inhibit the extension portions 7A to 7D from protruding outside the recesses 46A and 46B and inhibit spatial interference between the extension portions 7A to 7D and the side plate 302 of the cover member 300. This is because spatial interference between the extension portions 7A to 7D and the side plate 302 of the cover member 300 may restrict movement of the OIS moving unit.

In an example, the outer side surface of the protruding portion 216A may be disposed closer to the optical axis OA than the outer side surface of the third side portion 65C of the base 210. In addition, in an example, the outer side surface of the protruding portion 216B may be disposed closer to the optical axis OA than the outer side surface of the fourth side portion 65D of the base 210.

In an example, the outer side surface of the protruding portion 216A (or 216B) may be located farther inward than the outer side surface of the third side portion 65C (or the fourth side portion 65D) of the base 210. In an example, a step may be present in the first horizontal direction (e.g., the Y-axis direction) between the outer side surface of the protruding portion 216A (or 216B) and the third side portion 65C (or the fourth side portion 65D) of the base 210.

In an example, the upper sides of the recesses 46A and 46B in the base 210 may be open to the upper surface of the base 210. In addition, in an example, the lower sides of the recesses 46A and 46B in the base 210 may be open to the lower surface of the base 210.

In an example, at least a portion of the support board 310 may be coupled, attached, or fixed to the protruding portions 216A and 216B formed on the base 210. In an example, the support board 310 may be coupled, attached, or fixed to the outer side surfaces (or the inner side surfaces) of the protruding portions 216A and 216B of the base 210. The first protruding portion 216A may be formed on the third side portion 65C of the base 210, and the second protruding portion 216B may be formed on the fourth side portion 65D of the base 210.

In an example, the bodies 86 and 87 of the support board 310 may be coupled, attached, or fixed to the first and second protruding portions 216A and 216B of the base 210.

In an example, one end (e.g., the second portion 6B) of the first support board 310-1 may be coupled, attached, or fixed to one region of the first protruding portion 216A of the base 210, and the other end (e.g., the third portion 6C) of the first support board 310-1 may be coupled, attached, or fixed to one region of the second protruding portion 216B of the base 210.

In an example, one end (e.g., the second portion 9B) of the second support board 310-2 may be coupled, attached, or fixed to another region of the first protruding portion 216A of the base 210, and the other end (e.g., the third portion 9C) of the second support board 310-2 may be coupled, attached, or fixed to another region of the second protruding portion 216B of the base 210.

A first coupling region 69A may be formed between the first body 86 of the first support board 310-1 and the first protruding portion 27A of the holder 270, and a second coupling region 69B may be formed between the second body 87 of the second support board 310-2 and the second protruding portion 27B of the holder 270.

In addition, a third coupling region 59A may be formed between one end of each of the first and second support boards 310-1 and 310-2 and the first protruding portion 216A of the base 210. A fourth coupling region 59B may be formed between the other end of each of the first and second support boards 310-1 and 310-2 and the second protruding portion 216B of the base 210.

The OIS moving unit may be elastically supported with respect to the fixed unit by the support board 310 and the first to fourth coupling regions 69A, 69B, 59A, and 59B. The terminals 311 of the support board 310 may be coupled and conductively connected to the terminals 800B of the second board unit 800 by means of solder 902 (refer to FIGS. 17A and 17B) or a conductive adhesive.

In another embodiment, the support member may be an elastic member including no substrate, for example, a spring, a wire, a shape memory alloy, or a ball member. In an example, in the case in which the support member is a wire, a plurality of wires may be disposed on at least one of the corners or the side portions of the base 210 or the second board unit 800, and may interconnect the first board unit 255 (e.g., the second circuit board 260) and the second board unit 800 (or the base 210). In an example, one end of each of the plurality of wires may be coupled to the first board unit 255 (e.g., the second circuit board 260), and the other end of each of the plurality of wires may be coupled to the second board unit 800 (or the base 210).

The image sensor unit 350 may include at least one of a controller 830, a memory 512, or a capacitor 514.

The controller 830 may be disposed so as to be spaced apart from the first board unit 255. In an example, the controller 830 may be disposed on the second board unit 800.

The memory 512 may be disposed on any one of the first board unit 255 and the second board unit 800. In an example, the memory 512 may be disposed or mounted in the first region 801 of the second board unit 800. In an example, the memory 512 may spatially avoid or be spaced apart from the heat dissipation member 380. In an example, the heat dissipation member 380 may include an escape recess or a bore formed therein in order to avoid spatial interference with the memory 512, and the memory 512 may be disposed in the escape recess or the bore in the heat dissipation member 380. The capacitor 514 may be disposed on at least one of the first board unit 255 or the second board unit 800.

The memory 512 may store a first data value (or code value) corresponding to the output from the second position sensor 240 according to displacement (or stroke) of the OIS moving unit in a direction perpendicular to the optical axis (e.g., the X-axis direction or the Y-axis direction) in order to implement OIS feedback driving. In addition, the memory 512 may store a second data value (or code value) corresponding to the output from the first position sensor 170 according to displacement (or stroke) of the bobbin 110 in the first direction (e.g., the optical-axis direction or the Z-axis direction) in order to implement AF feedback driving.

In an example, each of the first and second data values may be stored in the memory 512 in the form of a look-up table. Alternatively, each of the first and second data values may be stored in the memory 512 in the form of an equation or an algorithm. In addition, the memory 512 may store an equation, an algorithm, or a program for operation of the controller 830. In an example, the memory 512 may be a non-volatile memory, for example, an electrically erasable programmable read-only memory (EEPROM).

The controller 830 may be disposed in one region of the second board unit 800 that is located on the outer side of the cover member 300 or is located outside the cover member 300.

Referring to FIG. 20A, the second board unit 800 may include an extension region 808, which is connected to the first region 801 and extends from the first region 801. The extension region 808 may extend from the first side portion 85A of the first region 801. In an example, the extension region 808 may protrude from the outer side surface of the first side portion 85A of the first region. In an example, the extension region 808 may extend or protrude in the second horizontal direction (e.g., the X-axis direction).

The extension region 808 may be located on the outer side of the cover member 300 or may be located outside the cover member 300.

The extension region 808 may alternatively be referred to as a “fourth region”, a “protruding region”, an “extension portion”, or a “protruding portion”. The extension region 808 does not overlap the AF moving unit or the OIS moving unit in the optical-axis direction. In an example, the extension region 808 may extend in the same direction as the third region 803 (e.g., the second horizontal direction).

The controller 830 may be disposed in the extension region 808 of the second board unit 800. In an example, the controller 830 may be disposed or mounted on the upper surface of the extension region 808 of the second board unit 800. In another embodiment, the controller 830 may be disposed or mounted on the lower surface of the extension region 808. In an example, the controller 830 may not overlap the cover member 300 in the optical-axis direction. In addition, in an example, the extension region 808 may not overlap the cover member 300 in the optical-axis direction. In an example, the area of the upper surface of the extension region 808 may be larger than or equal to the area of the lower surface of the controller 830.

Since the extension region 808 and the third region 803 are connected to the first side portion 85A of the second board unit 800, the area occupied by the camera device 10 in a direction perpendicular to the optical axis may be reduced. Accordingly, the embodiment may minimize increase in the size of the camera device 10 due to the extension region 808.

In another embodiment, the extension region may be connected to any one of the second to fourth side portions 85B, 85C, and 85D of the first region 801 of the second board unit 800 or may protrude from any one of the second to fourth side portions 85B, 85C, and 85D of the first region 801.

The controller 830 may be located on the outer side of the cover member 300 or may be located outside the cover member 300. In an example, the controller 830 may be located outside the space defined by the cover member 300, the base 210, and the first region 801 of the second board unit 800.

In an example, the controller 830 does not overlap the lens module 400, the AF moving unit, the OIS moving unit, or the first region 801 of the second board unit 255 in the optical-axis direction. At least one capacitor 514 may be disposed or mounted on the upper surface of the extension region 808.

In a sensor shift camera device in which an image sensor moves in order to implement hand-tremor compensation, an OIS moving unit, which includes the image sensor and a first board unit, is disposed so as to be spaced apart from a fixed unit, which includes a second board unit. Therefore, heat generated from the OIS moving unit may not be effectively dissipated outside through the fixed unit. In addition, the sensor shift camera device may be structured such that the AF driving unit and the OIS driving unit are enveloped by the cover member in order to inhibit defects attributable to foreign matter, and thus heat may not be easily dissipated outside the camera device.

The image sensor, a second coil, and a controller may correspond to heat sources. Here, the “controller” may be a driver IC, which controls AF driving and/or OIS driving.

The camera device 10 may include a heat dissipation member 870, which is disposed in, coupled to, or attached to the extension region 808 in order to improve heat dissipation effect. The heat dissipation member 870 may be in contact with the extension region 808. In an example, the heat dissipation member 870 may be disposed beneath the extension region 808. In an example, the heat dissipation member 870 may be disposed on, coupled to, or fixed to the lower surface of the extension region 808. The heat dissipation member 870 may be a plate-type member, and the description of the material of the heat dissipation member 280 may be equally or similarly applied to the heat dissipation member 870. At least a portion of the heat dissipation member 870 may overlap the controller 830 in the optical-axis direction.

The camera device 10 may include a cover can 405, which is disposed in the extension region 808 and accommodates the controller 830 therein in order to protect the controller 830 from external impact. The cover can 405 may include an upper plate 405A and a side plate 405B connected to the upper plate 405A and extending from the upper plate 405A toward the extension region 808.

The cover can 405 may be disposed on, coupled to, or fixed to the upper surface of the extension region 808. In an example, the lower portion, lower end, or lower surface of the side plate 405B of the cover can 405 may be coupled, attached, or fixed to the upper surface of the extension region 808.

Since the cover can 405 accommodates the controller 830 therein, the cover can 405 may inhibit the heat generated from the controller 830 from being emitted to the outside of the cover can 405 and transferred to the image sensor. The description of the material of the heat dissipation member 280 or the material of the cover member 300 may be equally or similarly applied to the cover can 405.

The camera device 10 may further include a heat dissipation layer 860, which is disposed on the controller 830. The heat dissipation layer 860 may cover the surface of the controller 830. In an example, the heat dissipation layer 860 may be disposed so as to surround the surface of the controller 830. In an example, the heat dissipation layer 860 may be in contact with the upper surface and the side surface of the controller 830 and may surround the same. The heat dissipation layer 860 may be formed of heat dissipation plastic or heat dissipation resin, for example, heat dissipation epoxy. The heat dissipation layer 860 may improve the heat dissipation efficiency and the heat dissipation performance of the controller 830.

In another embodiment, the heat dissipation layer may be disposed on at least one of the upper surface or the side surface of the controller 830. In an example, the heat dissipation layer may expose at least a portion of the controller 830.

The controller 830 may be conductively connected to the second position sensor 240. The controller 830 may adjust or control a driving signal supplied to the second coil 230 using the output signals received from the sensors 240A, 240B, and 240C of the second position sensor 240 and the first data value stored in the memory 512, and may perform feedback OIS operation.

In addition, the controller 830 may be conductively connected to the first position sensor 170. For example, when the first position sensor 170 is implemented as a Hall sensor alone, the first position sensor 170 may be conductively connected to the controller 830. In this case, the controller 830 may control a driving signal supplied to the first coil 120 using the output signal from the first position sensor 170 and the second data value stored in the memory 512, and may perform feedback autofocus operation.

The controller 830 may be implemented in the form of a driver IC, but the disclosure is not limited thereto. In an example, the controller 830 may be conductively connected to the terminals 800B of the second board unit 800.

The controller 830 may control the first position sensor, which is implemented as a Hall sensor alone, and/or the second position sensor, which is implemented as a Hall sensor alone. In an example, the controller 830 may supply a driving signal to the first position sensor, which is implemented as a Hall sensor alone, and/or the second position sensor, which is implemented as a Hall sensor alone, and may receive an output signal from the first position sensor and/or an output signal from the second position sensor.

In another embodiment, the first position sensor may be implemented as a Hall sensor alone, and the second position sensor may be implemented in the form of a driver IC including a Hall sensor. In this case, the controller 830 may be conductively connected to the first position sensor, may supply a driving signal to the first position sensor, and may receive an output signal from the first position sensor.

In an example, the controller 830 may include a driver for driving at least one of the first position sensor or the second position sensor.

The image sensor unit 350 may further include a motion sensor (not shown), which is disposed on any one of the first board unit 255 and the second board unit 800. The motion sensor may be conductively connected to the controller 830. The motion sensor may output rotational angular speed information regarding movement of the camera device 10. The motion sensor may be implemented as, for example, a two-axis or three-axis gyro sensor or an angular speed sensor. In an example, the motion sensor may output information about the movement amount in the X-axis direction, the movement amount in the y-axis direction, and the rotation amount in response to movement of the camera device 10.

In another embodiment, the motion sensor may be omitted from the camera device 10. In the case in which the motion sensor is omitted from the camera device, the camera device 10 may receive position information from a motion sensor provided in the optical instrument 200A in response to movement of the camera device 10.

The image sensor unit 350 may further include a filter 610, which is disposed between the lens module 400 and the image sensor 810. In addition, the image sensor unit 350 may further include a filter holder 600, in which the filter is disposed, seated, or accommodated. The filter holder 600 may alternatively be referred to as a “sensor base”.

The filter 610 may serve to block or allow introduction of light within a specific frequency band, among the light that has passed through the lens barrel 400, into the image sensor 810. The filter 610 may be, for example, an infrared cut filter. In an example, the filter 610 may be disposed parallel to the xy-plane, which is perpendicular to the optical axis OA. The filter 610 may be disposed below the lens module 400.

The filter holder 600 may be disposed below the AF driving unit 100. In an example, the filter holder 600 may be disposed on the first board unit 255. In an example, the filter holder 600 may be disposed on the upper surface of the second circuit board 260 of the first board unit 255.

The filter holder 600 may be coupled to one region of the second circuit board 260 around the image sensor 810 by means of an adhesive, and may be exposed through the bore 250A in the first circuit board 250. In an example, the bore 250A in the first circuit board 250 may expose the filter holder 600 disposed on the second circuit board 260 and the filter 610 disposed on the filter holder 600. The filter holder 600 may include a bore 61A formed in a portion thereof, on which the filter 610 is mounted or disposed, in order to allow the light passing through the filter 610 to be introduced into the image sensor 810. The bore 61A in the filter holder 600 may be a through-hole formed through the filter holder 600 in the optical-axis direction. In an example, the bore 61A in the filter holder 600 may be formed through the center of the filter holder 600 and may be disposed so as to correspond to or oppose the image sensor 810.

The filter holder 600 may include a seating portion 500, which is depressed in the upper surface thereof to allow the filter 610 to be seated therein, and the filter 610 may be disposed, seated, or mounted in the seating portion 500. The seating portion 500 may be formed so as to surround the bore 61A. In another embodiment, the seating portion of the filter holder may take the form of a protruding portion protruding from the upper surface of the filter.

The image sensor unit 350 may further include an adhesive disposed between the filter 610 and the seating portion 500, and the filter 610 may be coupled or attached to the filter holder 600 by means of the adhesive.

In another embodiment, the filter holder may be coupled to the holder 270 or may be coupled to the AF driving unit 100.

Referring to FIG. 3, the cover member 300 may take the form of a box that has an open lower portion and includes an upper plate 301 and a side plate 302. The lower portion of the side plate 302 of the cover member 300 may be coupled to the base 210. The shape of the upper plate 301 of the cover member 300 may be a polygonal shape, for example, a quadrangular shape or an octagonal shape. In an example, the side plate 302 may include four side plates 302A to 302D connected to each other. The cover member 300 may include a bore 303 formed in the upper plate 301 thereof to expose the lens of the lens module 400 coupled to the bobbin 110 to external light.

Referring to FIGS. 1 and 3, the side plate 302 of the cover member 300 may have a recessed portion 304 formed therein to expose the terminal 95 of the circuit board 190 and the terminals 800B of the second board unit corresponding thereto.

In an example, the cover member 300 may be formed of a metallic material. For example, the cover member 300 may be formed of steel use stainless (SUS) (e.g., an SUS-4-based material). In addition, the cover member 300 may be formed of a steel plate cold commercial (SPC). For example, the cover member 300 may be formed of SUS containing an iron (Fe) component in an amount of 50 percent (%) or more. In addition, in an example, an oxidation-resistant metal, for example, nickel, may be plated on the surface of the cover member 300 in order to inhibit oxidation. In addition, in another embodiment, the cover member 300 may be formed of a magnetic material or a magnetic metallic material.

In still another embodiment, the cover member 300 may be formed of an injection-molded material, for example, plastic or resin. In addition, the cover member 300 may be made of an insulating material or a material capable of blocking electromagnetic waves.

The cover member 300 and the base 210 may accommodate the AF driving unit 100 and the OIS moving unit, may protect the AF driving unit 100 and the OIS moving unit from external impact, and may inhibit introduction of external foreign substances thereinto.

In an example, at the initial position of the OIS moving unit, the outer side surface of the holder 270 may be spaced apart from the inner side surface of the base 210 by a predetermined distance. In addition, in an example, at the initial position of the OIS moving unit, the lower surfaces of the holder 270 and the first board unit 255 may be spaced apart from the base 210 by a predetermined distance.

The controller 830 may supply at least one driving signal to at least one of the first to fourth coil units 230-1 to 230-4, and may control the at least one driving signal to move the OIS moving unit in the X-axis direction and/or the Y-axis direction or to rotate, tilt, or roll the OIS moving unit within a predetermined angular range about the optical axis.

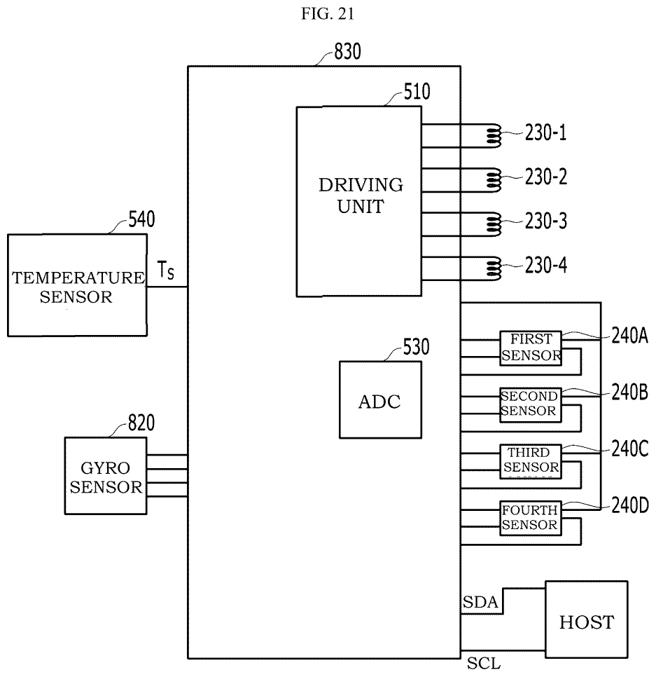

FIG. 21 is a block diagram showing the configuration of the controller 830 and the first to third sensors 240A, 240B, and 240C. The controller 830 may perform communication of transmitting and receiving data to and from a host using a clock signal SCL and a data signal SDA, for example, I2C communication. In an example, the host may be the controller 780 of the optical instrument 200A.

The controller 830 may be conductively connected to the second coil 230. The controller 830 may include a driving unit 510 for supplying a driving signal required to drive the first to fourth coil units 230-1 to 230-4. In an example, the driving unit 510 may include an H bridge circuit or an H bridge driver capable of changing the polarity of the driving signal. In this case, the driving signal may be a PWM signal in order to reduce consumption of current, and the driving frequency of the PWM signal may be 20 kHz or more, which is outside of the audible frequency band. In another embodiment, the driving signal may be a direct current signal.

Each of the first to third sensors 240A to 240C may include two input terminals and two output terminals. The controller 830 may supply power or a driving signal to two input terminals of each of the first to third sensors 240A to 240C. In an example, any one of the two input terminals of each of the first to third sensors 240A to 240C may be commonly connected. In an example, the two input terminals may be a (+) input terminal and a (−) input terminal (e.g., ground terminal).

In an example, the controller 830 may receive a first output voltage from the first sensor 240A, a second output voltage from the second sensor 240B, and a third output voltage from the third sensor 240C, and may control movement (or displacement) of the OIS moving unit in the X-axis direction or the Y-axis direction using the received first to third output voltages. In addition, the controller 830 may control rotation, tilting, or rolling of the OIS moving unit about the optical axis using the received first to third output voltages.

In addition, the controller 830 may include an analog-to-digital converter 530, which receives output voltage from the two output terminals of each of the first to third sensors 240A to 240C and outputs a data value, a digital value, or a code value corresponding to a result of the analog-to-digital conversion of the received output voltage. The controller 830 may control movement (or displacement) of the OIS moving unit in the X-axis direction or the Y-axis direction and rotation, tilting, or rolling of the OIS moving unit about the optical axis using the data values output from the analog-to-digital converter 530.

A temperature sensor 540 may measure the ambient temperature (e.g., the temperature of each of the first to third sensors 240A, 240B, and 240C), and may output a temperature detection signal Ts corresponding to a result of the measurement. The temperature sensor 540 may be, for example, a thermistor.

The resistance value of a resistor included in the temperature sensor 540 may vary depending on changes in the ambient temperature, and accordingly, the value of the temperature detection signal Ts may vary depending on changes in the ambient temperature. An equation or a look-up table relating to the relationship between the ambient temperature and the temperature detection signal Ts may be stored in the memory or the controller 830 or 780 through calibration.

Because the output values from the first to third sensors 240A, 240B, and 240C are also influenced by temperature, it is necessary to compensate for the output values from the first to third sensors 240A, 240B, and 240C according to the ambient temperature in order to accurately and reliably implement OIS feedback driving.

To this end, in an example, the controller 830 or 780 may compensate for the output value (or the data value corresponding to output) from each of the first to third sensors 240A, 240B, and 240C using the ambient temperature measured by the temperature sensor 540 and a temperature compensation algorithm or compensation equation. The temperature compensation algorithm or compensation equation may be stored in the controller 830 or 780 or the memory.

The camera device may further include a fourth sensor 240D, which corresponds to or opposes the fourth magnet unit 130-4 in the optical-axis direction. The fourth sensor 240D may be disposed on the first board unit 255 (e.g., the first circuit board 250). In an example, the fourth sensor 240D may be disposed adjacent to any one corner of the first circuit board 250, on which the first to third sensors 240A to 240C are not disposed. The description of the placement relationship between the first sensor 240A and the first coil unit 230-1 may be equally or similarly applied to the placement relationship between the fourth sensor 240D and the fourth coil unit 230-4.

In an example, the fourth sensor 240D may be located so as to oppose the second sensor 240B in a diagonal direction. In an example, the output voltage from the fourth sensor 240D may be used to detect movement of the OIS moving unit in the X-axis direction or the Y-axis direction.

In another embodiment, the fourth sensor 240D may correspond to the first position sensor 170 of the AF driving unit 100.

The controller 830 may be conductively connected to at least one of the first position sensor 170, the second coil 230, or the second position sensor 240 via the second board unit 800, the support board 310, and the first board unit 255.

In another embodiment, the controller 830 may be disposed on the first board unit 255. In another embodiment, the controller 830 may be disposed on the first circuit board 250.

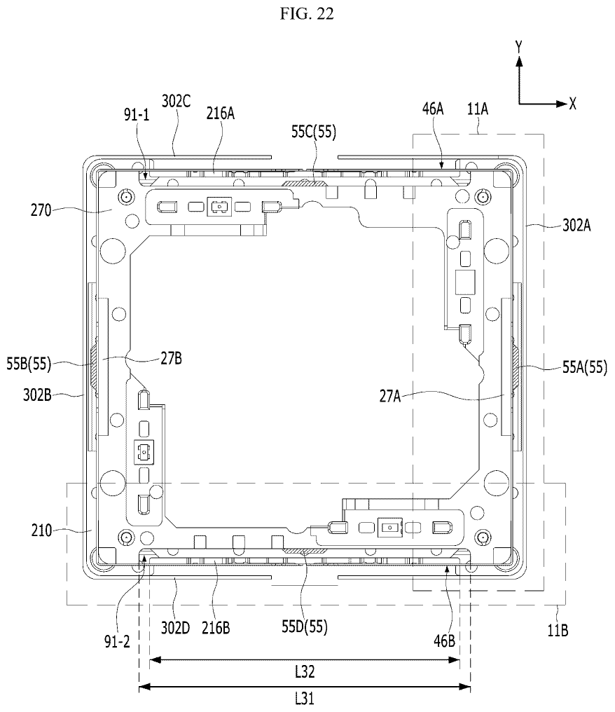

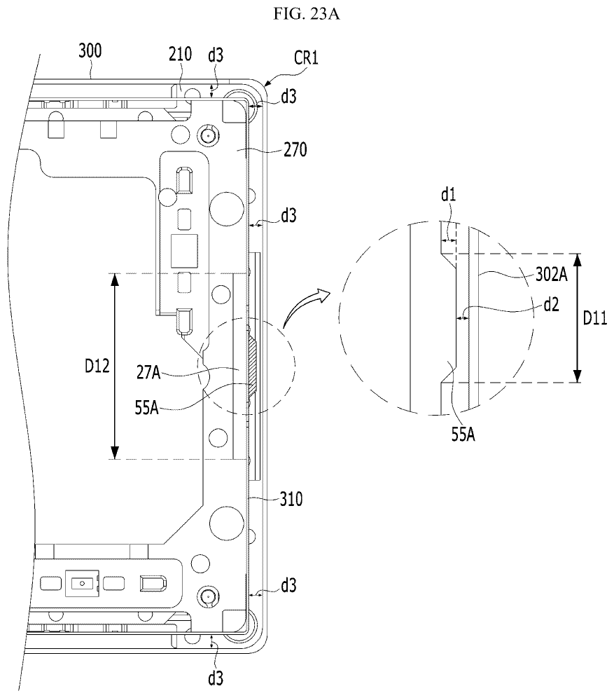

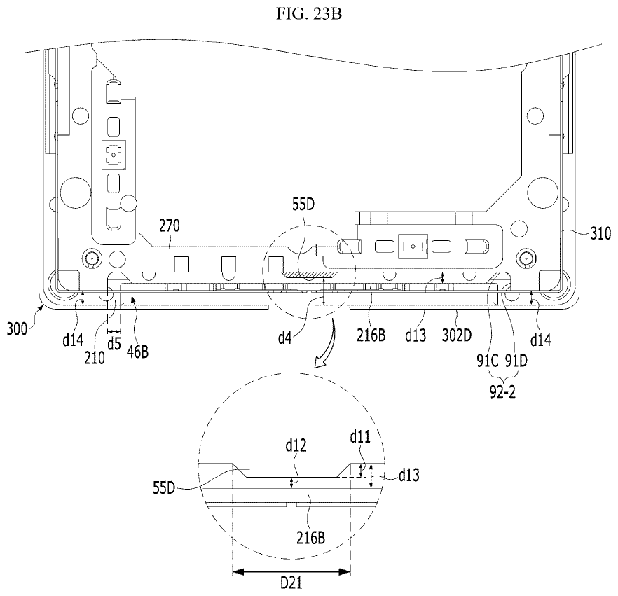

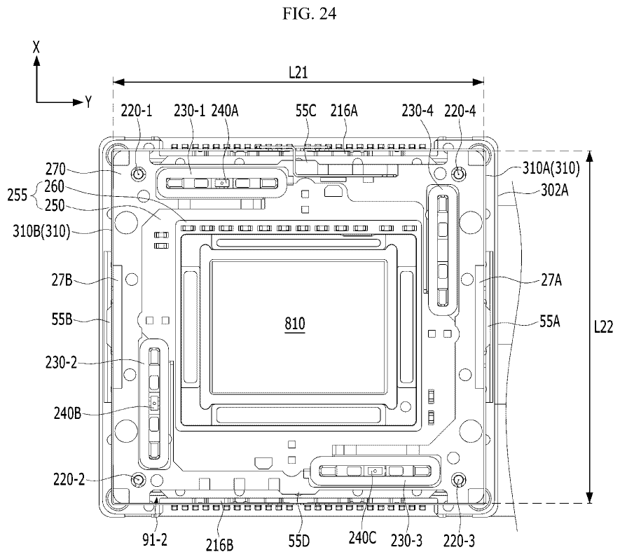

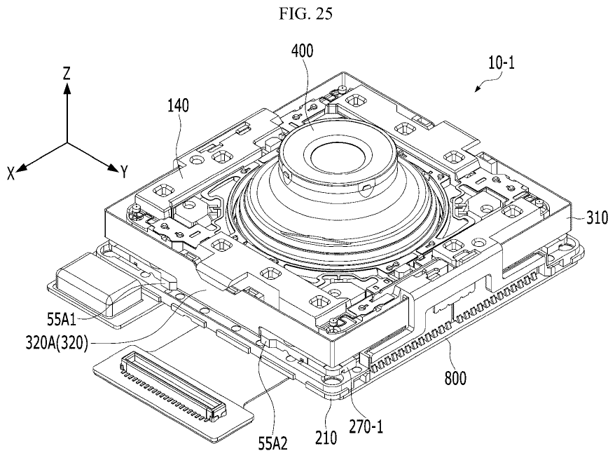

FIG. 22 is a plan view of the holder 270, the base 210, and the cover member 300, FIG. 23A is an enlarged view of a first dotted line portion 11A in FIG. 22, FIG. 23B is an enlarged view of a second dotted line portion 11B in FIG. 22, and FIG. 24 is a cross-sectional view of the image sensor unit 350 and the cover member 300 in a direction perpendicular to the optical axis.

Referring to FIGS. 22 to 24, the holder 270 may include recesses 91-1 and 91-2 or depressed portions, which correspond to, oppose, or overlap the accommodation portions 46A and 46B of the base 210. The recesses 91-1 and 91-2 may be depressed in the outer side surfaces of the side portions 57C and 57D of the holder 270.

In an example, the holder 270 may include a first recess 91-1 depressed in the third side portion 57C and a second recess 91-2 depressed in the fourth side portion.

Referring to FIG. 12A, in an example, the first recess 91-1 may include a bottom surface 91A, which has a step with the outer side surface of the third side portion 57C of the holder 270, and a side surface 91B, which is disposed between the bottom surface 91A and the outer side surface of the third side portion 57C. In an example, the bottom surface 91A may be located closer to the optical axis OA than the outer side surface of the third side portion 57C. In an example, the second recess 91-2 may include a bottom surface 91C, which has a step with the outer side surface of the fourth side portion 57D of the holder 270, and a side surface 91D, which is disposed between the bottom surface 91C and the outer side surface of the fourth side portion 57D. In an example, the bottom surface 91C may be located closer to the optical axis OA than the outer side surface of the fourth side portion 57D.

In an example, a distance between the bottom surface 91A or 91C of the holder 270 and the outer side surface of the side portion 57C or 57D of the holder 270 may be greater than or equal to a distance between the bottom surface of the recess 46A or 46B in the base 210 and the outer side surface of the base 210. In another embodiment, the former may be less than the latter.

In an example, the first recess 91-1 in the holder 270 may correspond to, oppose, or overlap the first recess 46A in the base 210, and the second recess 91-2 in the holder 270 may correspond to, oppose, or overlap the second recess 46B in the base 210. The reason for forming the first and second recesses 91-1 and 91-2 in the holder 270 is to avoid spatial interference with the first and second recesses 46A and 46B in the base 210 and to secure a space for movement of the OIS moving unit in a direction perpendicular to the optical axis or rolling of the moving unit in accordance with OIS driving.

In an example, the length L21 of the holder 270 in the second horizontal direction (e.g., the X-axis direction) may be greater than the length L22 of the holder 270 in the first horizontal direction (e.g., the Y-axis direction). For example, L21 may be a distance from the outer side surface of the first side portion 57A of the holder 270 to the outer side surface of the second side portion 57B, and L22 may be a distance from the outer side surface of the third side portion 57C of the holder 270 to the outer side surface of the fourth side portion 57D.

In another embodiment, L21 and L22 may be equal to each other. In addition, the length of the image sensor 810 in the second horizontal direction (e.g., the X-axis direction) may be greater than the length of the image sensor 810 in the first horizontal direction (e.g., the Y-axis direction). In another embodiment, the length of the image sensor 810 in the second horizontal direction (e.g., the X-axis direction) may be equal to or less than the length of the image sensor 810 in the first horizontal direction (e.g., the Y-axis direction).

The holder 260 may include a stopper (or protruding portion) 55 protruding in a direction perpendicular to the optical axis. In another embodiment, the stopper 55 may alternatively be referred to as a “protrusion” or a “protruding portion”.

In an example, the stopper 55 may protrude from the outer side surface of the holder 260. In an example, the stopper 55 may protrude from the side portions 57A to 57D of the holder 260. In an example, the stopper 55 may protrude from the outer side surfaces of the side portions 57A to 57D of the holder 260. In an example, the holder 260 may include stoppers 55A and 55B protruding toward the side plate 302 of the cover member 300. In an example, the stoppers 55A and 55B may protrude toward the inner side surface of the side plate 302 of the cover member 300. In an example, the holder 270 may include stoppers 55C and 55D protruding toward the protruding portions 216A and 216B of the base 210. In an example, the stoppers 55C and 55D may protrude toward the inner side surfaces of the protruding portions 216A and 216B of the base 210. The holder 270 may include at least one of the stoppers 55A to 55D.

In an example, the stopper 55 may include a first stopper 55A protruding from the first side portion 57A of the holder 270. In an example, the first stopper 55A may protrude from the second side portion 57B of the holder 270 toward the first side portion 57A.

In an example, the stopper 55 may include a second stopper 55B protruding from the second side portion 57B of the holder 270. In an example, the second stopper 55B may protrude from the first side portion 57A of the holder 270 toward the second side portion 57B. The first stopper 55A and the second stopper 55B may protrude or extend in opposite directions.

In an example, the first stopper 55A may be disposed adjacent to the first protruding portion 27A of the holder 270, and the second stopper 55B may be disposed adjacent to the second protruding portion 27B of the holder 270. In an example, the first stopper 55A may be disposed below the first protruding portion 27A of the holder 270. In an example, the second stopper 55B may be disposed below the second protruding portion 27B of the holder 270.

In an example, the stoppers 55A to 55D may be disposed closer to the centers or the central regions of the side portions 57A to 57D of the holder 270 than to the corner portions CR1 to CR4 of the holder 270.

In an example, the first stopper 55A may be disposed at a position corresponding to, opposing, or overlapping the center or the central region of the first side portion 57A of the holder 270. In an example, the first stopper 55A may be disposed at a position corresponding to, opposing, or overlapping the center or the central region of the first protruding portion 27A of the holder 270.

In an example, the second stopper 55B may be disposed at a position corresponding to, opposing, or overlapping the center or the central region of the second side portion 57B of the holder 270. In an example, the second stopper 55B may be disposed at a position corresponding to, opposing, or overlapping the center or the central region of the second protruding portion 27B of the holder 270.

In an example, on the assumption that the center of the first side portion 57A (or the second side portion 57B) of the holder 270 is a point corresponding to 50% of the overall length of the first side portion 57A (or the second side portion 57B), the first stopper 55A (or the second stopper 55B) may be disposed within a region between points corresponding to 10% and 90% of the overall length of the first side portion 57A (or the second side portion 57B). Alternatively, in an example, the first stopper 55A (or the second stopper 55B) may be disposed within a region between points corresponding to 25% and 75% of the length of the first side portion 57A (or the second side portion 57B) of the holder 270. Alternatively, in an example, the first stopper 55A (or the second stopper 55B) may be disposed within a region between points corresponding to 35% and 65% of the length of the first side portion 57A (or the second side portion 57B) of the holder 270.

In another embodiment, a portion corresponding to 50% or greater of the overall length D11 of the first stopper 55A (or the second stopper 55B) may be disposed with a region between points corresponding to 35% and 65% of the first side portion 57A (or the second side portion 57B) of the holder 270.

Each of the first stopper 55A and the second stopper 55B is illustrated in FIGS. 12A and 22 as being embodied as a single stopper. However, in another embodiment, each of the first stopper and the second stopper may include a plurality of stoppers spaced apart from each other. In another embodiment, the support board 310 may include a plurality of holes or through-holes formed therein so as to correspond to the plurality of stoppers, and the plurality of holes may be formed in the connection portion 320 of the support board 310. Each of the plurality of stoppers may pass through a corresponding one of the plurality of holes in the support board 310 and may protrude from the support board 310.

Referring to FIG. 22, the first stopper 55A may protrude toward the first side plate 302A of the cover member 300, and the second stopper 55B may protrude toward the second side plate 302B of the cover member 300. At the initial position of the OIS moving unit, the stoppers 55A and 55B may be spaced apart from the side plates 302A and 302B of the cover member 300. The reason for this is to perform OIS operation through movement of the OIS moving unit.

Referring to FIGS. 17A and 17B, at least a portion of each of the stoppers 55A and 55B may penetrate at least a portion of the support board 310. In an example, the stoppers 55A and 55B may protrude in a direction perpendicular to the optical axis OA with respect to the support board 310. In an example, the stoppers 55A and 55B may penetrate at least part of the connection portion 320 of the support board 310. In an example, the connection portion 320 of the support board 310 may include an opening 320-1 formed therein to allow at least a portion of each of the stoppers 55A and 55B to pass therethrough. For example, the opening 320-1 may be a hole, a bore, or a through-hole.

Because the opening 320-1 in the connection portion 320 of the support board 310 is coupled to the stoppers 55A and 55B of the holder 270, the stoppers 55A and 55B may serve as a guide for coupling between the support board 310 and the holder 270. In another embodiment, the stoppers 55A and 55B may alternatively be referred to as “protrusions” or “guide protrusions”.

In an example, distal ends or leading ends of the stoppers 55A and 55B may be located closer to the side plate 302 of the cover member 300 than to the support board 310 (or the holder 270).

Referring to FIG. 23A, in an example, the distance d2 between the stoppers 55A and 55B and the side plate 302A of the cover member 300 may be less than the distance d1 between the support board 310 (or the holder (270)) and the side plate 302A of the cover member 300 (d2<d3).

For example, d2 may be the shortest distance between the stoppers 55A and 55B and the side plate 302A of the cover member 300. For example, d3 may be the shortest distance between the support board 310 (or the holder 270) and the side plate 302A of the cover member 300.

In an example, the protruding length d1 of the stoppers 55A and 55B protruding from the outer side surfaces of the side portions 57A to 57D of the holder 270 may be greater than the distance d2 between the stoppers 55A and 55B and the side plate 302A of the cover member 300 (d1>d2). Because d1 is greater than d2, the stoppers 55A and 55B may stably protect the holder 270 from external impact.

In addition, in an example, the protruding length of the stoppers 55A and 55B may be greater than d2 with respect to the bodies 86 and 87 of the support board 310. In another embodiment, the protruding length of the stoppers 55A and 55B may be equal to or less than the distance d2 between the stoppers 55A and 55B and the side plate 302A of the cover member 300.

In an example, the distance d2 between the stoppers 55A and 55B and the side plate 302A of the cover member 300 may be less than the distance d3 between the side portions 57A to 57D of the holder 270 and the side plate 302A of the cover member 300 (d2<d3).

For example, d2 may be a distance between an end of each of the stoppers 55A and 55B and the inner side surface of the side plate 302A of the cover member 300.

For example, d3 may be a distance between the side portions 57A to 57D (or the outer side surfaces of the side portions 57A to 57D) of the holder 270 and the side plate 302 (or the inner side surface of the side plate 302) of the cover member 300. For example, d3 may be a distance between the corner portions CR1 to CR4 (or the outer side surfaces of the corner portions CR1 to CR4) of the holder 270 and the side plate 302 (or the inner side surface of the side plate 302) of the cover member 300. For example, d3 may mean the shortest distance.

In an example, the distance between the side portions 57A to 57D (or the outer side surfaces of the side portions 57A to 57D) of the holder 270 and the side plate 302 (or the inner side surface of the side plate 302) of the cover member 300 and the distance between the corner portions CR1 to CR4 (or the outer side surfaces of the corner portions CR1 to CR4) of the holder 270 and the side plate 302 (or the inner side surface of the side plate 302) of the cover member 300 may be equal to each other. In another embodiment, the former may be less than the latter. In still another embodiment, the former may be greater than the latter.

The length D11 of the stoppers 55A and 55B in the first horizontal direction (e.g., the Y-axis direction) or a direction parallel to the outer side surfaces of the side portions 57A and 57B may be less than the length D12 of the protruding portions 27A and 27B of the holder 270 in the first horizontal direction (e.g., the Y-axis direction) or a direction parallel to the outer side surfaces of the side portions 57A and 57B (D11 <D12). In another embodiment, D11 may be equal to D12. D11 may be 10% to 50% of the length L22 of the holder 270 in the first horizontal direction (e.g., the Y-axis direction) or a direction parallel to the outer side surfaces of the side portions 57A and 57B. In another embodiment, D11 may be 10% to 30% of L22. In still another embodiment, D11 may be 13% to 20% of L22. If D11 is less than 10% of L22, the stoppers 55A and 55B may not stably protect the holder 270 from external impact, whereby the holder 270 may be broken or damaged due to the external impact. Further, if D11 exceeds 50% of L22, it may be difficult to avoid spatial interference with another component, for example, the support board 310, freedom of design of the camera device may be lowered, and the weight of the moving unit may increase, thus increasing power consumption.

The description given with reference to FIG. 23A may be equally or similarly applied to both the first stopper 55A and the second stopper 55B.

Referring to FIGS. 22 and 23B, in an example, the stopper 55 may include a third stopper 55C protruding from the third side portion 57C of the holder 270. In an example, the third stopper 55C may protrude from the fourth side portion 57D of the holder 270 toward the third side portion 57C.

In an example, the stopper 55 may include a fourth stopper 55D protruding from the fourth side portion 57D of the holder 270. In an example, the fourth stopper 55D may protrude from the third side portion 57C of the holder 270 toward the fourth side portion 57D. The third stopper 55C and the fourth stopper 55D may protrude or extend in opposite directions.

In an example, the third stopper 55C may be disposed in the first recess 91-1 in the holder 270. The fourth stopper 55D may be disposed in the second recess 91-2 in the holder 270. In an example, the third stopper 55C may protrude from the bottom surface 91A of the first recess 91-1 in the holder 270. In an example, the fourth stopper 55D may protrude from the bottom surface of the second recess 91-2 in the holder 270.

In an example, the third stopper 55C may not protrude from the outer side surface of the third side portion 57C of the holder 270. In an example, the third stopper 55C may not protrude outside the first recess 91-1 in the holder 270. In an example, the fourth stopper 55D may not protrude from the outer side surface of the fourth side portion 57D of the holder 270. In an example, the fourth stopper 55D may not protrude outside the second recess 91-2 in the holder 270.

In an example, the protruding length d11 of the third stopper 55C may be less than the distance from the outer side surface of the third side portion 57C of the holder 270 to the bottom surface 91A of the first recess 91-1. In an example, the protruding length d11 of the fourth stopper 55D may be less than the distance from the outer side surface of the fourth side portion of the holder 270 to the bottom surface 91C of the second recess 91-2.

In an example, the third stopper 55C may be disposed so as to correspond to, oppose, or overlap the first protruding portion 216A of the base 210 in a direction perpendicular to the optical axis, for example, the first horizontal direction (e.g., the Y-axis direction). In an example, the fourth stopper 55D may be disposed so as to correspond to, oppose, or overlap the second protruding portion 216B of the base 210 in a direction perpendicular to the optical axis, for example, the first horizontal direction (e.g., the Y-axis direction).

In an example, the third stopper 55C may be disposed at a position corresponding to, opposing, or overlapping the center or the central region of the third side portion 57C of the holder 270, and the fourth stopper 55D may be disposed at a position corresponding to, opposing, or overlapping the center or the central region of the fourth side portion 57D of the holder 270.

In an example, the third stopper 55C may be disposed at a position corresponding to, opposing, or overlapping the center or the central region of the bottom surface 91A of the first recess 91-1 in the holder 270, and the fourth stopper 55D may be disposed at a position corresponding to, opposing, or overlapping the center or the central region of the bottom surface 91C of the second recess 91-2 in the holder 270.

In an example, on the assumption that the center of the third side portion 57C (or the fourth side portion 57D) of the holder 270 is a point corresponding to 50% of the third side portion 57C (or the fourth side portion 57D), the third stopper 55C (or the fourth stopper 55D) may be disposed within a region between points corresponding to 10% and 90% of the third side portion 57C (or the fourth side portion 57D). Alternatively, in an example, the third stopper 55C (or the fourth stopper 55D) may be disposed within a region between points corresponding to 25% and 75% of the third side portion 57C (or the fourth side portion 57D) of the holder 270. Alternatively, in an example, the third stopper 55C (or the fourth stopper 55D) may be disposed within a region between points corresponding to 35% and 65% of the third side portion 57C (or the fourth side portion 57D) of the holder 270.

In another embodiment, a portion corresponding to 50% or greater of the overall length D21 of the third stopper 55C (or the fourth stopper 55D) may be disposed with a region between points corresponding to 35% and 65% of the third side portion 57C (or the fourth side portion 57D) of the holder 270.

Each of the third stopper 55C and the fourth stopper 55D is illustrated in FIGS. 12A and 22 as being embodied as a single stopper. However, in another embodiment, each of the third stopper and the fourth stopper of the holder may include a plurality of stoppers spaced apart from each other.

Referring to FIG. 22, the third stopper 55C may protrude toward the third side plate 302C of the cover member 300, and the fourth stopper 55D may protrude toward the fourth side plate 302D of the cover member 300.

At the initial position of the OIS moving unit, the stoppers 55C and 55D may be spaced apart from the base 210. In an example, at the initial position of the OIS moving unit, the stoppers 55C and 55D may be spaced apart from the protruding portions 216A and 216B of the base 210. The reason for this is to perform OIS operation through movement of the OIS moving unit.

In an example, distal ends or leading ends of the stoppers 55C and 55D may be located closer to the protruding portions 216A and 216B of the base 210 than to the bottom surfaces 91A and 91C of the recesses 91-1 and 91-2 in the holder 270. In an example, distal ends or leading ends of the stoppers 55C and 55D may be located closer to the side plates 302C and 302D of the cover member 300 than to the bottom surfaces 91A and 91C of the recesses 91-1 and 91-2 in the holder 270.

Referring to FIG. 23B, in an example, the distance d12 between the stoppers 55C and 55D and the protruding portions 216A and 216B of the base 210 may be less than the distance d13 between the bottom surfaces 91A and 91C of the recesses 91-1 and 91-2 in the holder 270 and the protruding portions 216A and 216B of the base 210 (d12<d13).

For example, d12 may be the shortest distance between the stoppers 55C and 55D and the protruding portions 216A and 216B of the base 210. For example, d13 may be the shortest distance between the bottom surfaces 91A and 91C of the recesses 91-1 and 91-2 in the holder 270 and the protruding portions 216A and 216B of the base 210.

In an example, the protruding length d11 of the stoppers 55C and 55D protruding from the bottom surfaces 91A and 91C of the recesses 91-1 and 91-2 in the holder 270 may be greater than the distance d12 between the stoppers 55C and 55D and the protruding portions 216A and 216B of the base 210 (d11>d12). Because d11 is greater than d12, the stoppers 55C and 55D may stably protect the holder 270 from external impact. In another embodiment, the protruding length of the stoppers 55C and 55D may be equal to or less than the distance d12 between the stoppers 55C and 55D and the protruding portions 216A and 216B of the base 210.

Referring to FIG. 24, when viewed from above, the stoppers 55C and 55D may be located closer to the optical axis than the support board 310. In an example, when viewed from above, distal ends of the stoppers 55C and 55D may be located inside the bodies 86 and 87 of the support board 310.

In an example, the distance d12 between the stoppers 55C and 55D and the protruding portions 216A and 216B of the base 210 may be less than the distance d13 between the bottom surfaces 91A and 91B of the recesses 91-1 and 91-2 in the holder 270 and the protruding portions 216A and 216B of the base 210 (d12<d13).

For example, d12 may be the distance between the distal ends of the stoppers 55C and 55D and the inner side surfaces of the protruding portions 216A and 216B of the base 210.

For example, d13 may be the distance between the bottom surfaces 91A and 91C of the recesses 91-1 and 91-2 in the holder 270 and the protruding portions 216A and 216B (or the inner side surfaces of the protruding portions 216A and 216B) of the base 210.

The distance d5 between the side surfaces 91B and 91D of the recesses 91-1 and 91-2 in the holder 270 and the protruding portions 216A and 216B of the base 210 may be equal to or greater than d13. In another embodiment, d5 may be less than d13.

In an example, the distance d14 between the side portions 57C and 57D (or the outer side surfaces of the side portions 57C and 57D) of the holder 270 and the side plates 302C and 302D of the cover member 300 may be equal to d13. In another embodiment, d13 may be less than d14. In still another embodiment, d13 may be greater than d14. For example, d14 may be the shortest distance between the side portions 57C and 57D (or the outer side surfaces of the side portions 57C and 57D) of the holder 270 and the side plates 302C and 302D of the cover member 300.

Referring to FIG. 22, the length L31 of the recesses 91-1 and 91-2 in the holder 270 in a direction parallel to the side portions 57C and 57D of the holder may be greater than the length L32 of the accommodation portions 46A and 46B of the base 210 in a direction parallel to the outer side surfaces of the side portions 57C and 57D of the holder 270 (L31>L32).

In an example, when viewed from above, at the initial position of the OIS moving unit, at least parts of the accommodation portions 46A and 46B of the base 210 may be located in the recesses 91-1 and 91-2 in the holder 270.

In an example, when viewed from above, at the initial position of the OIS moving unit, at least parts of the accommodation portions 46A and 46B of the base 210 may overlap the recesses 91-1 and 91-2 in the holder 270 in a direction parallel to the outer side surfaces of the side portions 57C and 57D of the holder 270 or the second horizontal direction (the X-axis direction).

The length D21 of the stoppers 55C and 55D in the second horizontal direction (e.g., the X-axis direction) or a direction parallel to the outer side surfaces of the side portions 57C and 57D of the holder 270 may be less than the length D22 of the recesses 91-1 and 91-2 in the holder 270 in the second horizontal direction (e.g., the X-axis direction) or a direction parallel to the outer side surfaces of the side portions 57C and 57D of the holder 270 (D21 <D22). In another embodiment, D21 may be equal to D22.

D21 may be 8% to 50% of the length L21 of the holder 270 in the second horizontal direction (e.g., the X-axis direction) or a direction parallel to the outer side surfaces of the side portions 57C and 57D. In another embodiment, D21 may be 10% to 25% of L21. In still another embodiment, D21 may be 10% to 20% of L21. If D21 is less than 8% of L21, the stoppers 55C and 55D may not stably protect the holder 270 from external impact, whereby the holder 270 may be broken or damaged due to the external impact. Further, if D21 exceeds 50% of L21, freedom of design of the camera device may be lowered, and the weight of the moving unit may increase, thus increasing power consumption.

The description given with reference to FIG. 23B may be equally or similarly applied to both the third stopper 55C and the fourth stopper 55D.

The distance d2 between the stoppers 55A and 55B of the holder 270 and the side plates 302A and 302B of the cover member 300 may be different from the distance d4 between the stoppers 55C and 55D of the holder 270 and the side plates 302C and 302D of the cover member 300.

In an example, the distance d2 between the stoppers 55A and 55B of the holder 270 and the side plates 302A and 302B of the cover member 300 may be less than the distance d4 between the stoppers 55C and 55D of the holder 270 and the side plates 302C and 302D of the cover member 300 (d2<d4). In another embodiment, d2 may be equal to or greater than d4.

For example, the shape of the stopper 55 may be a polyhedral shape, a semicircular shape, or a semi-elliptical shape. For example, when viewed from above, the shape of the stopper 55 may be a trapezoidal shape. In another embodiment, when viewed from above, the shape of the stopper 55 may be a quadrangular shape.

In an example, each of the stoppers (e.g., 55A to 55D) may include a portion that is gradually reduced in length in the protruding direction thereof. For example, the length of the stoppers (e.g., 55A to 55D) may be a length in a direction parallel to the outer side surface of the side portion (e.g., 57A) of the holder 270.

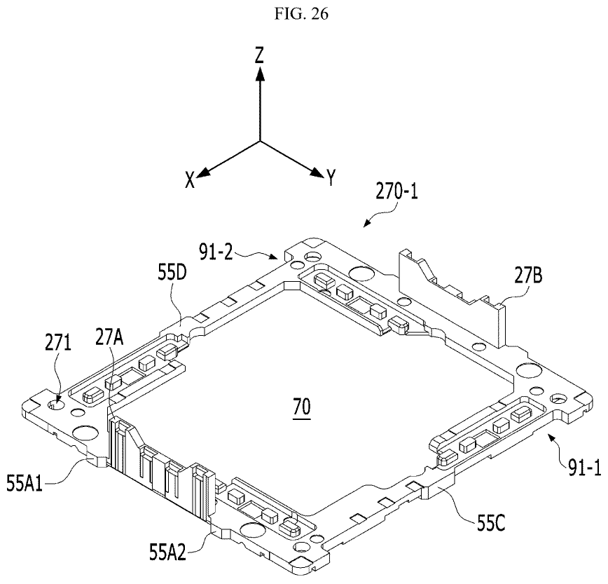

FIG. 25 is a perspective view of a camera device 10-1 according to another embodiment, and FIG. 26 is a perspective view of a holder 270-1 of the camera device 10-1 shown in FIG. 25.

In the embodiment shown in FIGS. 25 and 26, the position and shape of first and second stoppers 55A1 and 55A2 of the holder 270-1 may be different from those of the stopper 55A shown in FIG. 12A.

In an example, the holder 270-1 may include stoppers 55A and 55B, each of which is formed on at least one of one side or the other side of a respective one of the protruding portions 27A and 27B. In an example, the stoppers 55A1 and 55A2 may be disposed on both sides of each of the protruding portions 27A and 27B so as to avoid spatial interference with the connection portion 320 of the support board 310. The stoppers 55A1 and 55A2 of the holder 270-1 shown in FIG. 25 may not penetrate the support board 310.

In an example, the holder 270-1 may include a first stopper 55A1 (or a “first protrusion”), which is located on one side of the connection portion 320 of the support board 310 and protrudes relative to the connection portion 320. In an example, the holder 270-1 may include a second stopper 55A2 (or a “second protrusion”), which is located on one side of the connection portion 320 of the support board 310 and protrudes relative to the connection portion 320.

In an example, at least one of the first and second stoppers 55A1 and 55A2 may be in contact with the protruding portions 27A and 27B of the holder 270-1. In another embodiment, at least one of the first and second stoppers 55A1 and 55A2 may be spaced apart from the protruding portions 27A and 27B of the holder 270-1.

The description of the first and second stoppers 55A and 55B shown in FIGS. 12A and 22 to 24 may be equally or similarly applied to the stoppers 55A1 and 55A2 shown in FIGS. 25 and 26.

In order to implement movement of the OIS moving unit in a direction perpendicular to the optical axis or rolling of the OIS moving unit about the optical axis, a space or a gap is required between the OIS moving unit and the fixed unit (e.g., the cover member and the base).

In the camera device, the holder of the OIS moving unit or the components coupled to the holder (the circuit board, the OIS coil, and the position sensor) may be damaged or broken due to impact. Such damage or breakage may deteriorate the performance of the camera device or may cause malfunction of the camera device.

The embodiment includes the stopper 55 in order to inhibit the holder of the OIS moving unit or the components coupled to the holder from being damaged due to external impact. The stopper 55 according to the embodiment may be located at the center or the central region of each of the side portions 57A to 57D of the holder 270.

In the camera device 10 according to the embodiment, the distance d13 or d14 between the holder 270 (or the support board 310) and the side plate 302 of the cover member 300 may be a value obtained by summing the movement distance of the OIS moving unit along the X-axis (or the Y-axis), the movement distance of the OIS moving unit during rolling thereof, and the other processing and assembly offset.

For example, the OIS movement distance during shift operation in the X-axis and Y-axis directions for 1-degree correction may be 0.12 mm, the movement distance of the OIS moving unit during rolling operation for 1-degree correction (i.e., the movement distance in the X-axis and Y-axis directions) may be 0.02 mm, and the other processing and assembly offset may be 0.1 mm.

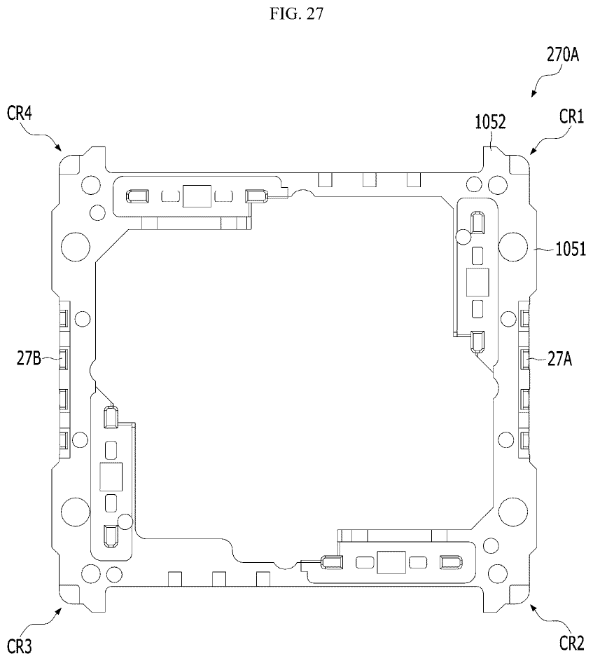

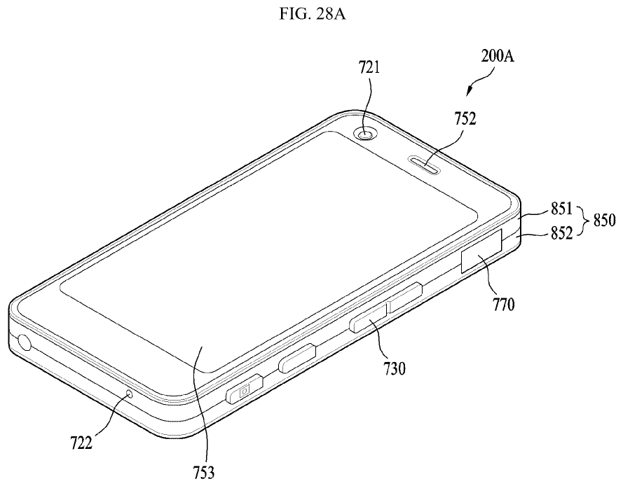

FIG. 27 is a perspective view of a holder 270A according to another embodiment.

Referring to FIG. 27, the holder 270A according to another embodiment (hereinafter referred to as a “comparative example”) may include stoppers 1051 and 1052 disposed adjacent to corner regions CR1 to CR4 of the holder 270A.

The stoppers 1051 and 1052 may be disposed closer to the corner regions CR1 to CR4 of the holder 270A than to the centers of the side portions of the holder 270A. In an example, at least portions of the stoppers 1052 and 1051 may be disposed in the corner regions of the holder 270A. Alternatively, in an example, the stoppers 1051 and 1052 may be disposed in contact with or adjacent to the corner regions of the holder 270A.

In the comparative example, the OIS movement distance during shift operation in the X-axis and Y-axis directions for 1-degree correction may be 0.12 mm, the movement distance of the OIS moving unit during rolling operation for 1-degree correction may be 0.16 mm, and the other processing and assembly offset may be 0.1 mm.

Compared to the comparative example, the embodiment is structured such that the stopper 55 is disposed in the central region of the side portion of the holder 270 and is located closer to the center of the holder 270 than to the corner portion of the holder 270. Accordingly, during the rolling operation of the OIS moving unit for 1-degree correction, the movement distance of the OIS moving unit in the embodiment may be less than that in the comparative example. Therefore, in the embodiment shown in FIGS. 22 to 26, during the rolling operation of the OIS moving unit for 1-degree correction, the movement distance of the OIS moving unit may be reduced to 0.14 mm. That is, the embodiment may reduce a spacing distance (hereinafter referred to as a “gap” or an “air gap”), which is necessary for OIS operation, between the OIS moving unit (e.g., the holder 270 or the support board 310) and the fixed unit (e.g., the side plate of the cover member 300), compared to the comparative example.

As described above, according to the embodiment, the gap (or the air gap), which is necessary for OIS operation, between the OIS moving unit (e.g., the holder 270 or the support board 310) and the fixed unit (e.g., the side plate of the cover member 300) may be reduced.

According to a drop experiment of the camera device, the fixed unit of the camera device, for example, the cover member and the base, first stop upon collision with the collision surface (e.g., the ground or the floor), and the OIS moving unit falls further by the gap (or the air gap) and then collides with the fixed unit of the camera device.

Compared to the comparative example, the embodiment may obtain an impulse reduction effect of about 20% by reducing the gap (or the air gap), thereby inhibiting the OIS moving unit of the camera device 10 from being damaged or broken due to impact or collision.

In addition, the camera device according to the embodiment may be included in an optical instrument for the purpose of forming an image of an object present in a space using reflection, refraction, absorption, interference, and diffraction, which are characteristics of light, for the purpose of increasing visibility, for the purpose of recording and reproduction of an image using a lens, or for the purpose of optical measurement or image propagation or transmission. For example, the optical instrument according to the embodiment may be a cellular phone, a mobile phone, a smartphone, a portable smart device, a digital camera, a laptop computer, a digital broadcasting terminal, a personal digital assistant (PDA), a portable multimedia player (PMP), a navigation device, etc., without being limited thereto, and may also be any of devices for capturing images or pictures.

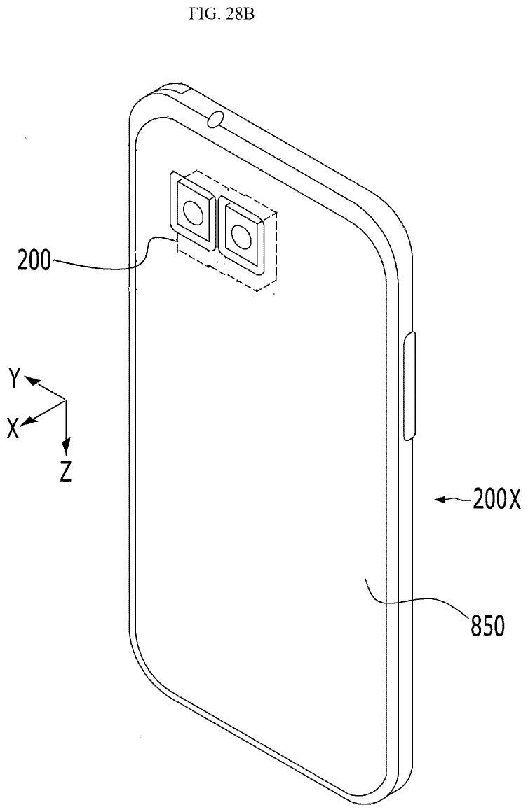

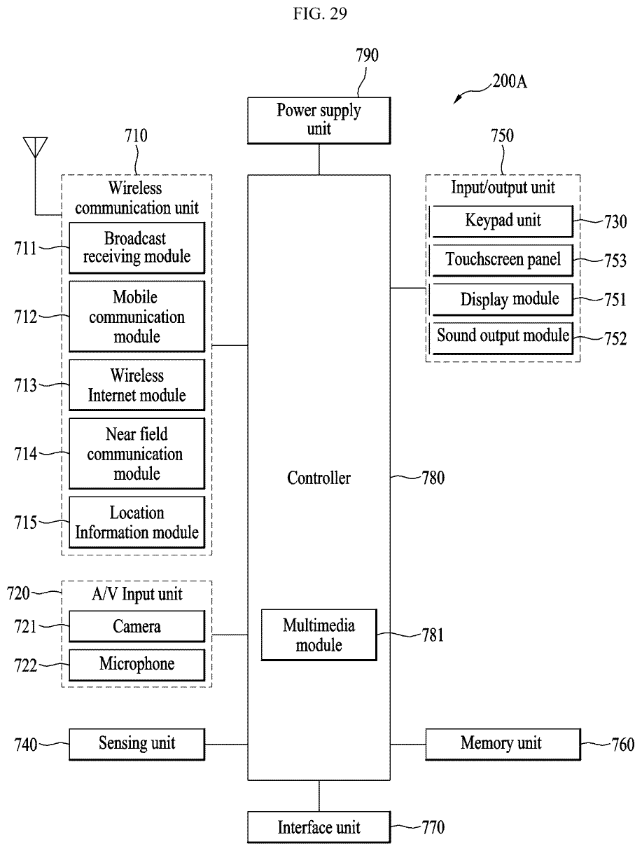

FIG. 28A is a perspective view of an optical instrument 200A according to an embodiment, FIG. 28B is a perspective view of an optical instrument 200X according to another embodiment, and FIG. 29 is a configuration diagram of the optical instruments 200A shown in FIGS. 28A and 28B.

For example, the embodiment in FIG. 28A may be a front-view camera of the optical instrument 200A in which the lens module 400 of the camera module 200 is disposed so as to face the front surface of the body 850, and the embodiment in FIG. 28B may be a rear-view camera in which the lens module 400 of the camera module 200 is disposed so as to face the rear surface of the body 850 of the optical instrument 200X. FIG. 28B illustrates an example in which two rear-view cameras are disposed. In another embodiment, one or more rear-view cameras may be disposed.

In another embodiment, the optical instrument 200A according to the embodiment may correspond to the front-view camera and the rear-view camera of the optical instrument 200A.

Referring to FIGS. 28A, 28B, and 29, the optical instrument 200A may include a body 850, a wireless communication unit 710, an A/V input unit 720, a sensing unit 740, an input/output unit 750, a memory 760, an interface unit 770, a controller 780, and a power supply unit 790.

The body 850 may have a bar shape, without being limited thereto, and may be any of various types such as, for example, a slide type, a folder type, a swing type, or a swivel type, in which two or more sub-bodies are coupled so as to be movable relative to each other.

The body 850 may include a case (a casing, a housing, a cover, or the like) defining the external appearance thereof. In an example, the body 850 may be divided into a front case 851 and a rear case 852. A variety of electronic components of the terminal may be mounted in the space defined between the front case 851 and the rear case 852.

The wireless communication unit 710 may include one or more modules that enable wireless communication between the optical instrument 200A and a wireless communication system or between the optical instrument 200A and a network in which the optical instrument 200A is located. In an example, the wireless communication unit 710 may include a broadcast receiving module 711, a mobile communication module 712, a wireless Internet module 713, a nearfield communication module 714, and a location information module 715.

The audio/video (A/V) input unit 720 serves to input audio signals or video signals and may include a camera 721 and a microphone 722.

The camera 721 may include the camera device according to the embodiment.

The sensing unit 740 may sense the current state of the optical instrument 200A, such as the open or closed state of the optical instrument 200A, the position of the optical instrument 200A, the presence or absence of a user's touch, the orientation of the optical instrument 200A, or the acceleration/deceleration of the optical instrument 200A, and may generate a sensing signal to control the operation of the optical instrument 200A. For example, when the optical instrument 200A is a slide-type phone, whether the slide-type phone is open or closed may be detected. In addition, the sensing unit 740 serves to sense whether power is supplied from the power supply unit 790 or whether the interface unit 770 is coupled to an external device.

The input/output unit 750 serves to generate visual, audible, or tactile input or output. The input/output unit 750 may generate input data to control the operation of the optical instrument 200A and may display information processed in the optical instrument 200A.

The input/output unit 750 may include a keypad unit 730, a display module 751, a sound output module 752, and a touchscreen panel 753. The keypad unit 730 may generate input data in response to input to a keypad.

The display module 751 may include a plurality of pixels, the color of which varies in response to electrical signals. In an example, the display module 751 may include at least one of a liquid crystal display, a thin-film transistor liquid crystal display, an organic light-emitting diode, a flexible display, or a 3D display.

The sound output module 752 may output audio data received from the wireless communication unit 710 in a call-signal reception mode, a call mode, a recording mode, a voice recognition mode, or a broadcast reception mode, or may output audio data stored in the memory 760.

The touchscreen panel 753 may convert variation in capacitance, caused by a user's touch on a specific region of a touchscreen, into electrical input signals.

The memory 760 may store programs for the processing and control of the controller 780, and may temporarily store input/output data (e.g., a phone book, messages, audio, still images, pictures, and moving images). For example, the memory 760 may store images captured by the camera 721, for example, pictures or moving images. For example, the memory 760 may store software, an algorithm, or an equation for implementation of hand-tremor compensation described above.

The interface unit 770 serves as a passage for connection between the optical instrument 200A and an external device. The interface unit 770 may receive data or power from the external device and may transmit the same to respective components provided in the optical instrument 200A, or may transmit data inside the optical instrument 200A to the external device. For example, the interface unit 770 may include a wired/wireless headset port, an external charger port, a wired/wireless data port, a memory card port, a port for connection of a device having an identification module, an audio input/output (I/O) port, a video input/output (I/O) port, and an earphone port.

The controller 780 may control the overall operation of the optical instrument 200A. For example, the controller 780 may perform control and processing related to voice calls, data communication, and video calls.

The controller 780 may include a multimedia module 781 for multimedia playback. The multimedia module 781 may be provided in the controller 180 or may be provided separately from the controller 780.

The controller 780 may perform pattern recognition processing, by which writing or drawing input to the touchscreen is perceived as characters and images.

The power supply unit 790 may supply power required to operate the respective components upon receiving external power or internal power under the control of the controller 780.

The features, structures, effects, and the like described above in the embodiments are included in at least one embodiment of the present disclosure, but are not necessarily limited to only one embodiment. Furthermore, the features, structures, and effects exemplified in the respective embodiments may be combined with other embodiments or modified. Therefore, content related to such combinations and modifications should be construed as falling within the scope of the present disclosure.

### INDUSTRIAL APPLICABILITY

Embodiments may be used for a camera device capable of inhibiting an OIS moving unit from being damaged or broken due to impact or collision and an optical instrument.

1. A camera device comprising:
a fixed unit comprising a cover member comprising an upper plate and a side plate connected to the upper plate;
a moving unit comprising a holder disposed inside the cover member, a first circuit board disposed on the holder, and an image sensor conductively connected to the first circuit board; and
a support unit coupled to the holder, the support unit being configured to support the moving unit with respect to the fixed unit,
wherein the holder comprises a side portion, a corner portion, and a stopper protruding from an outer side surface of the side portion of the holder toward the side plate of the cover member, and
wherein the stopper is disposed closer to a center of the side portion of the holder than to the corner portion of the holder.

2. The camera device according to claim 1, wherein at least a portion of the stopper passes through the support unit.

3. The camera device according to claim 1, wherein a shortest distance between the stopper and the side plate of the cover member is less than a shortest distance between the outer side surface of the side portion of the holder and the side plate of the cover member.

4. The camera device according to claim 1, wherein a shortest distance between the stopper and the side plate of the cover member is less than a shortest distance between an outer side surface of the corner portion of the holder and the side plate of the cover member.

5. The camera device according to claim 3, wherein the holder comprises a protruding portion formed so as to allow a portion of the support unit to be coupled thereto, and wherein the stopper comprises a first stopper protruding from an outer side surface of the protruding portion of the holder.

6. The camera device according to claim 5, wherein the support unit comprises a connection portion connected to the first circuit board and coupled to the protruding portion of the holder, and
wherein the first stopper passes through the connection portion.

7. The camera device according to claim 1, wherein the holder comprises a protruding portion protruding in an optical-axis direction so as to allow a portion of the support unit to be coupled thereto, and
wherein the stopper comprises a first stopper located on one side of the protruding portion of the holder and a second stopper located on an opposite side of the protruding portion of the holder.

8. The camera device according to claim 1, wherein the fixed unit comprises:
a base disposed below the cover member; and
a second circuit board coupled to the base, and
wherein the stopper comprises a second stopper protruding from the outer side surface of the side portion of the holder toward the base.

9. The camera device according to claim 8, wherein the base comprises a protruding portion formed so as to allow a portion of the support unit to be coupled thereto,
wherein the holder comprises a recess depressed in the outer side surface of the side portion of the holder so as to correspond to the protruding portion of the base, and
wherein the second stopper protrudes from a bottom surface of the recess in the holder toward the protruding portion of the base.

10. The camera device according to claim 9, wherein a distance between the second stopper and the protruding portion of the base is less than a distance between the outer side surface of the side portion of the holder and the side plate of the cover member.

11. The camera device according to claim 1, wherein when a center of the side portion of the holder is a point corresponding to 50% of the overall length of the side portion of the holder, the stopper is disposed within a region between points corresponding to 35% and 65% of the length of the side portion of the holder.

12. A camera device comprising:
a fixed unit including a cover member;
a moving unit including a holder disposed inside the cover member and an image sensor; and
a support unit coupled to the holder and configured to support the moving unit with respect to the fixed unit,
wherein the holder comprises a first stopper protruding from an outer side surface of a first side portion of the holder toward a first side plate of the cover member in a second direction perpendicular to a first direction parallel to an optical axis,
wherein the first stopper protrudes relative to the support unit coupled to the holder.

13. The camera device according to claim 12, wherein the holder comprises a second stopper protruding from an outer side surface of a second side portion of the holder toward a second side plate of the cover member in a direction opposite the first stopper, and wherein the second stopper protrudes relative to the support unit coupled to the holder.

14. The camera device according to claim 13, wherein the support unit comprises:
a first hole formed therein to allow a portion of the first stopper to pass therethrough; and
a second hole formed therein to allow the second stopper to pass therethrough.

15. The camera device according to claim 12, wherein the holder comprises:
a third stopper protruding from an outer side surface of a third side portion of the holder in a third direction perpendicular to the first direction and the second direction; and
a fourth stopper protruding from an outer side surface of a fourth side portion of the holder in a direction opposite the third stopper.

16. The camera device according to claim 15, wherein the holder comprises:
a first recess formed in the outer side surface of the third side portion of the holder; and
a second recess formed in the outer side surface of the fourth side portion of the holder, wherein the third stopper protrudes from a bottom surface of the first recess, and the fourth stopper protrudes from a bottom surface of the second recess.

17. The camera device according to claim 15, wherein each of the third stopper and the fourth stopper is located farther inward than the support unit.

18. The camera device according to claim 16, wherein a protruding length of the third stopper is less than a distance from the outer side surface of the third side portion of the holder to the bottom surface of the first recess, and a protruding length of the fourth stopper is less than a distance from the outer side surface of the fourth side portion of the holder to the bottom surface of the second recess.

19. The camera device according to claim 16, wherein the base comprises:
a first protruding portion formed so as to oppose the first recess in the holder and to allow a portion of the support unit to be coupled thereto; and
a second protruding portion formed so as to oppose the second recess in the holder and to allow another portion of the support unit to be coupled thereto,
wherein the third stopper opposes the first protruding portion of the base, and the fourth stopper opposes the second protruding portion of the base.

20. An actuator comprising:
a fixed unit comprising a cover member including an upper plate and a side plate connected to the upper plate;
a moving unit comprising a holder disposed inside the cover member and a first circuit board disposed on the holder; and
a support unit coupled to the holder and configured to support the moving unit with respect to the fixed unit,
wherein the holder comprises a side portion, a corner portion, and a stopper protruding from an outer side surface of the side portion of the holder toward the side plate of the cover member, and the stopper is disposed closer to a center of the side portion of the holder than to the corner portion of the holder.
